(19) United States
(12) Patent Application Publication
(10) Pub. No.: US 2003/0231338 A1
(43) Pub. Date: Dec. 18, 2003

(54) Network image forming apparatus system and a method of registering the image forming apparatus for use in a network

(76) Inventor: Tatsuyoshi Haga, Tokyo (JP)

Correspondence Address: CANTOR COLBURN LLP, 55 Griffin Road South, Bloomfield, CT, 06002, US

(21) Appl. No.: 10/444,407

(22) Filed: May 23, 2003

(30) Foreign Application Priority Data
May 31, 2002 (JP) JP2002-159624
May 31, 2002 (JP) JP2002-159626
May 31, 2002 (JP) JP2002-159627

(51) Int. Cl. G06K 1/00; G06F 15/00; H04N 1/00; B41J 1/00

(52) U.S. Cl. 358/1.15; 358/402

(57) ABSTRACT

There is described a network image forming apparatus system including the image forming apparatus capable of communicating with a predetermined network. The system includes means for verifying to determine whether or not an image forming apparatus is capable of receiving electronic mail correctly; and means for displaying the result of this verification, and, if setting of a connection parameter is incorrect, displaying a particular item of incorrect setting and a way of correcting this incorrect setting; wherein self-transmission and reception is possible without being affected by delay in distribution of electronic mail to a mail server; the display means showing for a user a message indicating the necessity of rebooting if there is any change in the connection parameter requiring rebooting of the image forming apparatus.

The present invention relates to a network image forming apparatus system including the image forming apparatus capable of communicating with a predetermined network.

Further, the present invention relates to a network image forming apparatus including: transceiver means for transmitting and receiving electronic mail via a mail server arranged in a predetermined network; image forming means for forming an image; and image output means for outputting the image formed by the aforementioned image forming means.

Still further, the present invention relates to a network image forming apparatus that provides remote control from the outside through operation in conformity to a predetermined command described in electronic mail including the predetermined command received by transceiver means.

In an image forming apparatus linked to a network, electronic mail is used for a wide variety of applications, including remote management, error report, status report and operation starting instruction. For remote management of an image forming apparatus, the Japanese Application Patent Laid-Open Publication No. Hei 08-331267 discloses remote management method and communication system thereof wherein a monitored apparatus such as a digital copying machine, fax machine and printer is subjected to diagnosis and control via the network by a monitoring apparatus including a computer.

For the error report in an image forming apparatus, the Japanese Application Patent Laid-Open Publication No. Hei 10-17202 discloses an information reporting method and apparatus thereof for using an external apparatus such as a computer to send paper run-out report for output equipment including a printer, copying machine and fax machine, request for repair and error information.

With regard to status report in an image forming apparatus, the Japanese Application Patent Laid-Open Publication No. Hei 10-207304 discloses an image forming apparatus consisting of self-diagnostic means for self-diagnosing failures of an image forming apparatus, a registration means for preliminary registration of the destinations for report, and reporting means for reporting the results of diagnosis to the destinations registered in advance.

With respect to the operation starting instruction of an image forming apparatus, the Japanese Application Patent Laid-Open Publication No. 2001-177672 shows an image reading system wherein an instruction is given to an image forming apparatus to start scanning in automatic readout mode.

However, when electronic mail is used in the aforementioned prior art image forming apparatus, it is necessary to set many connection parameters including information on mail server (IP address, user authentication). When setting these parameters, there is no way of checking whether or not the image forming apparatus ensures correct transmission and reception of electronic mail. There is no knowing whether or not setting of connection parameters is correct, or where an error is located when the parameter setting is incorrect. If incorrect setting of a connection parameter is overlooked, the image forming apparatus continues operation on the assumption that the set parameter is correct. In practice, however, electronic mail cannot be sent correctly. Depending on the function of the mail, an attempt at transmission or reception continues infinitely, with the result that the mail server, image forming apparatus and network are adversely affected, according to the prior art.

In an image forming apparatus having a function of self-transmission and reception of electronic mail, an electronic mail parameter checking function and its own status confirmation function are used. During the time from reception of electronic mail to transmission thereof, electronic mail is distributed through a great variety of routes over the Internet between a transmit mail server and a receive mail server. Accordingly, depending on the network environment, electronic mail may be sent to the receive mail server. If reception of electronic mail cannot be confirmed, there is no knowing if this is caused by delay or incorrect parameter setting. This has created a problem in the prior art.

In the prior art image forming apparatus, when changing the connection parameter setting and validating the change, the image forming apparatus must be rebooted in many cases. In such cases, user's decision has been essential. However, information on whether or not rebooting of an image forming apparatus is necessary in order to validate the changed parameter is described in the Manual or similar documents, and most users do not have this information. When the connection parameter (IP address, etc.) of an image forming apparatus has to be changed, it has not been easy for a user to determine whether or not the image forming apparatus should be rebooted, according to the prior art.

The following techniques have been used in the image forming apparatus linked to the general-purpose network: (1) a scan-to-e-mail technique wherein the document having been read is converted into data and is sent as electronic mail between the image forming apparatus and external terminal for manager (for example) (Japanese Application Patent Laid-Open Publication No. 2001-177672); (2) an error report technique for ensuring that a failure having occurred in an image forming apparatus is evaluated on the manager's terminal (Japanese Application Patent Laid-Open Publication No. Hei 10-17202); (3) status report technique for evaluation of the status of the image forming apparatus at the manager's terminal (Japanese Application Patent Laid-Open Publication No. Hei 10-207304; and (4) remote management technique for remote operation of the image forming apparatus from the manager's terminal (Japanese Application Patent Laid-Open Publication No. Hei 08-331267). These management techniques using electronic mail services on the Internet have come into widespread use.

When remote control is performed in the aforementioned management system, electronic mail is sent and received by each image forming apparatus. This means that an unspecified number of the pieces of electronic mail may be sent to the image forming apparatus.

Of these pieces of electronic mail, illegal mail having a great data size in particular will adversely affect the communication traffic of the network involving the image forming apparatus that receives this mail. Not only that, this requires analysis of a massive amounts of received data, with the result that a great load is imposed on the image forming apparatus.

When illegal mail of a greater data size has been received, a great volume of the memory must be wasted, and this has created a problem.

In order to reduce power consumption and to decrease load of communication traffic, it is common practice to receive electronic mail from the mail server at a predetermined interval. When mail has been received, however, a large quantity of electronic mail is received by the mail server in some cases. In such cases, a large quantity of data must be processed at one time. This results in an increased load on the communication traffic on the temporary basis, and there will be an increased load on the image forming apparatus in order to process a large quantity of electronic mail. This has created the same problem as mentioned above.

In the aforementioned management system, electronic mail is used to achieve remote control for an image forming apparatus. In this case, electronic mail is sent to the image forming apparatus as an object of this remote control; then the image forming apparatus receives, analyzes and executes this electronic mail.

At present, remote control cannot be achieved without having information on the command described in the electronic mail for the aforementioned remote control, so there is no restriction to an access from a third party unauthorized to execute a command. When having received electronic mail sent from a third party who is apparently not authorized to execute a command, or such illegal mail as electronic mail containing an unconceivable command, there has been no means of automatically notifying an external manager of the reception of such an illegal mail.

However, amid the recent development and spread of the Internet technologies, there has been a strong demand for enhanced security on the Internet and quick response to an illegal operation.

### SUMMARY OF THE INVENTION

The present invention has been made in an effort to solve the aforementioned problems. The first object of the present invention is to provide a network image forming apparatus system and a method of registering the image forming apparatus for use in the network using this system; wherein the aforementioned system comprises: means for verifying to determine if an image forming apparatus is capable of receiving electronic mail correctly or not; and means for displaying the result of this verification, and, if setting of a connection parameter is incorrect, displaying a particular item of incorrect setting and a way of correcting this incorrect setting; wherein self-transmission and reception is possible without being affected by delay in distribution of electronic mail to a mail server; said display means showing for a user a message indicating the necessity of rebooting if there is any change in the connection parameter requiring rebooting of the image forming apparatus.

Further, a second object of the present invention is to provide a network image forming apparatus system; wherein, for remote management of multiple image forming apparatuses using the technique based on electronic mail, means are provided to reduce the load on communication traffic of the network due to reception of illegal mail and the load on each image forming apparatus due to processing of illegal mail.

Still further, a third object of the present invention is to provide a network image forming apparatus system; wherein, for remote management of an image forming apparatus using the technique based on electronic mail, means are provided for automatic detection of illegal mail.

Accordingly, to overcome the cited shortcomings, the abovementioned object of the present invention can be attained by image-forming systems, image-forming methods and apparatus described as follow.

(1) A system for forming an image and communicating electronic mails, including a transmit mail and a receive mail, through a network, comprising: a server, that includes a transmit-mail storage for temporarily storing the transmit mail to be transmitted via the network, and a receive-mail storage for temporarily storing the receive mail received via the network; and an image-forming apparatus, that includes a transceiver section for transmitting a transmit data set to be transmitted on the transmit mail and for receiving a receive data set received on the receive mail, and a data-processing section for processing the receive data set received by the transceiver section; wherein the server is coupled to both the network and the image-forming apparatus, so as to communicate the transmit data set and the receive data set on the electronic mails through the network; and wherein the image-forming apparatus further includes: an operating section to input connecting data; a connecting data storage to store the connecting data therein; and a displaying section to display the connecting data inputted by the operating section; and wherein, when the connecting data are inputted from the operating section and a confirmation-starting command, to start an operation for confirming connections between the server and the transceiver section, is activated, the data-processing section generates a connecting parameter according to the connecting data inputted by the operating section, and then, the transceiver section is electrically connected to both the transmit-mail storage and the receive-mail storage, both included in the server, by employing the connecting parameter; and wherein the data-processing section determines whether or not the connecting data are effective by monitoring a connecting status between the transceiver section and the server, and sends first displaying data for displaying a result determined by the data-processing section to the displaying section, which displays the result on a displaying screen.

(2) The system of item 1, wherein, when the data-processing section determines that the connecting data are ineffective, the data-processing section also sends a second displaying data for displaying a second message urging a reentry of the connecting data to the displaying section, so that the displaying section displays the second message on the displaying screen, as needed.

(3) The system of item 2, wherein, when the server rejects a confirmation mail sent from the transceiver section in the operation for confirming connections between the server and the transceiver section with employing the connecting parameter, the data-processing section determines that the connecting data, inputted by the operating section, are ineffective.

(4) The system of item 2, wherein, when the transceiver section fails to achieve an accessing operation for accessing the receive-mail storage from the transceiver section in the operation for confirming connections between the server and the transceiver section with employing the connecting parameter, the data-processing section determines that the connecting data, inputted by the operating section, are ineffective.

(5) The system of item 2, wherein, in the operation for confirming connections between the server and the transceiver section with employing the connecting parameter, when the server rejects a confirmation mail sent from the transceiver section, or when the transceiver section fails to achieve an accessing operation for accessing the receive-mail storage from the transceiver section, the data-processing section determines that the connecting data, inputted by the operating section, are ineffective, and the data-processing section also sends a third displaying data, for displaying a third message indicating an inability of normal communicating operation for the electronic mails, to the displaying section, so that the displaying section displays the third message on the displaying screen, as needed.

(6) The system of item 5, wherein, when the data-processing section confirms that the receive-mail storage has not received a confirmation mail, the data-processing section controls the transceiver section so as to repeat accessing operations for accessing the receive-mail storage a predetermined number of times at a predetermined time interval; and wherein, if the data-processing section still confirms that the receive-mail storage has not received a confirmation mail after the predetermined number of the accessing operations have completed, the data-processing section sends the third displaying data to the displaying section.

(7) The system of item 2, wherein the data-processing section determines whether or not the server can recognize a new connecting parameter, regenerated from new connecting data reentered from the operating section, without rebooting the image-forming apparatus; and wherein, when the data-processing section determines that the server cannot recognize the new connecting parameter without rebooting the image-forming apparatus, the data-processing section sends a fourth displaying data, for displaying a fourth message indicating a necessity of rebooting the image-forming apparatus, to the displaying section, so that the displaying section displays the fourth message on the displaying screen.

(8) The system of item 2, wherein the data-processing section determines whether or not the server can recognize a new connecting parameter, regenerated from new connecting data reentered from the operating section, without rebooting the image-forming apparatus; and wherein, when the data-processing section determines that the server cannot recognize the new connecting parameter without rebooting the image-forming apparatus, the data-processing section automatically reboots the image-forming apparatus.

(9) A method for registering an image-forming apparatus into a network of a system for forming an image and communicating electronic mails, including a transmit mail and a receive mail, through the network, and the system comprising a server that includes a transmit-mail storage for temporarily storing the transmit mail to be transmitted via the network and a receive-mail storage for temporarily storing the receive mail received via the network, and the image-forming apparatus that includes a transceiver section for transmitting a transmit data set to be transmitted on the transmit mail and for receiving a receive data set received on the receive mail and a data-processing section for processing the receive data set received by the transceiver section, the method comprising the steps of: inputting connecting data for generating a connecting parameter to connect the transceiver section with both the transmit-mail storage and the receive-mail storage of the server; determining whether or not the connecting data are effective by monitoring a connecting status between the transceiver section and the server; and displaying a first message indicating a result determined in the determining step on a displaying screen.

(10) The method of item 9, further comprising the steps of: displaying a second message urging a reentry of the connecting data as needed, when it is determined that the connecting data are ineffective in the determining step.

(11) The method of item 10, wherein the determining step further comprises the steps of: controlling the transceiver section so as to conduct a sending operation of a confirmation mail by employing the connecting parameter; and judging whether or not the confirmation mail is rejected in the transceiver section; and wherein, when judging that the confirmation mail is rejected in the judging step, the connecting data are determined as ineffective data.

(12) The method of item 10, wherein the determining step further comprises the steps of: controlling the transceiver section so as to conduct an accessing operation for accessing the receive-mail storage of the server by employing the connecting parameter; and judging whether or not the accessing operation is failed; and wherein, when judging that the accessing operation is failed in the judging step, the connecting data are determined as ineffective data.

(13) The method of item 10, wherein the determining step further comprises the steps of: controlling the transceiver section so as to conduct a sending operation of a confirmation mail by employing the connecting parameter; judging whether or not the confirmation mail is rejected in the transceiver section; controlling the transceiver section so as to conduct an accessing operation for accessing the receive-mail storage of the server by employing the connecting parameter; judging whether or not the accessing operation is failed; and judging whether or not the confirmation mail is received at the receive-mail storage; and wherein, when judging that the confirmation mail is rejected in the judging step, the connecting data are determined as ineffective data; and wherein, when judging that the accessing operation is failed in the judging step, the connecting data are determined as ineffective data; and wherein, when judging that the confirmation mail is not received by the receive-mail storage, it is determined that receiving/transmitting operations cannot be normally conducted.

(14) The method of item 13, wherein, when it is confirmed that the confirmation mail is not received by the receive-mail storage, the judging step of confirmation mail reception further comprises the steps of: judging whether or not the transceiver section should perform again an accessing operation for accessing the receive-mail storage; and judging whether or not a number of repetitions of accessing operations for accessing the receive-mail storage already exceeds a predetermined number of times, when judging that the transceiver section should perform again the accessing operation; and wherein, judging that the number of repetitions of accessing operations for accessing the receive-mail storage already exceeds the predetermined number of times, it is determined that receiving operations of the electronic mail could not be normally conducted.

(15) The method of item 10, when the connecting data, which were once inputted, are changed to new connecting data, further comprising the steps of: inputting the new connecting data for regenerating a new connecting parameter; determining whether or not the server can recognize the new connecting parameter, regenerated from new connecting data inputted in the inputting step, without rebooting the image-forming apparatus; and displaying a fourth message indicating a necessity of rebooting the image-forming apparatus on the displaying screen, when determining that the server cannot recognize the new connecting parameter without rebooting the image-forming apparatus.

(16) The method of item 10, when the connecting data, which were once inputted, are changed to new connecting data, further comprising the steps of: inputting the new connecting data for regenerating a new connecting parameter; determining whether or not the server can recognize the new connecting parameter, regenerated from new connecting data inputted in the inputting step, without rebooting the image-forming apparatus; and rebooting the image-forming apparatus in an automatic mode, when determining that the server cannot recognize the new connecting parameter without rebooting the image-forming apparatus.

(17) An apparatus for forming an image and having a function of communicating electronic mails, including a transmit mail and a receive mail, through a mail server equipped in a network system, comprising: a transceiver section to transmit a transmit data set to be transmitted on the transmit mail and to receive a receive data set received on the receive mail; a data size detecting section to detect a data size of the receive data set, which is received and stored in a receive-mail storage provided in the mail server; a data size determining section to determine whether or not the data size, detected by the data size detecting section, is larger than a predetermined data size; and a controlling section to control the transceiver section so as to receive the receive data set of the receive mail when the data size determining section determines that the data size, detected by the data size detecting section, is not larger than a predetermined data size.

(18) The apparatus of item 17, wherein the receive data set received on the receive mail includes predetermined command data for commanding an operation of the controlling section; and further comprising: a command data extracting section to extract the command data from the receive data set when the data size determining section determines that the data size, detected by the data size detecting section, is not larger than the predetermined data size.

(19) The apparatus of item 17, further comprising: an electronic-mail creating section to create the transmit mail, which includes a message indicating that the data size is larger than the predetermined data size, when the data size determining section determines that the data size, detected by the data size detecting section, is larger than the predetermined data size; wherein the transceiver section transmits the transmit mail including the message to an external terminal device of a manager of the network system.

(20) The apparatus of item 17, wherein, when an attached file is attached to the receive mail, the data size detecting section also detects an attached data size of the attached file, and a data size determining section also determines whether or not the attached data size, detected by the data size detecting section, is larger than a predetermined attached-data size.

(21) The apparatus of item 20, further comprising: an electronic-mail creating section to create the transmit mail, which includes a message indicating that the attached data size is larger than the predetermined attached data size, when the data size determining section determines that the attached data size, detected by the data size detecting section, is larger than the predetermined attached data size; wherein the transceiver section transmits the transmit mail including the message to an external terminal device of a manager of the network system.

(22) An apparatus for forming an image and having a function of communicating electronic mails, including a transmit mail and a receive mail, through a mail server equipped in a network system, comprising: a transceiver section to conduct a transmitting operation of the transmit mail and a receiving operation of the receive mail; and a controlling section that determines whether or not a number of receive mails, received by the transceiver section, reaches to a predetermined number; wherein the controlling section controls the transceiver section so as to deactivate the receiving operation of the receive mail when determining that the number of receive mails reaches to the predetermined number.

(23) An apparatus for forming an image and having a function of communicating electronic mails including predetermined command data through a network, operations of the apparatus being remote-controlled according to the predetermined command data sent from an external device, the apparatus comprising: a transceiver section to conduct transmitting/receiving operations of the electronic mails; an identifying-information extracting section to extract identifying information from an electronic mail received by the transceiver section; an authenticating section to authenticate the identifying information extracted by the identifying-information extracting section; a reference information storage to store reference information to be referred when the authenticating section authenticates the identifying information; a command data extracting section to acquire the electronic mail including the identifying information authenticated by the authenticating section, in order to extract the predetermined command data from the electronic mail; and a controlling section to control each of sections as needed, according to the predetermined command data extracted by the command data extracting section.

(24) The apparatus of item 23, wherein the identifying information is a password written in a predetermined area of the electronic mail.

(25) The apparatus of item 23, wherein the identifying information is a mail address of a sender of the electronic mail.

(26) The apparatus of item 23, wherein the reference information storage stores each of identifying information sets correlating to each of authorities, each of which is established for every identifying information set; and wherein the authenticating section authenticates the identifying information set and extracts information with respect to an authority corresponding to the identifying information set from the reference information storage, to determine whether or not the predetermined command data, included in the electronic mail, resides within a scope of the authority extracted; and wherein, when the authenticating section determines that the predetermined command data resides within a scope of the authority extracted, the controlling section controls each of sections as needed, according to the predetermined command data.

(27) The apparatus of item 23, further comprising: an electronic-mail creating section to create the electronic mail, which includes a message indicating that the identifying information is not authenticated, when an authenticating section did not authenticate the identifying information extracted by the identifying-information extracting section; wherein the transceiver section transmits the transmit mail including the message to an external terminal device of a manager of the network system.

Further, to overcome the abovementioned problems, other image-forming systems, image-forming methods and apparatus, embodied in the present invention, will be described as follow:

(28) A network image-forming apparatus system, characterized in that,

in the system, which is provided with an image-forming apparatus having a transceiver means for conducting a communicating operation with a predetermined network and a data processing means for processing communication data received by the transceiver means, and an electronic-mail server having a transmit-mail storage section which is coupled to both the network and the transceiver means of the image-forming apparatus conducting the communicating operation with the network and in which a transmit mail to be transmitted from the transceiver means to the network is temporarily stored and a receive-mail storage in which a receive mail to be transmitted from the network to the transceiver means is temporarily stored,

the image-forming apparatus has an operating means for setting-inputting a predetermined connecting parameter for connecting the transceiver to both storages of the electronic-mail server, a memory means for memorizing the connecting parameter setting-inputted by the operating means and a displaying means for displaying a setting-inputting status by the operating means, and

the data processing means generates the connecting parameter according to the setting-input and sends it to the memory means, when the setting-input form the operating means is performed, and determines whether or not the connecting parameter setting-inputted is effective by monitoring the connecting status of the transceiver means and the transmit-mail storage and/or the connecting status of the transceiver means and the receive-mail storage by using the connecting parameter, and

when determining that determined result displaying data and the connecting parameter are ineffective, the data processing means sends input-urging displaying data for conducting displaying operation of urging the operating means to input again the connecting parameter as needed, and

the displaying means conducts the displaying operation based on the determined result displaying data and the input-urging displaying data as needed.

(29) A method of registering image-forming apparatus into a network, characterized in that,

in the system, which is provided with an image-forming apparatus having a transceiver means for conducting a communicating operation with a predetermined network and a data processing means for processing communication data received by the transceiver means, and an electronic-mail server having a transmit-mail storage section which is coupled to both the network and the transceiver means of the image-forming apparatus conducting the communicating—operation with the network and in which a transmit mail to be transmitted from the transceiver means to the network is temporarily stored and a receive-mail storage in which a receive mail to be transmitted from the network to the transceiver means is temporarily stored,

the method comprises the steps of:

an inputting step for urging setting-inputting operation of a predetermined connecting parameter for connecting the transceiver to both storages of the electronic-mail server;

a parameter determining step for determines whether or not the connecting parameter setting-inputted is effective by monitoring the connecting status of the transceiver means and the transmit-mail storage and/or the connecting status of the transceiver means and the receive-mail storage by using the connecting parameter, when the setting-input form the operating means is performed; and

a displaying step for displaying determined results in the parameter determining step, and for urging the operating means to input again the connecting parameter as needed when determining that determined result displaying data and the connecting parameter are ineffective.

of 2002-159626

(30) A network image-forming apparatus, characterized in that,

in the network image-forming apparatus, which has transceiver means for transmitting/receiving electronic mails through a mail server equipped in a predetermined network, image-forming means for conducting an image forming, and image-outputting means for outputting an image formed by the image-forming means,

size detecting means for detecting a data size of the electronic mail, which is received by a receive-mail box provided in the mail server;

size determining means for determining whether or not the detected data size is larger than a predetermined data size;

controlling means for controlling the transceiver means so as to receive a body of the electronic mail when the size determining means determines that the data size is smaller than the predetermined size.

of 2002-159627

(31) A network image-forming apparatus, characterized in that,

in the network image-forming apparatus, which has transceiver means for transmitting/receiving electronic mails through a predetermined network, image-forming means for conducting an image forming, and image-outputting means for outputting an image formed by the image-forming means, and which processes remote-controlling operations from outside by being operated according with predetermined commands described in the electronic mail, which is received by the transceiver means and includes the predetermined commands,

the network image-forming apparatus is provided with:

identifying-information extracting means for extracting identifying information from the electronic mail received by the transceiver means;

authenticating means for authenticating the extracted identifying information;

a reference memory to accumulate information to be referred when the authenticating means authenticates the identifying information;

command extracting means for acquiring the electronic mail including the authenticated identifying information, and for extracting the predetermined commands described in the electronic mail; and

controlling means for controlling each of sections according to the extracted commands.

### BRIEF DESCRIPTION OF THE DRAWINGS

Other objects and advantages of the present invention will become apparent upon reading the following detailed description and upon reference to the drawings in which:

FIG. 1 is a block diagram representing one embodiment of the network image forming apparatus system according to the present invention;

FIG. 2 is a flow chart representing a first embodiment of the method of registering an image forming apparatus for use in a network according to the present invention;

FIG. 3 is a drawing representing an embodiment of the connection parameter input screen to be displayed in a display section;

FIG. 4(a), FIG. 4(b) and FIG. 4(c) are drawings representing an embodiment of the confirmation test OK screen to be displayed on the display section;

FIG. 5(a), FIG. 5(b) and FIG. 5(c) are drawings representing another embodiment of the confirmation test NG screen to be displayed on the display section;

FIG. 6(a), FIG. 6(b) and FIG. 6(c) are drawings representing a further embodiment of the confirmation test NG screen to be displayed on the display section;

FIG. 7 is a drawing representing an embodiment of a screen for prompting reentry of a connection parameter to be displayed on the display section;

FIG. 8 is a flow chart representing a second embodiment of the method of registering an image forming apparatus for use in a network according to the present invention;

FIG. 9 is a flow chart representing a third embodiment of the method of registering an image forming apparatus for use in a network according to the present invention;

FIG. 10 is a flow chart representing a fourth embodiment of the method of registering an image forming apparatus for use in a network according to the present invention;

FIG. 11 is a flow chart representing a fifth embodiment of the method of registering an image forming apparatus for use in a network according to the present invention;

FIG. 12 is a flow chart representing a sixth embodiment of the method of registering an image forming apparatus for use in a network according to the present invention;

FIG. 13 is a drawing representing an embodiment of a screen for prompting rebooting of the image forming apparatus to be displayed on the display section;

FIG. 14 is a flow chart representing a seventh embodiment of the method of registering an image forming apparatus for use in a network according to the present invention;

FIG. 15 is a flow chart representing an eighth embodiment of the method of registering an image forming apparatus for use in a network according to the present invention;

FIG. 16 is a flow chart representing a ninth embodiment of the method of registering an image forming apparatus for use in a network according to the present invention;

FIG. 17 is a flow chart representing a tenth embodiment of the method of registering an image forming apparatus for use in a network according to the present invention;

FIG. 18 is a flow chart representing an eleventh embodiment of the method of registering an image forming apparatus for use in a network according to the present invention;

FIG. 19 is a block diagram representing one embodiment of the network image forming apparatus system according to the present invention;

FIG. 20 is a flow chart representing an operation of the aforementioned equipment embodiment;

FIG. 21 is a flow chart representing another example of the operation of the aforementioned equipment embodiment;

FIG. 22 is a block diagram representing another embodiment of the network image forming apparatus system according to the present invention;

FIG. 23 is a flow chart representing another example of the operation of the aforementioned equipment embodiment;

FIG. 24 is a drawing representing an example of electronic mail for reporting reception of illegal mail to a manager in the aforementioned embodiment;

FIG. 25 is a block diagram representing one embodiment of the network image forming apparatus system according to the present invention;

FIG. 26 is a flow chart representing an example of the operation of the aforementioned equipment embodiment;

FIG. 27 is a drawing representing an example of electronic mail sent and received in the aforementioned embodiment;

FIG. 28 is a drawing illustrating master data for authentication in the aforementioned embodiment;

FIG. 29 is a drawing representing an example of electronic mail sent and received in the aforementioned embodiment;

FIG. 30 is a drawing illustrating another item of master data for authentication in the aforementioned embodiment;

FIG. 31 is a drawing representing another example of electronic mail sent and received in the aforementioned embodiment;

FIG. 32 is a flow chart representing another operation of the aforementioned equipment embodiment;

FIG. 33 is a drawing illustrating master data for authentication in the aforementioned embodiment;

FIG. 34(a) and FIG. 34(b) are drawings representing an example of electronic mail sent and received in the aforementioned embodiment.

FIG. 35 is a drawing representing another example of electronic mail sent and received in the aforementioned embodiment; and

FIG. 36 is a drawing representing an example of electronic mail for reporting reception of illegal mail to a manager in the aforementioned embodiment.

### DETAILED DESCRIPTION OF THE PREFERRED EMBODIMENT

Referring to drawings, the following describes a network image forming apparatus system and a method of registering the image forming apparatus for use in a network according to the present invention.

<Network Image Forming Apparatus System>

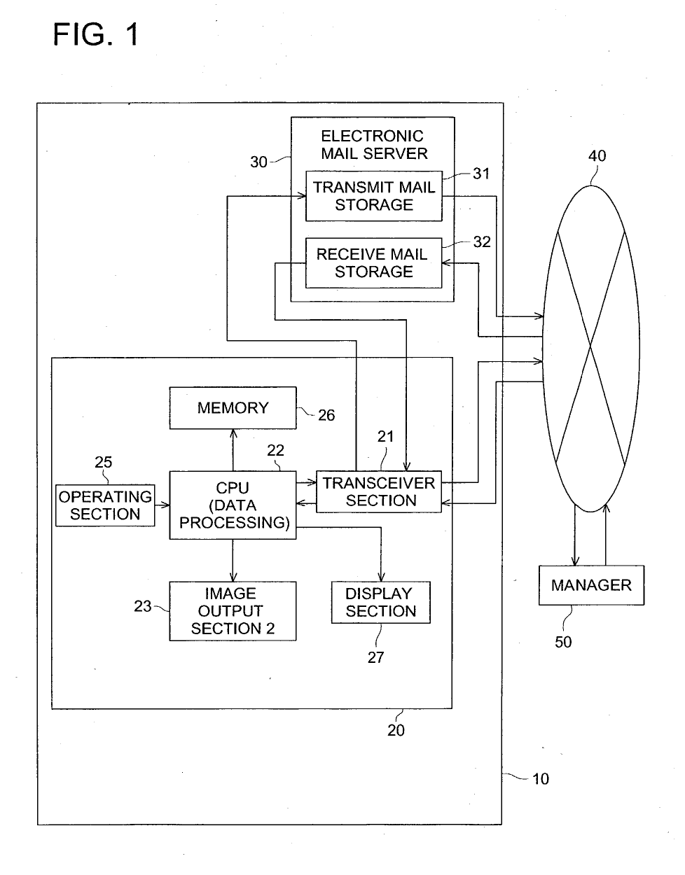

As shown in FIG. 1, a network image forming apparatus system according to the present invention is embodied in the network image forming apparatus system 20 basically comprising: an image forming apparatus 20 further including: a transceiver section 21 as transceiver means for communications with a predetermined network, and a data processing section (CPU: Central Processing Unit) 22 as data processing means for obtaining image data from the communication data received from the aforementioned transceiver means; and an electronic mail server further including: a transmit mail storage 31 for temporarily storing electronic mail sent from the transceiver means to the network, wherein the transmit mail storage 31 is coupled to both the network and transceiver means of the image forming apparatus for communications with the network, and a receive mail storage 32 for temporarily storing electronic mail sent from the network to the transceiver means.

As shown in FIG. 1, the network image forming apparatus system 10 is connected to a manager through an adequate network 40, for example, via the Internet. The manager 50 is connected to the network 40 through an information terminal apparatus (not illustrated), for example, a personal computer or a cellular phone. Either wired or wireless means may be used for connection between this information terminal apparatus and network 40. The manager is not subjected to any restriction; it includes a parameter setting personnel (hereinafter abbreviated as “setting person”) to be described later and a maintenance manager of the image forming apparatus 20.

Further, the image forming apparatus 20 forms images according to the aforementioned image data, and is further provided with: an image output section 23 as image output means for producing an image; an operating section 25 as an operating means for setting and inputting a predetermined connection parameter for connecting the transceiver section 21 to both storages of the electronic mail server 30; a memory 26 as memory means for memorizing the connection parameter set and entered from the operating section; and a display section 27 for displaying the setting and entry status by the operating section 24.

The aforementioned image forming apparatus 20 is not subjected to any restriction if it is provided with these components, namely, a transceiver section 21, data processing section (CPU) 22, an image output section 23, an operating section 25, memory 26 and display section 27. To put it more specifically, the image forming apparatus 20 can be a copying machine, fax machine, scanner or composite thereto (hereinafter also referred to as “main unit”) provided with the aforementioned components. An information terminal apparatus and main unit can be connected with each other to permit exchange of data. To put it more specifically, an information terminal apparatus and main unit are connected through such an information communication network as the LAN (Local Area Network) or WAN (Wide Area Network). This information terminal apparatus and main unit can be connected with each other either by wired means or wireless means. Alternatively, a browser may be used for this connection.

Further, the transceiver section 21 sends the electronic mail created by the operation from the operating section 25 and sent from the data processing section (CPU), to the transmit mail storage 31 of an electronic mail server 30 to be described later, and captures the electronic mail stored in the receive mail storage 32. As will be described later, when setting the connection parameter, the transceiver section 21 sends the confirmation mail created by the data processing section (CPU), to the electronic mail server 30 from this connection parameter having been set and entered. Further, when receiving this confirmation mail again, it receives the returned confirmation mail from the electronic mail server 30.

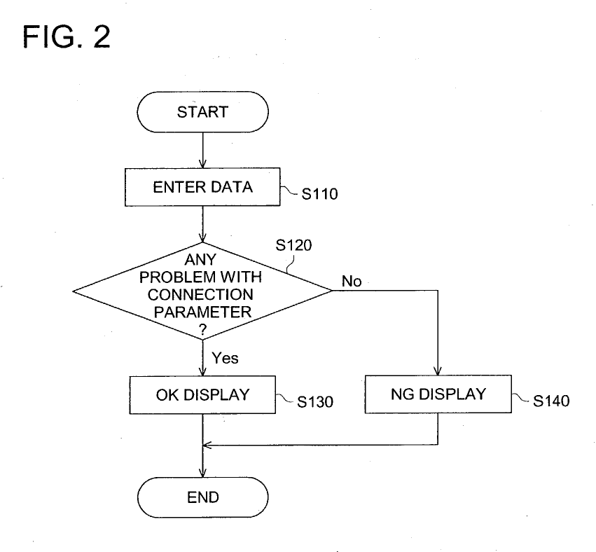

The data processing section (CPU) 22 controls the sections 21, 23, 24, 25, 26 and 27 according to the predetermined program stored in the memory 26 to be described later, namely, the control program shown in the flow charts FIGS. 2, 8 to 12, 14 to 18.

In addition to forming an image from the general image data, an image output section 23 forms as an image the information that should be displayed for the setting person in the control of the data processing section (CPU) 22, and produces this image according to the request from the data processing section (CPU) 22. To put it more specifically, it is printed out in paper.

The operating section 25 is not subjected to any restriction if it serves to enter information; it can be a keyboard, numeric keypad or mouse, for example. Further, the operating section 25 can be an operating section formed integrally with the main unit, and/or an operating section of the aforementioned information terminal apparatus connected with the main unit.

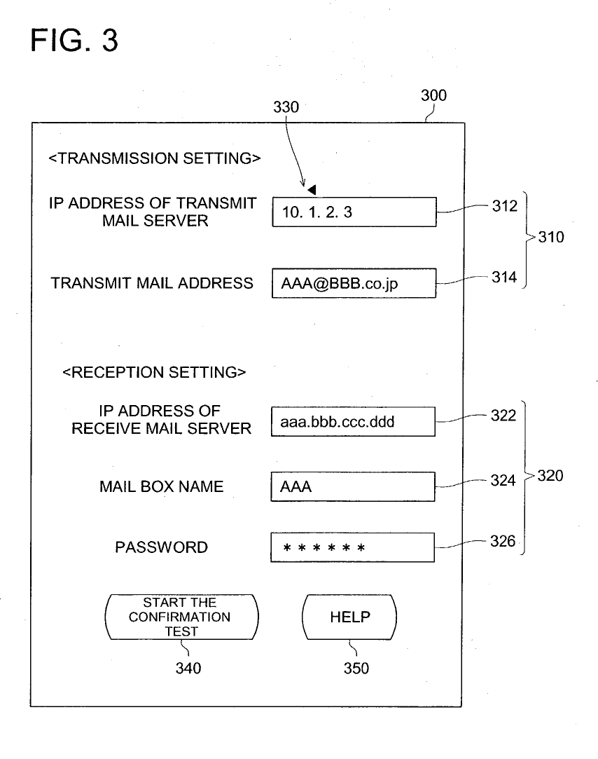

In addition to memorizing the information for inducing creation of electronic mail, the memory 26 memories the information for inducing setting of the connection parameter to be described later, namely, confirmation screen shown in FIGS. 3 to 7 and 13.

The display section 27 is a screen of the aforementioned main unit and/or the screen of the information terminal apparatus connected to the main unit. It displays the confirmation screen shown in FIGS. 3 to 7 and 13. The image output section 23 and display section 27 can be made integral with each other.

The electronic mail server 30 also serves both as a transmit mail server and a receive mail server, and is provided with a transmit mail storage 31 and a receive mail storage 32 corresponding to respective functions.

The electronic mail server 30 is connected in such a way as to allow transmission and reception of electronic mail with the electronic mail server 30. To put it more specifically, it is connected via the information communication network such as LAN (Local Area Network) and WAN (Wide Area Network). Further, the image forming apparatus 20 is directly connected to the network 40 to exchange electronic mail with the electronic mail server 30 present in the network 40.

The transmit mail storage 31 temporarily stores the electronic mail (including the confirmation electronic mail) created by the image forming apparatus 20 and sent to the electronic mail server 30 through the transceiver section 21, and sends it thereafter. In the meantime, the receive mail storage 32 is provided preferably for each image forming apparatus. When having again received the electronic mail sent to the electronic mail server 30 through the network 40 and the confirmation electronic mail, it receives the confirmation mail and stores it temporarily. Then it sends the confirmation mail to the transceiver section 21 in response to the request of the data processing section (CPU) 22.

Further, the confirmation mail can be sent to the manager 50. In this case, the confirmation mail is sent to the information terminal apparatus (not illustrated) owned by the manager 50 through the network through the personal computer and cellular phone, for example.

<Method of Registering an Image Forming Apparatus for Use in a Network>

This is the method of registering an image forming apparatus 20 for use in a network according to the present invention in a system 10 comprising: an image forming apparatus 20 further including: a transceiver section 21 for communications with a predetermined network, and a data processing section 22 for processing the communication data received from the aforementioned transceiver section 21; and an electronic mail server further including: a transmit mail storage 31 for temporarily storing electronic mail sent from the transceiver section 21 to the network 40, wherein the transmit mail storage 31 is coupled to both the network and transceiver section 21 of the image forming apparatus 20 for communications with the network, and a receive mail storage 32 for temporarily storing electronic mail sent from the network to the transceiver section 21.

The following describes each embodiment with reference to drawings.

First Embodiment

As shown in FIG. 2, the first embodiment of the <Method of registering an image forming apparatus for use in a network> according to the present invention comprises: an input step (Step S110) for prompting a predetermined connection parameter to be set and entered to connect the transceiver section 21 with both storages (31) and (32) of the electronic mail server 30; a parameter determining step (Step S120) for determining if the connection parameter set and entered in the aforementioned input step is valid or not, by monitoring the connection status of the transceiver section 21 and transmit mail storage 31 and/or connection status of the transceiver section 21 and receive mail storage 32 using the connection parameter at the time of setting and inputting in the input step; and display steps (Steps S130 and 140) for displaying the result of evaluation in the aforementioned parameter determining step, and for displaying a message to prompt reentry of the connection parameter in the operating means as required, if the connection parameter has been determined not valid.

As shown in FIG. 2, the setting person uses the operating section 25 to enter the connection parameter data in Step S110.

To put it more specifically, the data input screen 300 is displayed on the display section 27. On the data input screen 300 shown in FIG. 3 are displayed a transmit set/input window 310, a receive set/input window 320, a select cursor 330, a confirmation test start button 340 and a HELP button 350.

The transmit set/input window 310 consists of an IP address input window 312 for entering the address of the transmit mail server portion inside the electronic mail server 30, and a transmit mail input window 314 for entering an address for specifying the transmit mail storage 31 in the transmit mail server.

In the meantime, the receive set/input window 320 consists of: an IP address input window 322 for entering the address of the receive mail server portion inside the electronic mail server 30, a mail box name input window 324 for entering the mail box name to specify the receive mail storage 32 in the mail server, and a transmit mail input window 314 for entering an address for specifying the transmit mail storage 31 in the transmit mail server.

The setting person uses the select cursor 330 displayed on the data input screen 300 and select a desired input window to click the input window. This procedure causes the input window to be set to the input state. Then the setting person enters a predetermined parameter from the operating section 25. In this manner, predetermined parameters are entered into all the aforementioned window from the operating section 25.

Upon completion of the entry of the aforementioned connection parameters, the setting person clicks the confirmation test start button 340. If there is any an unclear point or questions, the setting person clicks the HELP button 350.

When the confirmation test start button 340 has been clicked, the system proceeds to the Step S120.

In Step S120, the connection status of the transceiver section 21 and transmit mail storage 31 and/or connection status of the transceiver section 21 and receive mail storage 32 are monitored using the connection parameter set and entered in Step S110, thereby determining if the connection parameter set and entered in the aforementioned input step is valid or not. To put it more specifically, the confirmation mail is sent to its own receive mail storage 32 or manager 50 to determine if the confirmation mail has been rejected or not.

Here the “the confirmation mail has been rejected” occurs in cases where: Connection has failed due to an error in setting the IP address of the transmit mail server; Transmission has been rejected from the transmit mail server; The transmit parameter (sender's mail address, etc.) is illegal; Connection has failed due to an error in setting the IP address of the receive mail server; Reception has been rejected from the receive mail server; Receive parameter (user's name, password, etc.) is illegal; The transmitted confirmation mail has not yet reached the receive mail storage 32, or The confirmation mail cannot be received by the receive mail storage 32, for example, because the contents of confirmation mail are incorrect.

When the result of evaluation is YES, namely when the connection parameter has been determined to be valid, the system goes to Step S130. If the result of evaluation is NO, namely when the connection parameter has been determined to be invalid, the system goes to Step S140.

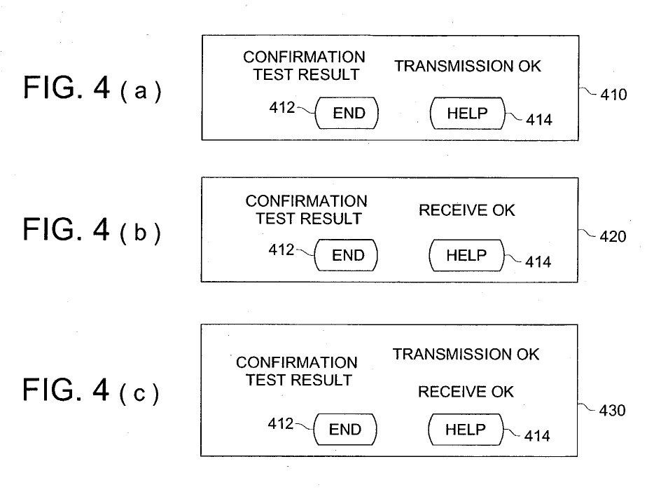

In Step S130, the OK screen is displayed on the display section 27 to indicate that the connection is satisfactory (OK). To put it more specifically, the confirmation screens 410, 420 and 430 in FIG. 4(a) to FIG. 4(c) are displayed on the display section 27.

The confirmation screen 410 shown in FIG. 4(a) is an OK display screen for the cases where connection is confirmed by sending the confirmation mail to its own receive mail storage 32 or development apparatus 50. To be more specific, it is displayed when the connection parameter entered in the transmit set/input window 310 illustrated in FIG. 3 has been evaluated as valid. The END button 412 and HELP button 414 are displayed also on the confirmation screen 410.

The confirmation screen 420 shown in FIG. 4(b) is an OK screen for the cases where confirmation has been made to determine whether or not the image forming apparatus 20 can access its own receive mail storage 32, independently of the confirmation electronic mail. In other words, it is displayed when the connection parameter entered in the receive set/input window 320 shown in FIG. 3 has been evaluated as valid. The END button 412 and HELP button 414 are also indicated on the confirmation screen 420.

The confirmation screen 430 in FIG. 4(c) is an OK screen for the cases where connection has been confirmed by sending the confirmation mail to its own receive mail storage 32 and by receiving this confirmation electronic mail. To be more specific, it is displayed when the connection parameter entered in the transmit set/input window 310 illustrated in FIG. 3 has been evaluated as valid, and the connection parameter entered in the receive set/input window 320 has been evaluated as valid. The END button 412 and HELP button 414 are also displayed on the confirmation screen 430.

As described above, confirmation screens 410, 420 and 430 are displayed on the display section 27, and the setting person confirms that aforementioned connection status is satisfactory and clicks the END button 412. This procedure terminates the registration of the image forming apparatus for use in the network. If there is any unclear points or questions, the setting person clicks the HELP button 414.

When the result of evaluation in Step S120 is NO, namely when the connection parameter has been determined to be invalid, the system goes to Step S140.

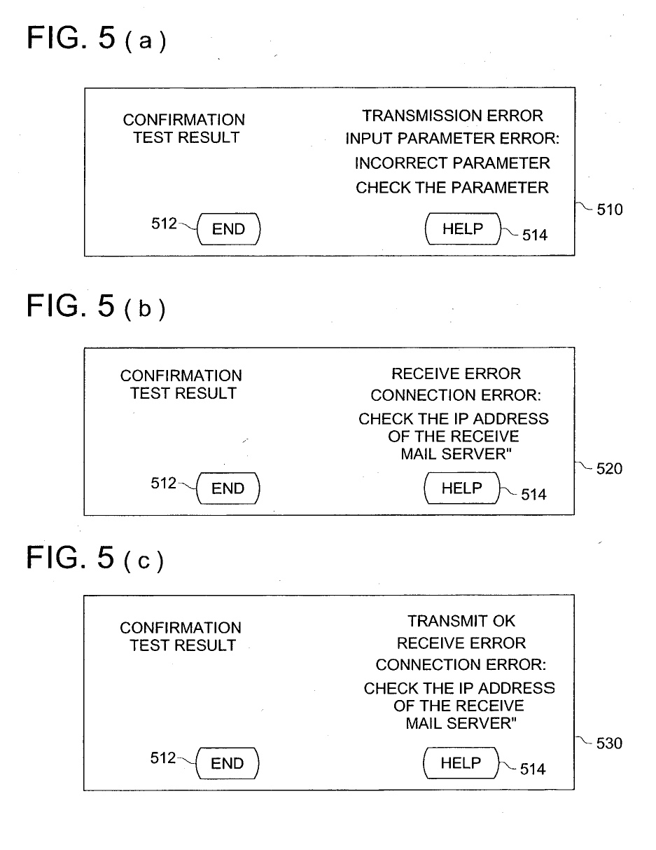

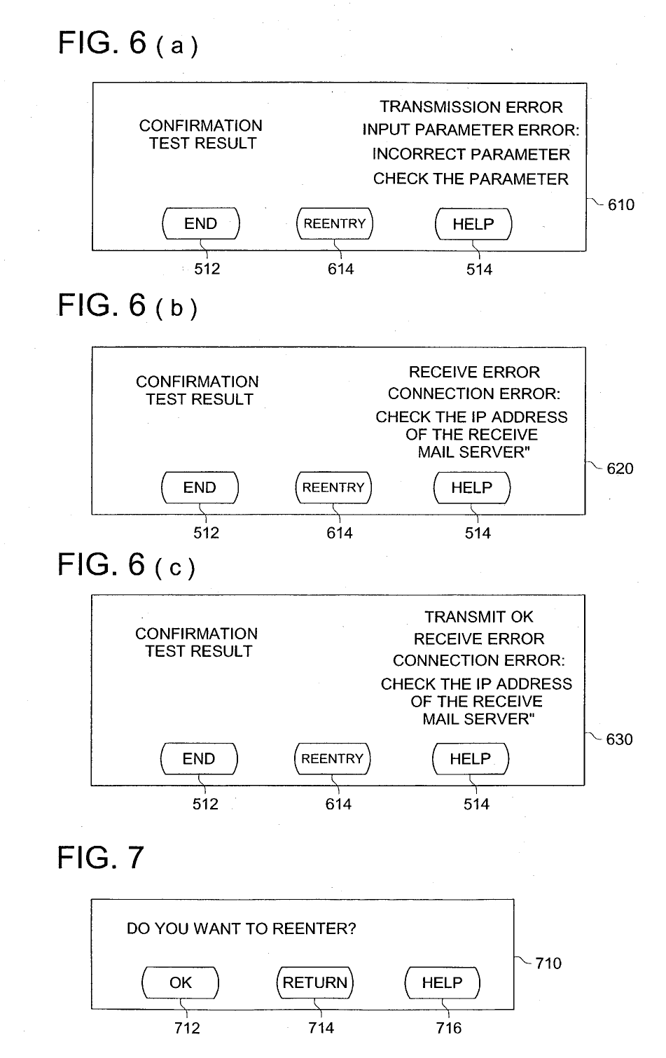

In Step S140, the NG screen is displayed on the display section 27 to indicate that the connection is faulty (NG). To put it more specifically, the confirmation screens 510, 520, 530 in FIG. 5(a) to FIG. 5(c), 610, 620 and 630 in FIG. 6(a) to FIG. 6(c) are displayed on the display section 27.

The confirmation screen 510 shown in FIG. 5(a) is an NG screen for the cases where the confirmation mail has failed to be sent to the transmit mail storage 31 when connection status is confirmed by sending the confirmation mail to the manager 50 or its own receive mail storage 32. In other words, it is displayed on the display section 27 when connection parameter entered in the transmit set/input window 310 shown in FIG. 3 has been determined to be invalid. The END button 512 and HELP button 514 are displayed on the confirmation screen 510. It is preferred that the cause for the invalidity of the connection parameter be indicated.

On the confirmation screen 510 shown in FIG. 5(a), a message “Input parameter error: Incorrect parameter. Check the parameter.” is given as an example. Other messages include “Input parameter error: No parameter. Enter the parameter”, “Connection error: Check the IP address of the transmit mail server.” and “Transmit error: Transmission was rejected by the transmit mail server.”

The confirmation screen 520 shown in FIG. 5(b) is an NG screen for the cases where confirmation has been made to determine whether or not the image forming apparatus 20 can access its own receive mail storage 32, independently of the confirmation electronic mail. The cause for the invalidity of the connection parameter entered in the receive set/input window 320 shown in FIG. 3 is indicated on the display section 27. The END button 512 and HELP button 514 are displayed on the confirmation screen 520. It is preferred that the cause for the invalidity of the connection parameter be indicated.

For example, “Connection error: Check the IP address of the receive mail server.” appears on the confirmation screen 520 shown in FIG. 5(b). In addition, the following messages showing the causes for an error are also displayed: “Receive mailbox authentication error: Check the mailbox name.”, “Receive mailbox authentication error: Check the password.”, “Receive mailbox authentication error: Check the mailbox name and password.”, and “Receive error: Reception has been rejected by the receive mail server”.

Further, the confirmation screen 530 shown in FIG. 5(c) is an NG screen for the cases wherein, when connection is confirmed by sending the confirmation mail to its own receive mail storage 32, and receiving this confirmation electronic mail, the confirmation mail has failed to be received by its own receive mail storage despite correct transmission operation. Namely, this screen appears on the display section 27 when the connection parameter entered in the transmit set/input window 310 shown in FIG. 3 has been evaluated as valid and the connection parameter entered in the receive set/input window 320 has been evaluated as invalid. The END button 512 and HELP button 514 are displayed on the confirmation screen 510. It is preferred that the cause for the invalidity of the connection parameter be indicated.

For example, “Connection error: Check the IP address of the receive mail server.” appears on the confirmation screen 530 shown in FIG. 5(c). In addition, the following messages showing the causes for an error are also displayed: “Receive mailbox authentication error: Check the mailbox name.”, “Receive mailbox authentication error: Check the password.”, “Receive mailbox authentication error: Check the mailbox name and password.”, and “Receive error: Reception has been rejected by the receive mail server”.

As described above, confirmation screens 510, 520 and 530 are displayed on the display section 27, and the setting person checks the cause for error and clicks the END button 512. This procedure terminates the work of registering the image forming apparatus 20 for use in the network as it is not registered. If there is any unclear points or questions, the setting person clicks the HELP button 514.

It is preferred that a display step is provided for prompting reentry of the connection parameter of the operating section 25 as required, when it has been determined in the aforementioned parameter determining step (Step S120) that the connection parameter is invalid.

To put it more specifically, it is preferred that the confirmation screens 610, 620 and 630 shown in FIGS. 6(a) to (c) be displayed on the display section 27.

These confirmation screens 610, 620 and 630 are the same as the confirmation screens 510, 520 and 530 shown in FIGS. 5(a) to (c), plus reentry buttons 614 added thereto.

When the setting person has determined to perform reentry of a connection parameter, the setting person is allowed to click the reentry button 614 on the aforementioned confirmation screens 610, 620 and 630. To suspend the registration of the image forming apparatus for use in the network, the setting person is allowed to click the END button 512. If there is any unclear points or questions, the setting person clicks the HELP button 514.

When the Reentry button 614 has been clicked on the aforementioned confirmation screens 610, 620 and 630, the confirmation screen 710 for prompting the setting person to reenter the connection parameter with the message of “Do you want to reenter?” as shown in FIG. 7 is displayed on the display section 27.

An OK button 712, Return button 714 and HELP button 716 are indicated on the confirmation screen 710.

When the setting person has determined to reenter the connection parameter, the setting person is allowed to click the OK button 712 of the confirmation screen 710. When the OK button 712 is clicked, the system returns to the data input screen 300 and allows the setting person to reenter the connection parameter. If there is any unclear points or questions, the setting person clicks the HELP button 716.

As will be described later, when the setting person has reentered the data, the image forming apparatus 20 is rebooted as required and the system proceeds to the Parameter determining step (Step S120) again.

When the setting person has determined not to reenter the data on the confirmation screen 710, the setting person is allowed to click the Return button 714, and the confirmation screens 610, 620 and 630 shown in FIG. 6(a) to (c) are displayed on the display section 27. When the setting person clicks the END button 512 on this confirmation screen, the work of registering the image forming apparatus for use in the network is terminated without the image forming apparatus being registered.

This embodiment has been explained using an example wherein a predetermined confirmation screen is displayed on the display section 27 and buttons displayed on these confirmation screens are clicked. It is also possible that an image is formed by the image output section 23 based on the image data on the confirmation screen, and the medium with the image printed thereon is output. Then this medium is confirmed by the setting person, and the specified operation is performed from the operating section 25. This applies also to the embodiments to be described below.

Further, this embodiment has been explained using an example wherein, to confirm the transmit and receive statuses at the same time, the confirmation mail is sent to its own receive mail storage 32, and reception of this confirmation mail is confirmed. Without being restricted to this method, it is also possible to use the method where, after the confirmation mail has been sent to the manager 50, the predetermined mail is returned subsequent to reception of this mail by the manager 50, and evaluation is made to determine if this electronic mail has been received or not. This applies also to the embodiments to be described later.

Second Embodiment

The second embodiment of the method of registering the image forming apparatus for use in a network is a preferred embodiment of the parameter determining step (Step S120) in the aforementioned embodiment.

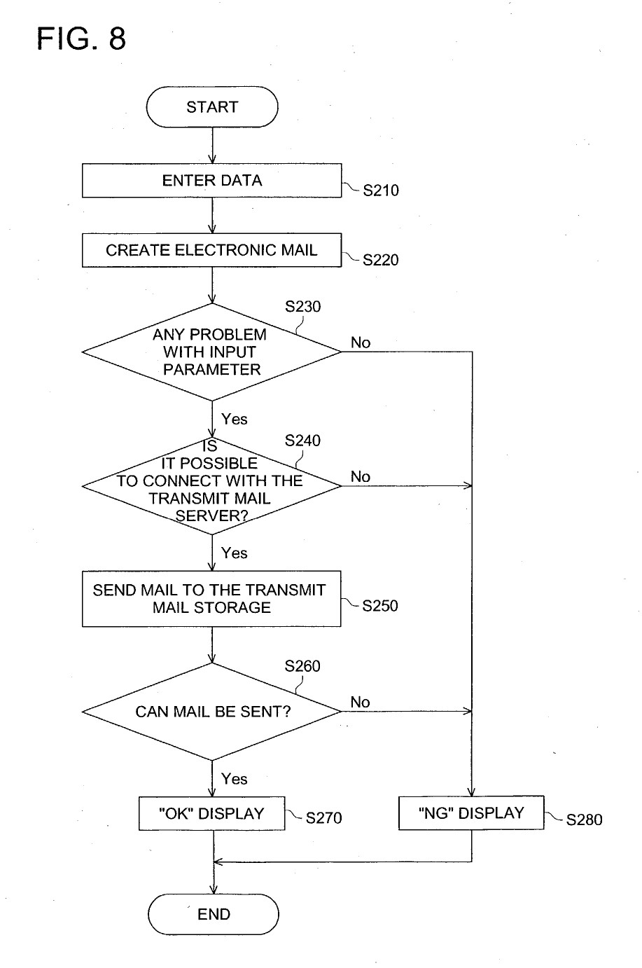

As shown in FIG. 8, the second embodiment of the present invention comprises: an electronic mail creation step (S220) for creating confirmation mail according to the setting and entry in the input step and for sending the confirmation mail to the transceiver section 21; transmit steps (Steps S230 to 250) for transmitting the aforementioned confirmation mail to the transceiver section 21 using the connection parameter for the connection between the transceiver section 21 and receive mail storage 32; and a reject confirmation determining step (Step S260) for determining whether or not the confirmation mail sent in the aforementioned transmit step is rejected by the transceiver section, and for determining that the confirmation screen is invalid if it has been confirmed that the confirmation mail has been rejected.

In the Step S210 as shown in FIG. 8, the setting person 25 is allowed to use the operating section 25 to enter the connection parameter data, similarly to the case of the aforementioned Step S110.

To put it more specifically, on the data input screen 300 given in FIG. 3, the setting person is allowed to enter the connection parameter, similarly to the case of the Step S111, and to click the confirmation test start button 340. Then the system proceeds to the Step S220.

In Step S220, confirmation mail is created by the data processing section (CPU) 22 using the connection parameter entered in the Step S210, and the system proceeds to Step S230.

In Step S230, the entered connection parameter is checked by the data processing section (CPU) 22. To put it more specifically, a syntax check is made to determine if the connection parameter has been entered or not, and if a symbol not used in the connection parameter is used or not. The expression “have a syntax error” used in the following description refers to the topsy-turvy cases where a parameter itself is not entered, a dot is not entered when entering an IP address, or four symbol groups separated by dots are not found in a complete form.

If the result of the above check is YES, namely, if the entered connection parameter has no syntax error, then the system proceeds to Step S240. If the result of the check is NO, namely, if the connection parameter has a syntax error, then the system proceeds to Step S280.

In Step S240, evaluation is made to determine whether or not the transceiver section 21 can be connected to the transmit mail storage 31, using the parameter for the connection between the transceiver section 21 and transmit mail storage 31.

To put it more specifically, the IP address of the transmit mail server entered in the IP address input window 312 of the transmit mail server shown in FIG. 3 is used to check whether or not the transceiver section 21 can be connected to the transmit mail storage 31.

If the result of the above check is YES, namely, if the transceiver section 21 can be connected with the transmit mail storage 31, then system proceeds to Step S250. If the result of the above check is NO, namely, if the transceiver section 21 cannot be connected with the transmit mail storage 31, then system proceeds to Step S280.

In Step S250, the transceiver section 21 transmits confirmation mail to the transmit mail storage 31 and the system goes to Step S260.

In the Step S260, evaluation is made to determine if the transmit mail storage 31 can send the confirmation mail to a predetermined party or not. In other words, evaluation is made to determine whether or not the confirmation mail is returned to the transceiver section 21 without being sent to the transmit mail storage 31 when the confirmation mail is sent from the transceiver section 21 to the transmit mail storage 31. If the confirmation mail has been returned to the transceiver section 21, it is determined that transmission has failed or the parameter for this connection is invalid. Here “a predetermined party” refers to the image forming apparatus 20 or manager 50.

In Step S260, if the result of evaluation is YES, namely if the confirmation mail has been sent, then the system goes to Step S270. If it is NO, namely if the confirmation mail has been returned to the transceiver section 21, then the system goes to Step S280. In the Step S270, the confirmation screen 410 indicating “OK” as shown in FIG. 4(a) is displayed on the display section 27.

In Step S280, the confirmation screen 510 indicating “NG” as shown in FIG. 5(a) is displayed on the display section 27.

On the confirmation screen 510 to be displayed when the result of evaluation in Step S230 is “NO”, causes for evaluated invalid connection parameter are indicated. These causes include “Input parameter error: Incorrect parameter. Check the parameter.” and “Input parameter error: No parameter entry. Enter the parameter”.

On the confirmation screen 510 to be displayed when the result of evaluation in Step S240 is “NO”, causes for evaluated invalid connection parameter are indicated. These causes include “Connection error: Check the IP address of the transmit mail server”.

On the confirmation screen 510 to be displayed when the result of evaluation in Step S260 is “NO”, causes for evaluated invalid connection parameter are indicated. These causes include “Transmit error: Transmission has been rejected by the transmit mail server”.

Third Embodiment

The third embodiment of the method of registering the image forming apparatus for use in a network is a preferred embodiment of the parameter determining step (Step S120) in the aforementioned first embodiment.

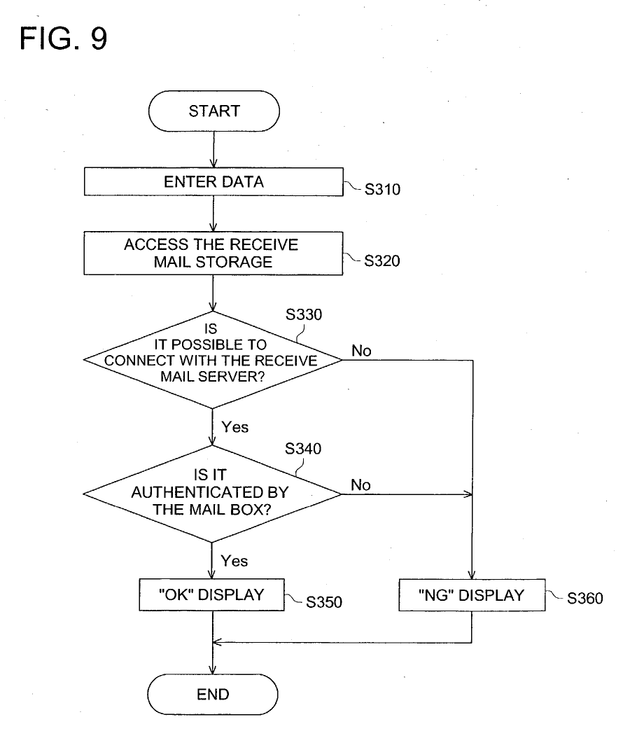

As shown in FIG. 9, the third embodiment of the present invention comprises: an access step (Step S320) for allowing the transceiver section 21 to access the receive mail storage 32, using the parameter for connection between the transceiver section 21 and receive mail storage 32, this connection parameter having been set and entered in the input step (Step S310); and an access confirmation determining steps (Steps S330 and 340) for determining whether or not the access in the aforementioned access step succeeded, and for determining that the parameter for the connection is invalid if it has been confirmed that the access failed.

As shown in FIG. 9, in Step S310, the setting person is allowed to use the operating section 25 to enter the connection parameter, similarly to the case of the above Step S110.

To put it more specifically, in the data input screen 300 shown in FIG. 3, the setting person is allowed to enter the connection parameter similarly to the case of the aforementioned Step S110, and to click the confirmation test start button 340. Then the system proceeds to Step S320.

In Step S320, the transceiver section 21 is allowed to access the receive mail storage 32 by the data processing section (CPU) 22 according to the aforementioned connection parameter, and the system proceeds to the Step S330.

In Step S330, evaluation is made to determine if the transceiver section 21 can be connected to the receive mail storage 32, according to the parameter for connection between the transceiver section 21 and receive mail storage 32, wherein this parameter is entered in Step S310.

To put it more specifically, evaluation is made to determine whether or not there is any receive mail server corresponding to the IP address entered into the IP address input window 322 of the receive mail server, namely, whether or not the transceiver section 21 can be connected to the receive mail storage 32 assigned in advance, based on the IP address.

When the result of evaluation is YES, namely when it can be connected to a predetermined receive storage, the system proceeds to Step S340. If the result of evaluation is NO, namely if it cannot be connected, the system goes to Step S360.

In Step 340, evaluation is made to determine if the transceiver section 21 is authenticated or not by the receive mail storage 32, according to the parameter for connection between the transceiver section 21 and receive mail storage 32, wherein this parameter is entered in Step S310.

To put it more specifically, evaluation is made to determine whether or not the transceiver section 21 is authenticated by the receive mail storage 32 according to the mailbox name and password entered into the mailbox name input window 324 and password input window 326 shown in FIG. 3.

When the result of evaluation is YES, namely when the transceiver section 21 has been authenticated by the receive mail storage 32, the system goes to Step S350. If the result of evaluation is NO, namely if it is not authenticated, the system goes to Step S360.

In the Step S350, the confirmation screen 420 indicating “OK” as given in FIG. 4(b) is displayed on the display section 27.

In Step S360, the confirmation screen 520 indicating “NG” as given in FIG. 5(b) is displayed on the display section 27.

On the confirmation screen 520 displayed when the result of evaluation in Step S330 is “NO”, causes for the evaluated invalid connection parameter are indicated. These causes include “Connection error: Check the IP address of the receive mail server”.

On the confirmation screen 520 displayed when the result of evaluation in Step S340 is “NO”, causes for the evaluated invalid connection parameter are indicated. These causes include “Receive mailbox authentication error: Check the mailbox name.”, “Receive mailbox authentication error: Check the password” and “Receive mailbox authentication error: Check the mailbox name and password”.

Fourth Embodiment

The fourth embodiment of the method of registering the image forming apparatus for use in a network is a preferred embodiment of the parameter determining step (Step S120) in the aforementioned first embodiment.

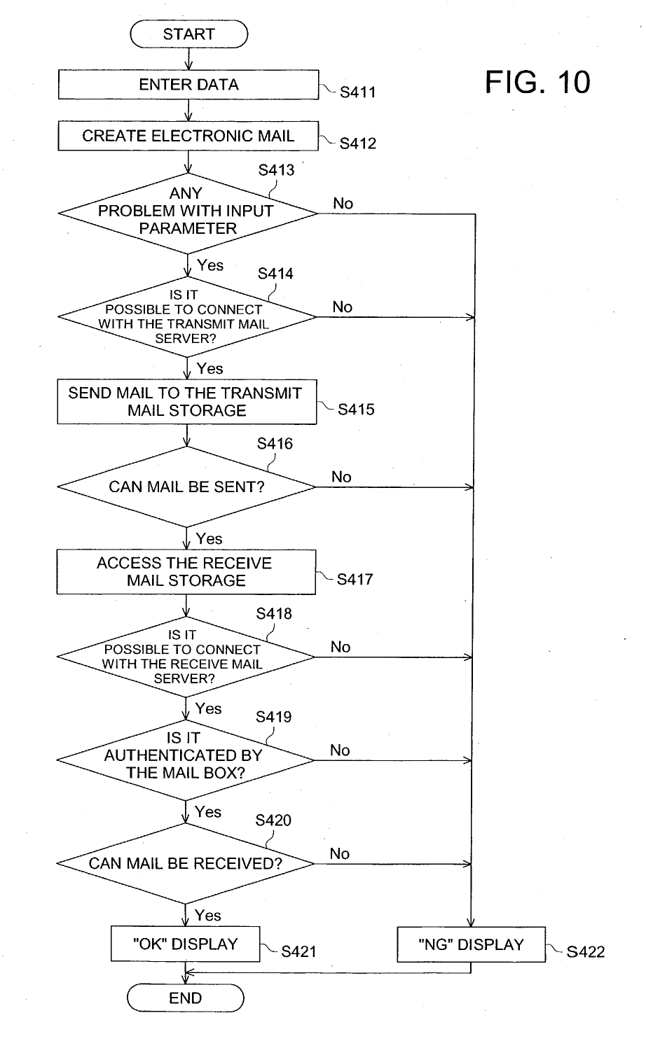

As shown in FIG. 10, the fourth embodiment of the present invention comprises: an electronic mail creation step (Step S412) for creating according to the setting and entry in the input step (Step S411) the confirmation mail to be sent to the receive mail storage 32 specified by the connection parameter set and entered in the aforementioned input step, and for sending the confirmation mail to the transceiver section 21; transmit steps (Steps S413 to 415) for allowing the transceiver section to send the aforementioned confirmation electronic mail, using the parameter of connection between the aforementioned transceiver section and transmit mail storage, this parameter having been set and entered in the aforementioned input step; a reject confirmation determining step (Step S416) for determining whether or not the confirmation mail sent in the aforementioned transmit step is rejected by the transceiver section, and for determining that the confirmation screen is invalid if it has been confirmed that the confirmation mail has been rejected; an access step (Step S417) for allowing the transceiver section to access the receive mail storage, using the parameter for connection between the transceiver section and receive mail storage, this connection parameter having been set and entered in the input step; an access confirmation determining steps (Steps S418 and 419) for determining whether or not the access in the aforementioned access step succeeded, and for determining that the parameter for the connection is invalid if it has been confirmed that the access failed; and a receive confirmation determining step (Step 420) for determining whether or not confirmation mail has been received by the receive mail storage, and for determining that confirmation mail has not been sent and received correctly if confirmation of reception cannot be made.

As shown in FIG. 10, in Step S411, the setting person is allowed to use the operating section 25 to enter the connection parameter, similarly to the case of the Step S110.

To put it more specifically, on the data input screen 300 shown in FIG. 3 the setting person is allowed to enter the connection parameter, similarly to Step S110, and to click the confirmation test start button 340. Then the system proceeds to Step S412.

In Step S412, confirmation mail is created by the data processing section (CPU) 22 using the connection parameter entered in Step S411, and the system goes to Step S413.

In Step S413, the entered connection parameter is subjected to syntax check by the data processing section (CPU) 22.

If the result of this check is YES, namely if no syntax error has been found in the connection parameter, the system goes to Step S414. If the result of this check is NO, namely if a syntax error has been found in the connection parameter, the system goes to Step S422.

In Step S414, evaluation is made to determine if the transceiver section 21 can be connected to the transmit mail storage 31, according to the parameter for connection between the transceiver section 21 and transmit mail storage 31.

To put it more specifically, evaluation is made to determine whether or not the transceiver section 21 can be connected to the transmit mail storage 31 according to the IP address of the transmit mail server entered in the IP address input window 312 of the transmit mail server shown in FIG. 3.

If the result of this check is YES, namely if the transceiver section 21 can be connected to the transmit mail storage 31, the system proceeds to the Step S415. If the result of this check is NO, namely if it cannot be connected, the system proceeds to the Step S422.

In Step S415, the transceiver section 21 sends confirmation mail to the transmit mail storage 31, and the system proceeds to the Step S416.

In Step S416, evaluation is made to determine whether or not the transmit mail storage 31 can send confirmation electronic mail. In other words, when confirmation mail is sent from the transceiver section 21 to the transmit mail storage 31, evaluation is made to determine whether or not the confirmation mail has been returned to the transceiver section 21 without being sent to the transmit mail storage 31. If it has been returned to the transceiver section 21, it is determined that the mail cannot be sent, namely the parameter related to this connection is invalid.

If the result of this check is YES in Step S416, namely if confirmation mail has been sent, the system proceeds to the Step S417. If the result of this check is NO, namely if the confirmation mail has been returned to the transceiver section 21, the system proceeds to the Step S422.

In Step S417, the transceiver section 21 is allowed to access the receive mail storage 32 according to the aforementioned parameter, and the system proceeds to the Step S418.

In Step S418, evaluation is made to determine whether or not the transceiver section 21 can be connected to the receive mail storage 32, according to the parameter for connection between the transceiver section 21 and receive mail storage 32, this parameter having been entered in Step S411.

To put it more specifically, evaluation is made to determine whether or not there is the receive mail server corresponding to the IP address entered in the IP address input window 322 of the receive mail server shown in FIG. 3, namely whether or not the transceiver section 21 can be connected to the pre-assigned receive mail storage 32 according to the IP address.

If the result of this check is YES, namely if transceiver section 21 can be connected to a predetermined receive mail storage, the system proceeds to the Step S419. If the result of this check is NO, namely if it cannot be connected, the system proceeds to the Step S422.

In Step S419, evaluation is made to determine whether or not the transceiver section 21 has been authenticated by the receive mail storage 32, according to the parameter for connection between the transceiver section 21 and receive mail storage 32, this parameter having been entered in Step S411.

To put it more specifically, evaluation is made to determine whether or not the transceiver section 21 has been authenticated by the receive mail storage 32, according to the mailbox name and password entered in the mail box name input window 324 and password input window 326 shown in FIG. 3.

If the result of this check is YES, namely if the transceiver section 21 has been authenticated by the receive mail storage 32, the system proceeds to the Step S420. If the result of this check is NO, namely if it is not authenticated, the system proceeds to the Step S422.

In Step S420, evaluation is made to determine whether or not the confirmation mail sent from the image forming apparatus 20 to its own equipment has been received by the receive mail storage 32.

If the result of this check is YES, namely if the aforementioned confirmation mail has been received by the receive mail storage 32, the system proceeds to the Step S421. If the result of this check is NO, namely if it has not been received, the system proceeds to the Step S422.

In Step S421, the confirmation screen 430 indicating “OK” as given in FIG. 4(c) is displayed on the display section 27. It is also possible to make arrangements so that the image forming apparatus 20 can receive confirmation mail from the receive mail storage 32 at the discretion of the setting person or automatically.

In Step S422, the confirmation screens 510 and 530 indicating “NG” as given in FIGS. 5(a) and (c) are displayed on the display section 27.

On the confirmation screen 510 displayed when the result of the check in Step S413 is NO, causes for the evaluated invalid connection parameter are indicated. These causes include “Input parameter error: Incorrect parameter. Check the parameter”, and “Input parameter error: No parameter entry. Enter the parameter”.

On the confirmation screen 510 displayed when the result of the check in Step S414 is NO, causes for the evaluated invalid connection parameter are indicated. These causes include “Connection error: Check the IP address of the transmit mail server”.

On the confirmation screen 510 to be displayed when the result of evaluation in Step S416 is “NO”, causes for evaluated invalid connection parameter are indicated. These causes include “Transmit error: Transmission has been rejected by the transmit mail server”.

On the confirmation screen 530 to be displayed when the result of evaluation in Step S418 is “NO”, causes for evaluated invalid connection parameter are indicated. These causes include “Connection error: Check the IP address of the receive mail server”.

On the confirmation screen 530 displayed when the result of evaluation in Step S419 is “NO”, causes for the evaluated invalid connection parameter are indicated. These causes include “Receive mailbox authentication error: Check the mailbox name.”, “Receive mailbox authentication error: Check the password” and “Receive mailbox authentication error: Check the mailbox name and password”.

On the confirmation screen 530 to be displayed when the result of evaluation in Step S420 is “NO”, causes for evaluated invalid connection parameter are indicated. These causes include “Receive error: Reception has been rejected by the receive mail server”.

Fifth Embodiment

The fifth embodiment of the method of registering the image forming apparatus for use in a network is a preferred embodiment when confirmation mail has not yet received by the receive mail storage 32, in the receive confirmation determining step (Step S420) in the aforementioned fourth embodiment.

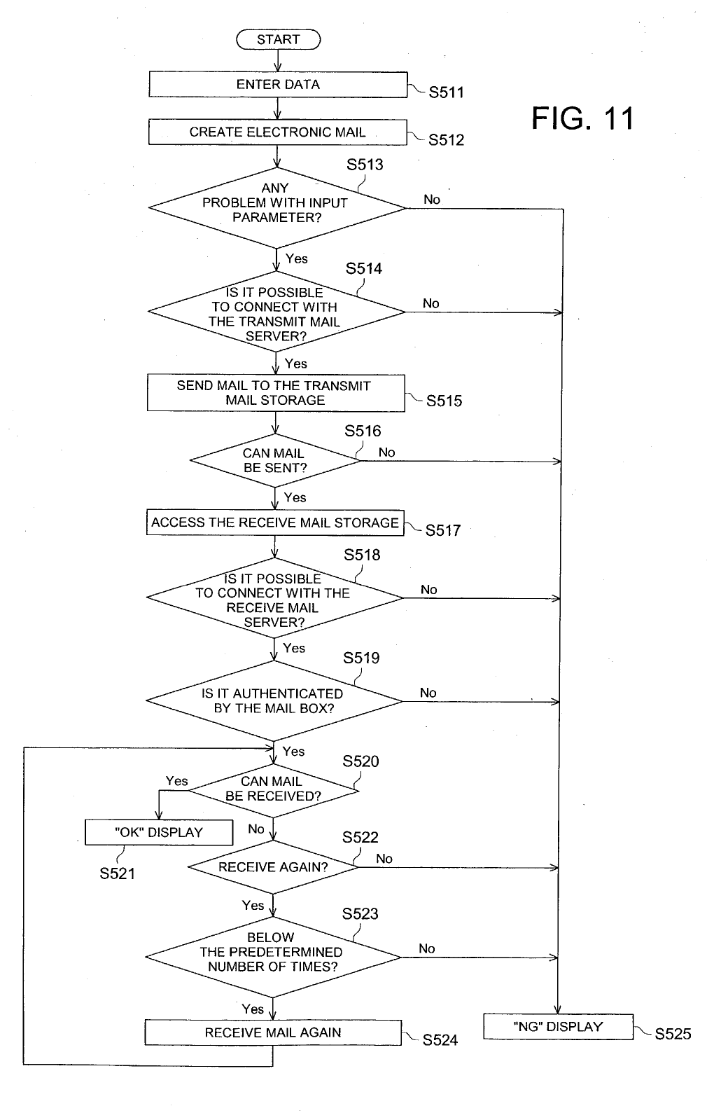

As shown in FIG. 11, the fifth embodiment of the present invention comprises: a re-receive confirmation determining step (Step S522) for determining whether or not reception should be performed again so that the aforementioned transceiver section accesses the receive mail storage again when it has been determined that the confirmation mail has not received by the receive mail storage 32; and a number-of-times determining step (Step S523) wherein evaluation is made to determine whether or not re-reception is made a predetermined number of times when it has been determined that re-reception should be performed in the aforementioned re-receive confirmation determining step, and the reception of confirmation mail has not been performed correctly when it has been determined that re-reception has already been done a predetermined number of times.

In Step S511 as shown in FIG. 11, the setting person is allowed to use the operating section 25 to enter the connection parameter, similarly to the case of the Step S110.

To put it more specifically, on the data input screen 300 given in FIG. 3, the setting person is allowed to enter the connection parameter similarly to the case of the Step S110 and to click the confirmation test start button 340. The system proceeds to the Step S512.

In Step S512, confirmation mail is created by the system proceeds to the Step S513.

In Step S513, the connection parameter entered in the data processing section (CPU) 22 is subjected to syntax check.

If the result of this check is YES, namely if there is no syntax error, the system proceeds to the Step S514. If the result of this check is NO, namely if there is any syntax error, the system proceeds to the Step S525.

In Step S514, evaluation is made to determine whether or not the transceiver section 21 can be connected to the transmit mail storage 31, according to the parameter for connection between the transceiver section 21 and transmit mail storage 31.

To put it more specifically, evaluation is made to determine whether or not the transceiver section 21 can be connected to the transmit mail storage 31, according to the IP address of the transmit mail server entered through the IP address input window 312 of the transmit mail server show in FIG. 3.

If the result of this check is YES, namely if the transceiver section 21 can be connected to the transmit mail storage 31, the system proceeds to the Step S515. If the result of this check is NO, namely if it cannot be connected, the system proceeds to the Step S525.

In Step S515, the transceiver section 21 sends confirmation mail to the transmit mail storage 31 and the system proceeds to the Step S516.

In Step S516, evaluation is made to determine whether or not the transmit mail storage 31 can send confirmation electronic mail. In other words, evaluation is made to determine whether or not confirmation mail is returned to the transceiver section 21 without being sent to the transmit mail storage 31, when confirmation mail is sent to the transmit mail storage 31 from the transceiver section 21. If the confirmation mail has been returned to the transceiver section 21, it is determined that confirmation mail cannot be sent, namely the parameter for this connection is invalid.

In Step S516, if the result of this check is YES, namely if confirmation mail has been sent, the system proceeds to the Step S517. If the result of this check is NO, namely if confirmation mail has been returned to the transceiver section 21, the system proceeds to the Step S525.

In Step S517, the transceiver section 21 is allowed to access the receive mail storage 32 by the data processing section (CPU) 22 according to the aforementioned connection, and the system proceeds to the Step S415.

In Step S518, evaluation is made to determine whether or not the transceiver section 21 can be connected to the receive mail storage 32, according to the parameter for connection between the transceiver section 21 and receive mail storage 32 entered in Step S511.

To put it more specifically, evaluation is made to determine whether or not there is the receive mail server corresponding to the IP address entered in the IP address input window 322 of the receive mail server shown in FIG. 3, namely whether or not the transceiver section 21 can be connected to the pre-assigned receive mail storage 32 according to the IP address.

If the result of this check is YES, namely if the transceiver section 21 can be connected to a predetermined receive mail storage, the system proceeds to the Step S519. If the result of this check is NO, namely if it cannot be connected, the system proceeds to the Step S525.

In Step S519, evaluation is made to determine whether or not the transceiver section 21 can be connected to the receive mail storage 32, according to the parameter for connection between the transceiver section 21 and receive mail storage 32 entered in Step S511.

To put it more specifically, evaluation is made to determine whether or not the transceiver section 21 has been authenticated by the receive mail storage 32, according to the mailbox name and password entered in the mail box name input window 324 and password input window 326 shown in FIG. 3.

If the result of this check is YES, namely if the transceiver section 21 has been authenticated by the receive mail storage 32, the system proceeds to the Step S520. If the result of this check is NO, namely if it is not authenticated, the system proceeds to the Step S522.

In Step S520, evaluation is made to determine whether or not the confirmation mail sent from the image forming apparatus 20 to its own equipment has been received by the receive mail storage 32.

If the result of this check is YES, namely if the aforementioned confirmation mail has been received by the receive mail storage 32, the system proceeds to the Step S521. If the result of this check is NO, namely if it has not been received, the system proceeds to the Step S522.

In Step S521, the confirmation screen 430 given in FIG. 4(c) is displayed on the display section 27. It is also possible to make arrangements so that confirmation mail can be received from the receive mail storage 32 at the discretion of the setting person or directly.

In Step S522, the transceiver section 21 is allowed to access the receive mail storage 32 again, and evaluation is made to determine whether or not confirmation mail should be received again.

If the result of this check is YES, namely if confirmation mail is to be received again, the system proceeds to the Step S523. If the result of this check is NO, namely if it is not received again, the system proceeds to the Step S525.

In Step S523, evaluation is made to determine whether or not the number of times confirmation mail is received is below the predetermined number of times. The aforementioned predetermined number of times is not subjected to any restriction. It refers to any preset number of times.

In Step S523, it is also preferred that evaluation be made to determine whether or not a predetermined time has elapsed during the time from reception of confirmation mail (Step S520) to re-reception. The aforementioned time is not subjected to any restriction. It refers to any preset number of times. In Step S523, it is also preferred that re-reception of confirmation mail be evaluated by combination of “a predetermined number of times” with “a predetermined time”.

If the result of this check in Step S523 is YES, namely if the number of times confirmation mail has been received is below the predetermined number of times, the system proceeds to the Step S524. confirmation mail is received again and the system returns to the Step S520.

If the result of this check is NO, namely if the number of times confirmation mail has been received is above the predetermined number of times, the system proceeds to the Step S525.

In Step S525, the confirmation screens 510 and 530 indicating “NG” as given in FIGS. 5(a) and (c) are displayed on the display section 27.

On the confirmation screen 510 displayed when the result of the check in Step S513 is NO, causes for the evaluated invalid connection parameter are indicated. These causes include “Input parameter error: Incorrect parameter. Check the parameter”, and “Input parameter error: No parameter entry. Enter the parameter”.

On the confirmation screen 510 displayed when the result of the check in Step S514 is NO, causes for the evaluated invalid connection parameter are indicated. These causes include “Connection error: Check the IP address of the transmit mail server”.

On the confirmation screen 510 to be displayed when the result of evaluation in Step S516 is “NO”, causes for evaluated invalid connection parameter are indicated. These causes include “Transmit error: Transmission has been rejected by the transmit mail server”.

On the confirmation screen 530 to be displayed when the result of evaluation in Step S518 is “NO”, causes for evaluated invalid connection parameter are indicated. These causes include “Connection error: Check the IP address of the receive mail server”.

On the confirmation screen 530 displayed when the result of evaluation in Step S519 is “NO”, causes for the evaluated invalid connection parameter are indicated. These causes include “Receive mailbox authentication error: Check the mailbox name.”, “Receive mailbox authentication error: Check the password” and “Receive mailbox authentication error: Check the mailbox name and password”.

On the confirmation screen 530 to be displayed when the result of evaluation in Step S522 is “NO”, causes for evaluated invalid connection parameter are indicated. These causes include “Receive error: Reception has been rejected by the receive mail server”.

On the confirmation screen 530 to be displayed when the result of evaluation in Step S523 is “NO”, causes for evaluated invalid connection parameter are indicated. These causes include “Receive error: Reception has been rejected by the receive mail server”.

Sixth Embodiment

The sixth embodiment of the method of registering the image forming apparatus for use in a network is a preferred embodiment when connection parameter has been determined to be invalid in the parameter determining step (Step S120) in the aforementioned first embodiment.

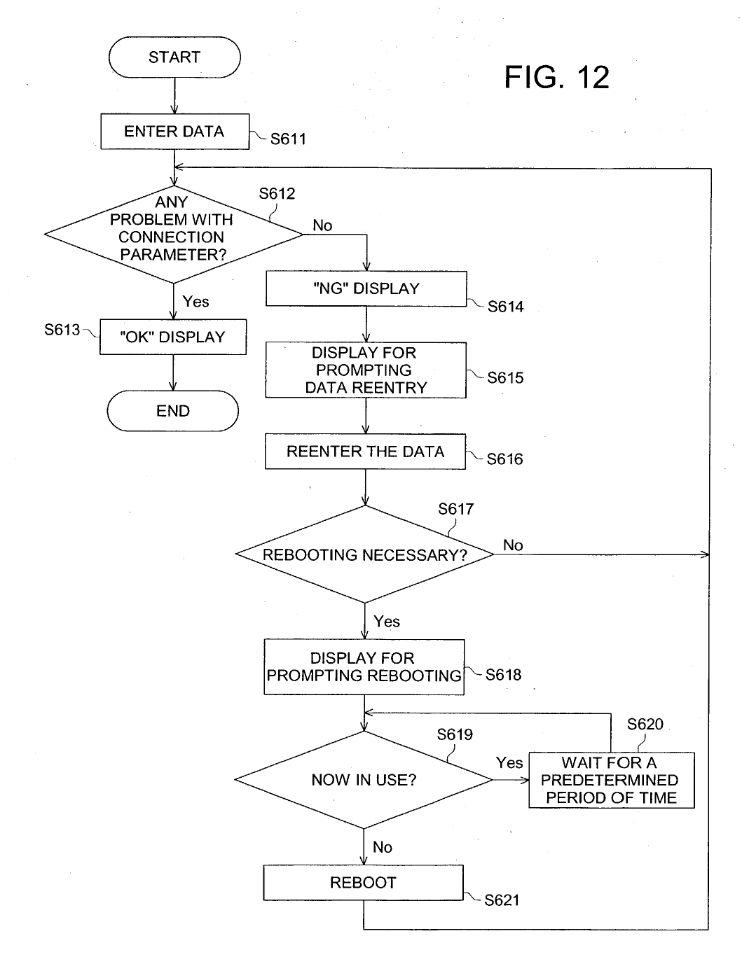

As shown in FIG. 12, the sixth embodiment of the present invention comprises: a reentry step (Step S616) for prompting reentry of a new connection parameter; a reboot confirmation step (Step S617) for determining whether or not there is any image forming apparatus that cannot be recognized by the electronic mail server, if the connection parameter entered in the reentry step does not reboot the image forming apparatus as its own equipment; and a reboot prompt display step (Step S618) for indicating that rebooting of the image forming apparatus is essential when the connection parameter having been entered in the reentry step is determined in the reboot confirmation step to be a connection parameter that requires rebooting of the image forming apparatus.

In Step S611 as shown in FIG. 12, the setting person is allowed to use the operating section 25 to enter the connection parameter, similarly to the case of the Step S110.

To put it more specifically, on the data input screen 300 given in FIG. 3, the setting person is allowed to enter the connection parameter similarly to the case of the Step S110 and to click the confirmation test start button 340. The system proceeds to the Step S612.

In Step S612, the connection status of the transceiver section 21 and transmit mail storage 31 and/or the connection status of the transceiver section 21 and receive mail storage 32 are monitored using the connection parameter set and entered in Step S610, thereby determining if the connection parameter set and entered in the aforementioned input Step S611 is valid or not.

If the result of this check is YES, namely if the connection parameter has been determined to be valid, the system goes to step (Step S613). If the result of this check is NO, namely if the connection parameter has been determined to be invalid, the system proceeds to the NG display step (Step S614).

In Step S613, the confirmation screens 410, 420 and 430 are displayed on the display section 27, where these screens are “OK” screens to show that the state of connection in FIGS. 4(a) to (c) is satisfactory (OK), similarly to the case of the Step S130. The registration of the image forming apparatus for use in the network is updated when the END button 412 displayed on these confirmation screens is clicked. Then the registration work terminates.

In Step S614, the confirmation screens 610, 620 and 630 are displayed on the display section 27, where these screens are “NG” screens to show that the state of connection in FIGS. 6(a) to (c) is not satisfactory (NG), similarly to the case of the Step S140. When the reentry button 614 is clicked on these confirmation screens, the system proceeds to the Step S615 that prompts reentry of the connection parameter.

In Step S615, a confirmation screen 710 for prompting the setting person to reenter the connection parameter given in FIG. 7 is displayed on the display section 27.

When it has been determined that reentry is necessary, the OK button 712 on the confirmation screen 710 is clicked by the setting person, and the system proceeds to the Step S616.

In Step S616, the data input screen 300 given in FIG. 3 is displayed on the display section 27 again and the setting person is allowed to reenter the connection parameter requiring updating, according to the cause for a parameter error shown in Step S614.

Upon termination of the reentry of the connection parameter by the setting person, the setting person is allowed to click the OK button (not illustrated) of the data input screen 300. When the OK button has been clicked, the system proceeds to the Step S617.

In Step S617, evaluation is made to determine whether or not the image forming apparatus 20 should be rebooted in order to ensure that the reentered connection parameter permits the image forming apparatus 20 to be recognized by the electronic mail server 30.

If the result of this check is NO, namely if it has been determined that rebooting is not required, the system proceeds to the Step S612 again and the reentered connection parameter is checked again.

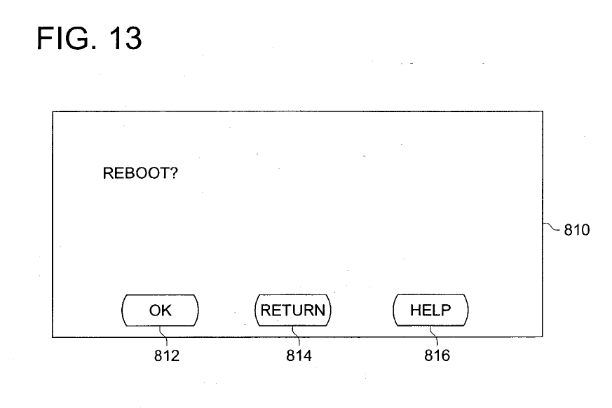

If the result of this check is YES, namely if it has been determined that rebooting is required, the system proceeds to the Step S618 and a confirmation screen 710 for prompting the setting person to reboot the image forming apparatus 20 given in FIG. 13 is displayed on the display section 27. At the same time, the setting person is allowed to determine whether or not the image forming apparatus 20 is to be rebooted.

An OK button 812, return button 814 and HELP button 816 are displayed on the confirmation screen 810.

It is also possible to arrange such a configuration that, when the setting person has determined that the image forming apparatus 20 is not rebooted, the setting person is allowed to click the return button 814 on the confirmation screen 810, and the confirmation screens 610, 620 and 630 given in FIGS. 6(a) to (c) are displayed again.

When the setting person has clicked the END button 512 on these confirmation screens 610, 620 and 630, the work of registering the image forming apparatus 20 for use in the network terminates without the image forming apparatus 20 being registered. If there is any unclear points or questions, the setting person clicks the HELP button 816. When the OK button 812 is clicked, the system proceeds to the Step S619.

In Step S619, evaluation is made to determine whether or not the image forming apparatus 20 is being used or not. To put it more specifically, evaluation is made to see if the main units of the aforementioned copy machine, fax machine, scanner and a combination thereof are currently operating or not. It is also preferred to check if use of these main units is reserved or not, in addition to checking for the current status of operation. If the result of this check is YES, namely if the image forming apparatus 20 is currently working, the system proceeds to the Step S620. If the result of this check is NO, namely if the image forming apparatus 20 is not working, the system proceeds to the Step S621.

The Step S620 is a step of waiting where the image forming apparatus 20 is not rebooted for a predetermined period of time. This waiting time can be set as desired.

After the lapse of the predetermined period of time, the system again returns to the Step S619.

In Step S619, the image forming apparatus 20 is rebooted and the reentered connection parameter is determined as valid. The system again returns to Step S612 after the image forming apparatus 20 has been rebooted, and the reentered connection parameter is checked.

Seventh Embodiment

The seventh embodiment of the method of registering the image forming apparatus for use in a network is a preferred embodiment when connection parameter entered in the aforementioned reentry step has been determined in the aforementioned reboot confirmation step (Step S617) to be a in connection parameter that requires the image forming apparatus to be rebooted.

As shown in FIG. 14, the seventh embodiment of the present invention is preferred to further include a reboot step (Step S718) for automatic rebooting of the image forming apparatus.

In FIG. 14, in Step S711 the setting person is allowed to use the operating section 25 to enter the connection parameter, similarly to the case of Step S110.

To put it more specifically, the setting person is allowed to enter the connection parameter on the data input screen 300 given in FIG. 3, similarly to the case of the Step S110, and to click the confirmation test start button 340. Then the system proceeds to the Step S712.

In Step S712, the connection status of the transceiver section 21 and transmit mail storage 31 and/or the connection status of the transceiver section 21 and receive mail storage 32 are monitored using the connection parameter set and entered in Step S711, thereby determining if the connection parameter set and entered in the aforementioned input Step S711 is valid or not.

If the result of this check is YES, namely if the connection parameter is determined to be valid, the system proceeds to the OK display step (Step S713). If the result of this check is NO, namely if it is determined to be invalid, the system proceeds to the NG displays step (Step S714).

In Step S713, the confirmation screens 410, 420 and 430 are displayed, where these screens are “OK” screens to show that the state of connection in FIGS. 4(a) to (c) is satisfactory (OK), similarly to the case of the Step S130. The registration of the image forming apparatus for use in the network is updated when the END button 412 displayed on these confirmation screens is clicked. Then the registration work terminates.

In Step S714, the confirmation screens 610, 620 and 630 are displayed on the display section 27, where these screens are “NG” screens to show that the state of connection in FIGS. 6(a) to (c) is not satisfactory (OK), similarly to the case of the Step S140.

When the reentry button 614 is clicked on these confirmation screens, the system proceeds to the Step S715 that prompts reentry of the connection parameter.

In Step S715, a confirmation screen 710 for prompting the setting person to reenter the connection parameter given in FIG. 7 is displayed on the display section 27.

When it has been determined that reentry is necessary, the OK button 712 on the confirmation screen 710 is clicked by the setting person, and the system proceeds to the Step S716.

In Step S716, the data input screen 300 given in FIG. 3 is displayed on the display section 27 again and the setting person is allowed to reenter the connection parameter requiring updating, according to the cause for a parameter error shown in Step S714.

Upon termination of the reentry of the connection parameter by the setting person, the setting person is allowed to click the OK button (not illustrated) of the data input screen 300. When the OK button has been clicked, the system proceeds to the Step S717.

In Step S717, evaluation is made to determine whether or not the image forming apparatus 20 should be rebooted in order to ensure that the reentered connection parameter permits the image forming apparatus 20 to be recognized by the electronic mail server 30.

If the result of this check is NO, namely if it has been determined that rebooting is not necessary, the system goes to Step S712 again, and the reentered connection parameter is again checked.

If the result of this check is YES, namely if it has been determined that rebooting of the image forming apparatus 20 is essential, then system proceeds to the Step S718.

In the Step S718, the image forming apparatus 20 is automatically rebooted and the reentered connection parameter is determined to be valid. After rebooting of the image forming apparatus 20, the system returns to the Step S721 and the reentered connection parameter is again checked.

To put it more specifically, in the seventh embodiment the operations in Step S712 include those in the following eighth to eleventh embodiments. They will be described below with reference to drawings.

Eighth Embodiment

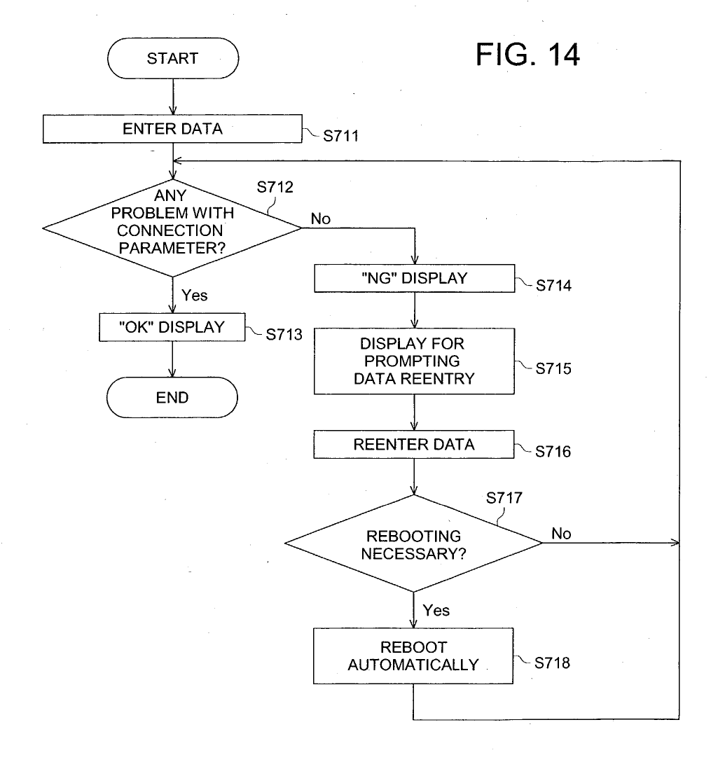

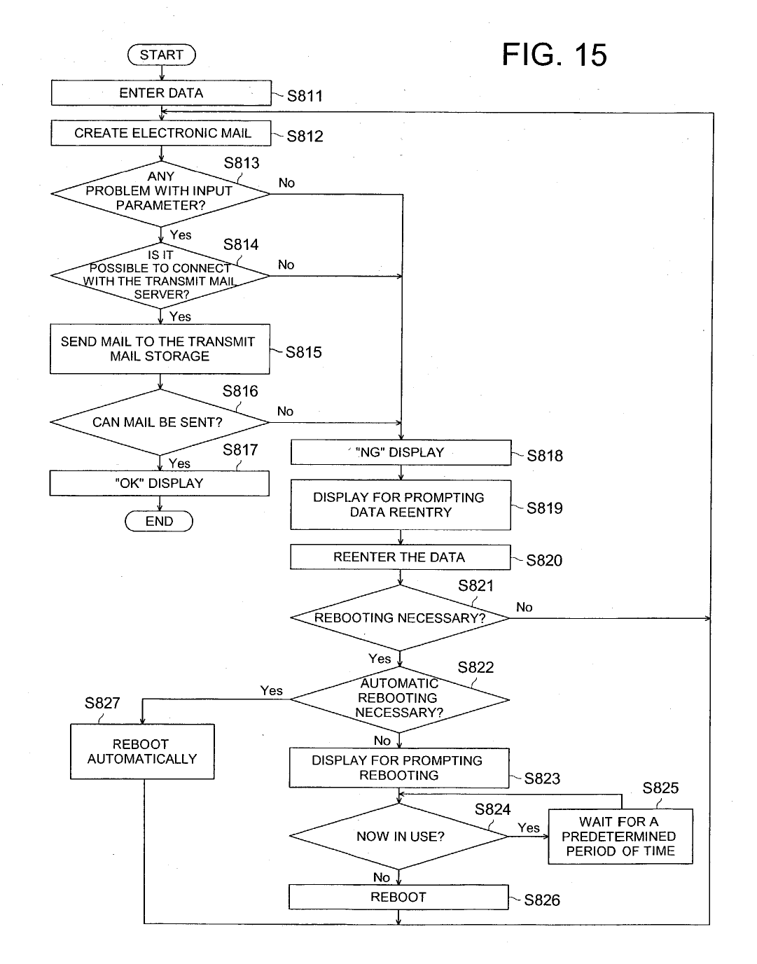

As shown in FIG. 15, the eighth embodiment of the present invention comprises: an input step (Step S811) for prompting setting and entry of a predetermined connection parameter for connection of the transceiver section 21 to the electronic mail server 30; an electronic mail creation step (Step S812) for creating confirmation mail according to the setting and entry in the input step and transmitting the confirmation mail to the transceiver section 21; transmit steps (Steps S813 to 815) for allowing the transceiver section 21 to transmit the confirmation mail using the parameter for connection between the transceiver section 21 and transmit mail storage 31, the parameter having been set and entered in the input stage; a reject confirmation determining step (Step S816) for determining whether or not the confirmation mail sent in the aforementioned transmit step is rejected by the transceiver section 21, and for determining that the confirmation screen is invalid if it has been confirmed that the confirmation mail has been rejected; display steps (Steps S817 and 818) for displaying the result of the aforementioned parameter check; a re-input step (Step S820) for prompting reentry of a new connection parameter in updating the connection parameter once set and input, when it has been determined that the connection parameter is invalid as a result of checking the parameter; a reboot confirmation step (Step S821) for determining whether or not the image forming apparatus can be recognized by the electronic mail server 30 only when the image forming apparatus as its own equipment is rebooted by the connection parameter entered in the re-input step; a reboot prompt display step (Step S823) for indicating that rebooting of the image forming apparatus 20 is necessary when it has been determined in the reboot confirmation step that the connection parameter entered in the re-input step is a connection parameter necessary to reboot the image forming apparatus 20; and a reboot step (Step S827) for automatically rebooting the image forming apparatus 20.

In Step S811 as shown in FIG. 15, the setting person is allowed to use the operating section 25 to enter the connection parameter, similarly to the case of Step S110.

To put it more specifically, in the data input screen 300 as given in FIG. 3, the setting person is allowed to enter the connection parameter similarly to the case of Step S110 and to click the confirmation test start button 340, and the system proceeds to the Step S812.

In Step S812, confirmation mail is created by the data processing section (CPU) 22 using the connection parameter entered in Step S811, and the system proceeds to the Step S813.

In Step S813, the entered connection parameter is checked by the data processing section (CPU) 22.

If the result of this check is YES, namely if the entered connection parameter has no syntax error, the system proceeds to the Step S814. If the result of this check is NO, namely if there is any problem, the system proceeds to the Step S818.

In Step S814, evaluation is made to determine whether or not the transceiver section 21 can be connected by the transmit mail storage 31 by the connection parameter.

To put it more specifically, evaluation is made to determine whether or not the transceiver section 21 can be connected to the transmit mail storage 31 by the IP address of the transmit mail server entered into the IP address input window 312 of the transmit mail server shown in FIG. 3.

If the result of this check is YES, namely if the transceiver section 21 can be connected to the transmit mail storage 31, the system proceeds to the Step S815. If the result of this check is NO, namely if it cannot be connected, the system proceeds to the Step S818.

In Step S815, the transceiver section 21 transmits confirmation mail to the transmit mail storage 31 and the system proceeds to the Step S816.

In Step S816, evaluation is made to determine whether or not if the transmit mail storage 31 can transmit confirmation mail to a predetermined party. In other words, when confirmation mail is sent from the transceiver section 21 to the transmit mail storage 31 evaluation is made to determine whether or not the confirmation mail is returned to the transceiver section 21 without being sent to the transmit mail storage 31. If the confirmation mail is returned to the transceiver section 21, it has been determined that it cannot be transmitted, namely it the parameter for the connection is not valid. The predetermined party refers to the image forming apparatus 20 or manager 50.

In Step S816, if the result of this check is YES, namely if the confirmation mail has been sent, the system proceeds to the Step S817. If the result of this check is NO, namely if the confirmation mail is returned to the transceiver section 21, the system proceeds to the Step S818.

In Step S817, the confirmation screen 410 for indicating “OK” as shown in FIG. 4(a) is indicated on the display section 27.

In Step S818, the confirmation screen 610 for indicating “NG” as shown in FIG. 6(a) is displayed on the display section 27.

On the confirmation screen 610 displayed when the result of this check in Step S813 is NO, causes for evaluated invalid connection parameter are indicated. These causes include “Input parameter error: Incorrect parameter. Check the parameter”, and “Input parameter error: No parameter entry. Enter the parameter”.

On the confirmation screen 610 displayed when the result of this check in Step S814 is NO, causes for evaluated invalid connection parameter are indicated. These causes include “Connection error: Check the IP address of the receive mail server”.

On the confirmation screen 610 displayed when the result of evaluation in Step S816 is “NO”, causes for the evaluated invalid connection parameter are indicated. These causes include “Transmit error: Transmission has been rejected by the transmit mail server”.

When the reentry button 614 has been clicked on the confirmation screen 610, the system proceeds to the Step S819 for prompting the reentry of a connection parameter.

In Step S819, the confirmation screen 710 for prompting the setting person to reenter the connection parameter is displayed on the display section 27.

When the setting person has determined to reenter the data, he/she is allowed to clock the OK button 712 of the confirmation screen 710 and the system proceeds to the Step S820.

In Step S820, the data input screen 300 shown in FIG. 3 is again displayed in the display section 27, and the setting person is allowed to reenter the connection parameter to be updated according to the cause for the connection parameter error shown in Step S818.

Upon termination of the reentry of the connection parameter by the setting person, the setting person is allowed to click the OK button (not illustrated) of the data input screen 300. When the OK button has been clicked, the system proceeds to the Step S821.

In Step S821, evaluation is made to determine whether or not the image forming apparatus 20 should be rebooted in order to ensure that the reentered connection parameter permits the image forming apparatus 20 to be recognized by the electronic mail server 30.

If the result of this check is NO, namely if it has been determined that rebooting is not necessary, the system again proceeds to the Step S812. Confirmation mail is created by the data processing section (CPU) 22 using the connection parameter entered again.

If the result of this check is YES, namely if it has been determined that rebooting is necessary, the system proceeds to the Step S822.

In Step S822 evaluation is made to determine whether or not rebooting of the image forming apparatus 20 should be performed automatically.

If the result of this check is YES, namely if it has been determined that rebooting of the image forming apparatus 20 should be performed automatically, the system proceeds to the Step S827.

In Step S827, the image forming apparatus 20 is automatically rebooted and the reentered connection parameter is determined to be valid. After the image forming apparatus 20 has been rebooted, the system returns to Step S812, and confirmation mail is created by the data processing section (CPU) 22 using the reentered connection parameter.

If the result of this check in Step S822 is NO, namely if it has been determined that automatic rebooting of the image forming apparatus 20 is not required, the system proceeds to the Step S823. The confirmation screen 810 for prompting the setting person to reboot the image forming apparatus 20 is displayed on the display section 27 and the setting person is allowed to determine if the image forming apparatus 20 should be rebooted or not.

When the setting person has determined not to reboot the image forming apparatus 20, it is also possible to arrange such a configuration that the setting person is allowed to click the Return bottom 814 on the confirmation screen 810 so that the confirmation screen 610 of the FIG. 6(a) is displayed on the display section 27 again.

Further, when the setting person has clicked the END button 512 on the confirmation screen 610, the work of registering the image forming apparatus 20 for use in the network terminates without the image forming apparatus 20 being registered. If the OK button 812 has been clicked, the system proceeds to the Step S824.

In Step S824, evaluation is made to determine whether or not the image forming apparatus 20 is being used or not. To put it more specifically, evaluation is made to see if the main units of the aforementioned copy machine, fax machine, scanner and a combination thereof are currently operating or not. It is also preferred to check if use of these main units is reserved or not, in addition to checking for the current status of operation. If the result of this check is YES, namely if the image forming apparatus 20 is currently working, the system proceeds to the Step S825. If the result of this check is NO, namely if the image forming apparatus 20 is not working, the system proceeds to the Step S826.

In Step S825, the image forming apparatus 20 is made to wait without being rebooted for a predetermined period of time. This waiting time can be set as desired.

After the lapse of the predetermined period of time, the system again returns to the Step S824.

In Step S826, the image forming apparatus 20 is rebooted and the reentered connection parameter is determined as valid. The system again returns to Step S812 after the image forming apparatus 20 has been rebooted, and confirmation mail is created by the data processing section (CPU) 22 using the reentered connection parameter.

Ninth Embodiment

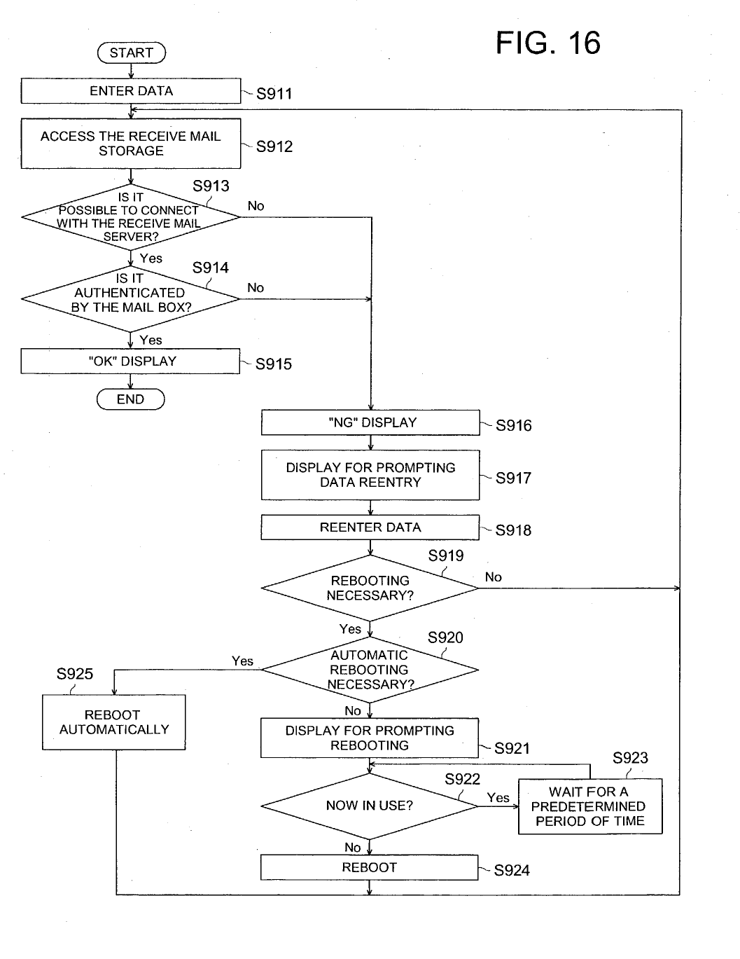

As shown in FIG. 16, the ninth embodiment of the method of registering the image forming apparatus for use in a network according to the present invention comprises: an input step (Step S911) for prompting a predetermined connection parameter to be set and entered to connect the transceiver section 21 to both the transmit mail storage 31 and receive mail storage 32 of the electronic mail server 30; an access step (Step S912) for allowing the transceiver section 21 to access the receive mail storage 32; access confirmation determining steps (Steps S913 and 914) for checking whether or not the access in the aforementioned access step has succeed, and for determining that the parameter for this connection is invalid if it is determined that access has failed; a display step (Step S917) for displaying the result of check in the aforementioned parameter determining step and for displaying on the operating section 25 a message prompting reentry of the connection parameter; a re-input step (Step S918) for prompting reentry of a new connection parameter in updating the connection parameter once set and input, when it has been determined that the connection parameter is invalid as a result of checking the parameter; a reboot confirmation step (Step S919) for determining whether or not the image forming apparatus 20 can be recognized by the electronic mail server 30 only when the image forming apparatus 20 as its own equipment is rebooted by the connection parameter entered in the re-input step; a reboot prompt display step (Step S921) for indicating that rebooting of the image forming apparatus 20 is necessary when it has been determined in the reboot confirmation step that the connection parameter entered in the re-input step is a connection parameter necessary to reboot the image forming apparatus 20; and a reboot step (Step S925) for automatically rebooting the image forming apparatus 20.

In Step S911 as shown in FIG. 16, the setting person is allowed to use the operating section 25 to enter the connection parameter, similarly to the case of Step S110.

To put it more specifically, on the data input screen 300 as given in FIG. 3, the setting person is allowed to enter the connection parameter similarly to the case of Step S110 and to click the confirmation test start button 340, and the system proceeds to the Step S912.

In Step S912, the transceiver section 21 is accessed the transmit mail storage 31 by the data processing section (CPU) 22 according to the connection parameter, and the system proceeds to Step S913.

In Step S913, evaluation is made to determine whether or not the transceiver section 21 can be connected to the receive mail storage 32, using the parameter for connection between the transceiver section 21 and receive mail storage 32.

To put it more specifically, evaluation is made to determine whether or not there is the receive mail server corresponding to the IP address entered in the IP address input window 322 of the receive mail server shown in FIG. 3, namely whether or not the transceiver section 21 can be connected to the pre-assigned receive mail storage 32 according to the IP address.

If the result of this check is YES, namely if the transceiver section 21 can be connected to a predetermined receive mail storage, the system proceeds to the Step S914. If the result of this check is NO, namely if it cannot be connected, the system proceeds to the Step S916.

In Step S914, evaluation is made to determine whether or not the transceiver section 21 is authenticated by the receive mail storage 32 according to the parameter for connection between the transceiver section 21 and receive mail storage 32.

To put it more specifically, evaluation is made to determine whether or not the transceiver section 21 has been authenticated by the receive mail storage 32, according to the mailbox name and password entered in the mail box name input window 324 and password input window 326 shown in FIG. 3.

If the result of this check is YES, namely if the transceiver section 21 has been authenticated by the receive mail storage 32, the system proceeds to the Step S915. If the result of this check is NO, namely if it is not authenticated, the system proceeds to the Step S916.

In Step S915, the confirmation screen 420 indicating “OK” in FIG. 4(b) is displayed on the display section 27.

In Step S916, the confirmation screen 620 indicating “NG” in FIG. 6(b) is displayed on the display section 27.

On the confirmation screen 620 to be displayed when the result of evaluation in Step S913 is “NO”, causes for evaluated invalid connection parameter are indicated. These causes include “Connection error: Check the IP address of the receive mail server”.

On the confirmation screen 620 to be displayed when the result of evaluation in Step S914 is “NO”, causes for evaluated invalid connection parameter are indicated. These causes include “Receive mailbox authentication error: Check the mailbox name.”, “Receive mailbox authentication error: Check the password” and “Receive mailbox authentication error: Check the mailbox name and password”.

When the reentry button 614 is clicked on the confirmation screen 620, the system proceeds to the Step S917 that prompts reentry of the connection parameter.

In Step S917, a confirmation screen 710 for prompting the setting person to reenter the connection parameter given in FIG. 7 is displayed on the display section 27.

When it has been determined that reentry is necessary, the OK button 712 on the confirmation screen 710 is clicked by the setting person, and the system proceeds to the Step S918.

In Step S918, the data input screen 300 given in FIG. 3 is displayed on the display section 27 again and the setting person is allowed to reenter the connection parameter requiring updating, according to the cause for the connection parameter error shown in Step S916.

Upon termination of the reentry of the connection parameter by the setting person, the setting person is allowed to click the OK button (not illustrated) of the data input screen 300. When the OK button has been clicked, the system proceeds to the Step S919.

In Step S919, evaluation is made to determine whether or not the image forming apparatus 20 should be rebooted in order to ensure that the reentered connection parameter permits the image forming apparatus 20 to be recognized by the electronic mail server 30.

If the result of this check is NO, namely if it has been determined that rebooting is not necessary, the system goes to Step S912 again, and the transceiver section 21 accesses the receive mail storage 32 according to the reentered connection parameter.

If the result of this check is YES, namely if it has been determined that rebooting is essential, then system proceeds to the Step S920.

In the Step S920, evaluation is made to determine whether or not the image forming apparatus 20 should be automatically rebooted.

If the result of this check is YES, namely if it has been determined that automatic rebooting of the image forming apparatus 20 is essential, then the system proceeds to the Step S925.

In the Step S925, the image forming apparatus 20 is automatically rebooted and the reentered connection parameter is determined to be valid. After rebooting of the image forming apparatus 20, the system returns to the Step S912, and the data processing section (CPU) 22 allows the transceiver section 21 to access the receive mail storage 32 according to the reentered connection parameter.

If the result of this check in Step S920 is NO, namely if it has been determined that automatic rebooting of the image forming apparatus 20 is not necessary, the system goes to Step S921, and a confirmation screen 810 for prompting the setting person to reboot the image forming apparatus 20 as given in FIG. 13 is displayed on the display section 27. At the same time, the setting person determines whether or not the image forming apparatus 20 is to be rebooted.

It is also possible to arrange such a configuration that, when the setting person has determined that the image forming apparatus 20 is not rebooted, the setting person is allowed to click the return button 814 on the confirmation screen 810, and the confirmation screen 610 given in FIG. 6(a) is displayed again.

When the setting person has clicked the END button 512 on the confirmation screen 610, the work of registering the image forming apparatus 20 for use in the network terminates without the image forming apparatus 20 being registered. When the OK button 812 is clicked, the system proceeds to the Step S922.

In Step S922, evaluation is made to determine whether or not the image forming apparatus 20 is being used or not. To put it more specifically, evaluation is made to see if the main units of the aforementioned copy machine, fax machine, scanner and a combination thereof are currently operating or not. It is also preferred to check if use of these main units is reserved or not, in addition to checking for the current status of operation.

If the result of this check is YES, namely if the image forming apparatus 20 is currently working, the system proceeds to the Step S923. If the result of this check is NO, namely if the image forming apparatus 20 is not working, the system proceeds to the Step S924.

The Step S923 is a step of waiting where the image forming apparatus 20 is not rebooted for a predetermined period of time. This waiting time can be set as desired.

After the lapse of the predetermined period of time, the system again returns to the Step S922.

In Step S924, the image forming apparatus 20 is rebooted and the reentered connection parameter is determined as valid.

The system again returns to Step S912 after the image forming apparatus 20 has been rebooted, and the reentered connection parameter is checked. The data processing section (CPU) 22 allows the transceiver section 21 to access the receive mail storage 32 according to the reentered connection parameter.

Tenth Embodiment

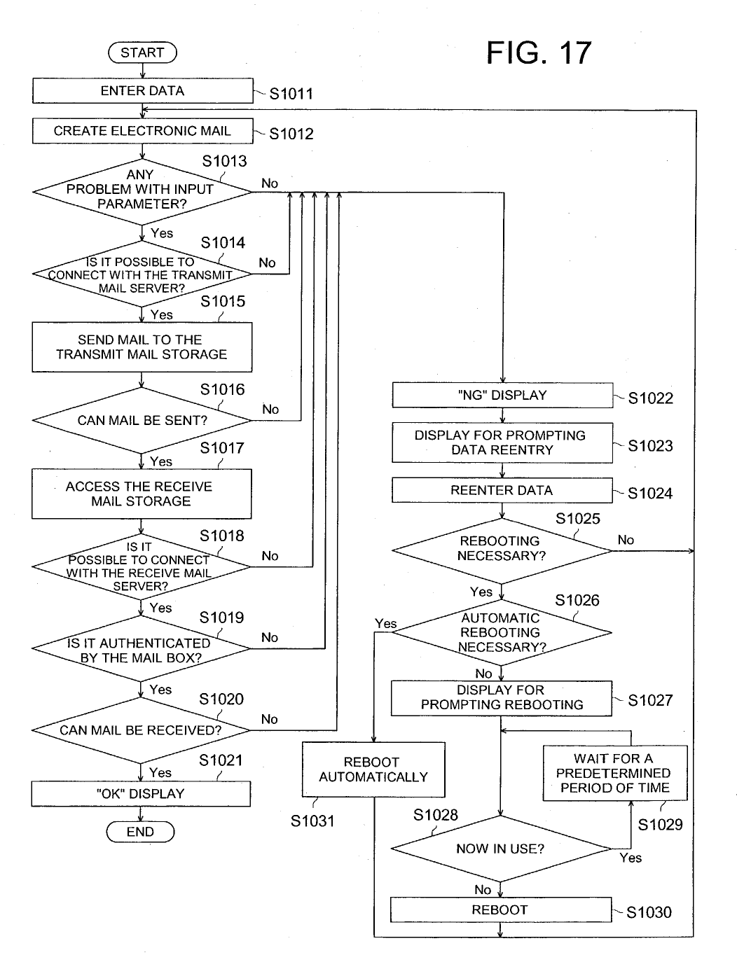

As shown in FIG. 17, the tenth embodiment of the method of registering the image forming apparatus for use in a network according to the present invention comprises: an input step (Step S1011) for prompting a predetermined connection parameter to be set and entered to connect the transceiver section 21 to both the transmit mail storage 31 and receive mail storage 32 of the electronic mail server 30; an electronic mail creation step (Step S1012) for creating the confirmation mail to be sent to the receive mail storage 32 specified by the connection parameter set and entered in the aforementioned input step, and for sending the confirmation mail to the transceiver section 21; transmit steps (Steps S1013 to 1015) for allowing the transceiver section to send the aforementioned confirmation electronic mail, using the parameter of connection between the aforementioned transceiver section and transmit mail storage, this parameter having been set and entered in the aforementioned input step; a reject confirmation determining step (Step S1016) for determining whether or not the confirmation mail sent in the aforementioned transmit step is rejected by the transceiver section, and for determining that the confirmation screen is invalid if it has been confirmed that the confirmation mail has been rejected; an access step (Step S1017) for allowing the transceiver section to access the receive mail storage, using the parameter for connection between the transceiver section and receive mail storage, this connection parameter having been set and entered in the input step; an access confirmation determining steps (Steps S1018 and 1019) for determining whether or not the access in the aforementioned access step has succeeded, and for determining that the parameter for the connection is invalid if it has been confirmed that the access failed; a receive confirmation determining step (step 1020) for determining whether or not confirmation mail has been received by the receive mail storage, and for determining that confirmation mail has not been sent and received correctly if confirmation of reception cannot be made; a display step (Step S1023) for displaying the result of check in the aforementioned parameter determining step and for displaying on the operating section 25 a message prompting reentry of the connection parameter when it has been determined that connection parameter is invalid; a re-input step (Step S1024) for prompting reentry of a new connection parameter in updating the connection parameter once set and entered, when it has been determined that the connection parameter is invalid as a result of checking the parameter; a reboot confirmation step (Step S1025) for determining whether or not the image forming apparatus 20 can be recognized by the electronic mail server 30 only when the image forming apparatus 20 as its own equipment is rebooted by the connection parameter entered in the re-input step; a reboot prompt display step (Step S1027) for indicating that rebooting of the image forming apparatus 20 is necessary when it has been determined in the reboot confirmation step that the connection parameter entered in the re-input step is a connection parameter necessary to reboot the image forming apparatus 20; and a reboot step (Step S1031) for automatically rebooting the image forming apparatus 20.

In Step S1011 as shown in FIG. 17, the setting person is allowed to use the operating section 25 to enter the connection parameter, similarly to the case of Step S110.

To put it more specifically, on the data input screen 300 as given in FIG. 3, the setting person is allowed to enter the connection parameter similarly to the case of Step S110 and to click the confirmation test start button 340, and the system proceeds to the Step S1012.

In Step S1012, confirmation mail is created by the data processing section (CPU) 22 according to the connection parameter entered in Step S1011, and the system proceeds to Step S1013.

In Step S1013, the connection parameter entered in the data processing section (CPU) 22 is subjected to syntax check.

If the result of the above check is YES, namely, if the entered connection parameter has no syntax error, then the system proceeds to Step S1014. If the result of the check is NO, namely, if the connection parameter has a syntax error, then the system proceeds to Step S1022.

In Step S1014, evaluation is made to determine whether or not the transceiver section 21 can be connected to the transmit mail storage 31, using the parameter for the connection between the transceiver section 21 and transmit mail storage 31.

To put it more specifically, the IP address of the transmit mail server entered in the IP address input window 312 of the transmit mail server shown in FIG. 3 is used to check whether or not the transceiver section 21 can be connected to the transmit mail storage 31.

If the result of the above check is YES, namely, if the transceiver section 21 can be connected with the transmit mail storage 31, then system proceeds to Step S1015. If the result of the above check is NO, namely, if the transceiver section 21 cannot be connected with the transmit mail storage 31, then system proceeds to Step S1022.

In the Step S1015, the transceiver section 21 transmits confirmation mail to the transmit mail storage 31 and the system goes to Step S1016.

In the Step S1016, evaluation is made to determine if the transmit mail storage 31 can send confirmation mail or not. In other words, evaluation is made to determine whether or not confirmation mail is returned to the transceiver section 21 without being sent to the transmit mail storage 31 when the confirmation mail is sent from the transceiver section 21 to the transmit mail storage 31. If the confirmation mail has been returned to the transceiver section 21, it is determined that transmission has failed or the parameter for this connection is invalid.

In Step S1016, if the result of evaluation is YES, namely if the confirmation mail has been sent, then the system goes to Step S1017. If it is NO, namely if the confirmation mail has been returned to the transceiver section 21, then the system goes to Step S1022.

In the Step S1017, the transceiver section 21 is allowed to access the receive mail storage 32 by the data processing section (CPU) 22 according to the aforementioned connection parameter, and the system proceeds to the Step S1018.

In Step S1018, evaluation is made to determine if the transceiver section 21 can be connected to the receive mail storage 32, according to the parameter for connection between the transceiver section 21 and receive mail storage 32, wherein this parameter is entered in Step S1011.

To put it more specifically, evaluation is made to determine whether or not there is any receive mail server corresponding to the IP address entered into the IP address input window 322 of the receive mail server, namely, whether or not the transceiver section 21 can be connected to the receive mail storage 32 assigned in advance, based on the IP address.

When the result of evaluation is YES, namely when it can be connected to a predetermined receive storage, the system proceeds to Step S1019. If the result of evaluation is NO, namely if it cannot be connected, the system goes to Step S1022.

In Step S1019, evaluation is made to determine if the transceiver section 21 is authenticated or not by the receive mail storage 32, according to the parameter for connection between the transceiver section 21 and receive mail storage 32, wherein this parameter is entered in Step S1011.

To put it more specifically, evaluation is made to determine whether or not the transceiver section 21 is authenticated by the receive mail storage 32 according to the mailbox name and password entered into the mailbox name input window 324 and password input window 326 shown in FIG. 3.

When the result of evaluation is YES, namely when the transceiver section 21 has been authenticated by the receive mail storage 32, the system goes to Step S1020. If the result of evaluation is NO, namely if it is not authenticated, the system goes to Step S1022.

In Step S1020, evaluation is made to determine whether or not the confirmation mail sent from the image forming apparatus 20 to its own equipment has been received by the receive mail storage 32.

If the result of this check is YES, namely if the aforementioned confirmation mail has been received by the receive mail storage 32, the system proceeds to the Step S1021. If the result of this check is NO, namely if it has not been received, the system proceeds to the Step S1022.

In step 1021, the confirmation screen 430 indicating “OK” as given in FIG. 4(c) is displayed on the display section 27. It is also possible to make arrangements so that the image forming apparatus 20 can receive confirmation mail from the receive mail storage 32 at the discretion of the setting person or automatically.

In Step S1022, the confirmation screens 610 and 630 indicating “NG” as given in FIGS. 6(a) and (c) are displayed on the display section 27.

On the confirmation screen 610 displayed when the result of the check in Step S1013 is NO, causes for the evaluated invalid connection parameter are indicated. These causes include “Input parameter error: Incorrect parameter. Check the parameter”, and “Input parameter error: No parameter entry. Enter the parameter”.

On the confirmation screen 610 displayed when the result of the check in Step S1014 is NO, causes for the evaluated invalid connection parameter are indicated. These causes include “Connection error: Check the IP address of the transmit mail server”.

On the confirmation screen 610 to be displayed when the result of evaluation in Step S1016 is “NO”, causes for evaluated invalid connection parameter are indicated. These causes include “Transmit error: Transmission has been rejected by the transmit mail server”.

On the confirmation screen 630 to be displayed when the result of evaluation in Step S1018 is “NO”, causes for evaluated invalid connection parameter are indicated. These causes include “Connection error: Check the IP address of the receive mail server”.

On the confirmation screen 630 displayed when the result of evaluation in Step S1019 is “NO”, causes for the evaluated invalid connection parameter are indicated. These causes include “Receive mailbox authentication error: Check the mailbox name.”, “Receive mailbox authentication error: Check the password” and “Receive mailbox authentication error: Check the mailbox name and password”.

On the confirmation screen 630 to be displayed when the result of evaluation in Step S1020 is “NO”, causes for evaluated invalid connection parameter are indicated. These causes include “Receive error: Reception has been rejected by the receive mail server”.

When the Reentry button 614 has been clicked on the aforementioned confirmation screens 610 and 630, the system proceeds to the Step S1023 for prompting reentry of the connection parameter.

In Step S1023, a confirmation screen 710 for prompting the setting person to reenter the connection parameter given in FIG. 7 is displayed on the display section 27.

When it has been determined that reentry is necessary, the OK button 712 on the confirmation screen 710 is clicked by the setting person, and the system proceeds to the Step S1024.

In Step S1024, the data input screen 300 given in FIG. 3 is displayed on the display section 27 again and the setting person is allowed to reenter the connection parameter requiring updating, according to the cause for a connection parameter error shown in Step S1011.

Upon termination of the reentry of the connection parameter by the setting person, the setting person is allowed to click the OK button (not illustrated) of the data input screen 300. When the OK button has been clicked, the system proceeds to the Step S1025.

In Step S1025, evaluation is made to determine whether or not the image forming apparatus 20 should be rebooted in order to ensure that the reentered connection parameter permits the image forming apparatus 20 to be recognized by the electronic mail server 30.

If the result of this check is NO, namely if it has been determined that rebooting is not necessary, the system goes to Step S1012 again, and confirmation mail is created by the data processing section (CPU) 22 using the reentered connection parameter.

In Step S1026, evaluation is made to determine whether or not the image forming apparatus 20 should be automatically rebooted.

If the result of this check is YES, namely if it has been determined that automatic rebooting of the image forming apparatus 20 is essential, then the system proceeds to the Step S1031.

In the Step S1031, the image forming apparatus 20 is automatically rebooted and the reentered connection parameter is determined to be valid. After rebooting of the image forming apparatus 20, the system returns to the Step S1012, and confirmation mail is created by the data processing section (CPU) 22 using the reentered connection parameter.

If the result of this check in Step S1026 is NO, namely if it has been determined that automatic rebooting of the image forming apparatus 20 is not necessary, the system goes to Step S1027, and a confirmation screen 810 for prompting the setting person to reboot the image forming apparatus 20 as given in FIG. 13 is displayed on the display section 27. At the same time, the setting person determines whether or not the image forming apparatus 20 is to be rebooted.

It is also possible to arrange such a configuration that, when the setting person has determined that the image forming apparatus 20 is not rebooted, the setting person is allowed to click the return button 814 on the confirmation screen 810, and the confirmation screens 610 and 630 given in FIGS. 6(a) and (c) are displayed again.

When the setting person has clicked the END button 512 on these confirmation screens 610 and 630, the work of registering the image forming apparatus 20 for use in the network terminates without the image forming apparatus 20 being registered. When the OK button 812 is clicked, the system proceeds to the Step S1028.

In Step S1028, evaluation is made to determine whether or not the image forming apparatus 20 is being used or not. To put it more specifically, evaluation is made to see if the main units of the aforementioned copy machine, fax machine, scanner and a combination thereof are currently operating or not. It is also preferred to check if use of these main units is reserved or not, in addition to checking for the current status of operation.

If the result of this check is YES, namely if the image forming apparatus 20 is currently working, the system proceeds to the Step S1029. If the result of this check is NO, namely if the image forming apparatus 20 is not working, the system proceeds to the Step S1030.

The Step S1029 is a step of waiting where the image forming apparatus 20 is not rebooted for a predetermined period of time. This waiting time can be set as desired.

After the lapse of the predetermined period of time, the system again returns to the Step S1028.

In Step S1030, the image forming apparatus 20 is rebooted and the reentered connection parameter is determined as valid.

The system again returns to Step S1012 after the image forming apparatus 20 has been rebooted, and confirmation mail is created by the data processing section (CPU) 22 using the reentered connection parameter.

Eleventh Embodiment

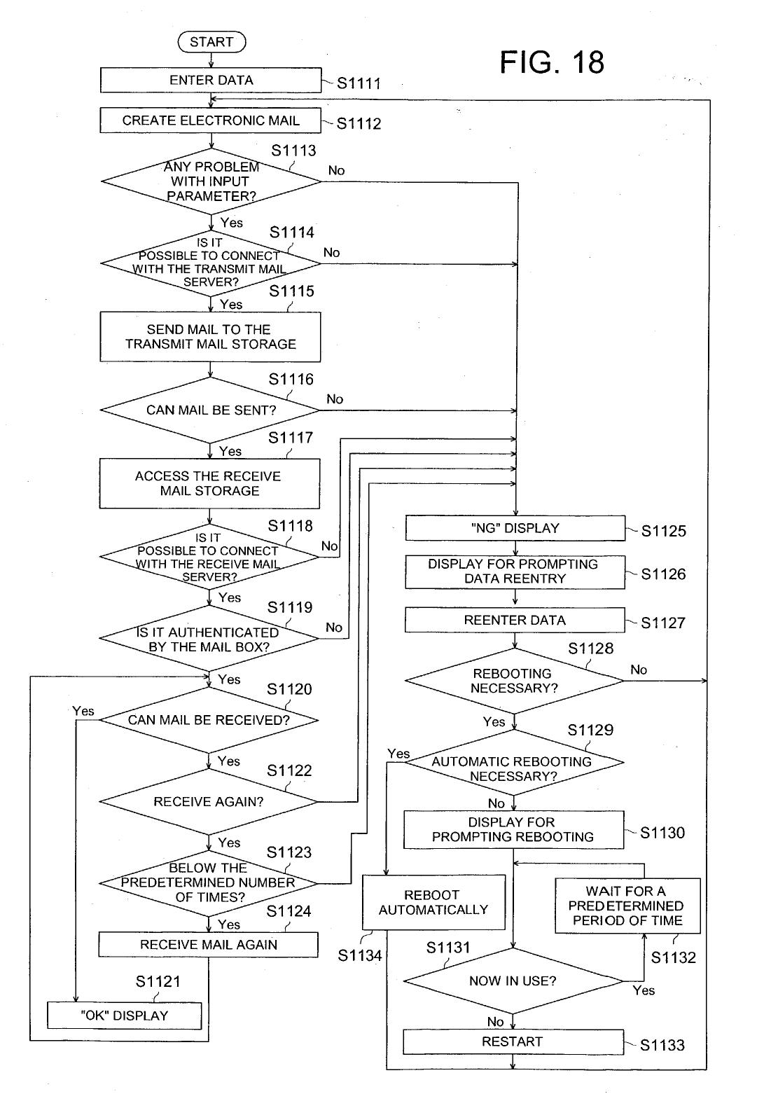

As shown in FIG. 18, the eleventh embodiment of the method of registering the image forming apparatus for use in a network according to the present invention comprises: an input step (Step S1111) for prompting a predetermined connection parameter to be set and entered to connect the transceiver section 21 to both the transmit mail storage 31 and receive mail storage 32 of the electronic mail server 30; an electronic mail creation step (Step S1112) for creating according to the setting and entry in the input step (Step S1111) the confirmation mail to be sent to the receive mail storage 32 specified by the connection parameter set and entered in the aforementioned input step, and for sending the confirmation mail to the transceiver section 21; transmit steps (Steps S1113 to 1115) for allowing the transceiver section to send the aforementioned confirmation electronic mail, using the parameter of connection between the aforementioned transceiver section and transmit mail storage, this parameter having been set and entered in the aforementioned input step; a reject confirmation determining step (Step S1111) for determining whether or not the confirmation mail sent in the aforementioned transmit step is rejected by the transceiver section, and for determining that the confirmation screen is invalid if it has been confirmed that the confirmation mail has been rejected; an access step (Step S1117) for allowing the transceiver section to access the receive mail storage, using the parameter for connection between the transceiver section and receive mail storage, this connection parameter having been set and entered in the input step; an access confirmation determining steps (Steps S1118 and 1119) for determining whether or not the access in the aforementioned access step has succeeded, and for determining that the parameter for the connection is invalid if it has been confirmed that the access failed; an access confirmation determining steps (Steps S1118 and 1119) for determining whether or not the access in the aforementioned access step has succeeded, and for determining that the parameter for the connection is invalid if it has been confirmed that the access failed; a receive confirmation determining step (Step S1120) for determining whether or not confirmation mail has been received by the receive mail storage, and for determining that confirmation mail has not been sent and received correctly if confirmation of reception cannot be made; a re-receive confirmation determining step (Step S1122) for determining whether or not reception should be performed again so that the aforementioned transceiver section accesses the receive mail storage again, when it has been determined in the aforementioned receive confirmation determining step that the confirmation mail is not received by the receive mail storage 32; a number-of-times determining step (Step S1123) wherein evaluation is made to determine whether or not re-reception has been done a predetermined number of times when it has been determined that re-reception should be performed in the aforementioned re-receive confirmation determining step, and the reception of confirmation mail has not been performed correctly when it has been determined that re-reception has already been done a predetermined number of times; a display step (Step S1126) for displaying the result of check in the aforementioned parameter determining step and for displaying on the operating section 25 a message prompting reentry of the connection parameter when it has been determined that connection parameter is invalid; a re-input step (Step S1127) for prompting reentry of a new connection parameter in updating the connection parameter once set and entered, when it has been determined that the connection parameter is invalid as a result of checking the parameter; a reboot confirmation step (Step S1128) for determining whether or not the image forming apparatus 20 can be recognized by the electronic mail server 30 only when the image forming apparatus 20 as its own equipment is rebooted by the connection parameter entered in the re-input step; a reboot prompt display step (Step S1130) for indicating that rebooting of the image forming apparatus 20 is necessary when it has been determined in the reboot confirmation step that the connection parameter entered in the re-input step is a connection parameter necessary to reboot the image forming apparatus 20; and a reboot step (Step S1133) for automatically rebooting the image forming apparatus 20.

In Step S1111 as shown in FIG. 18, the setting person is allowed to use the operating section 25 to enter the connection parameter, similarly to the case of Step S110.

To put it more specifically, on the data input screen 300 as given in FIG. 3, the setting person is allowed to enter the connection parameter similarly to the case of Step S110 and to click the confirmation test start button 340, and the system proceeds to the Step S1112.

In Step S1112, confirmation mail is created by the data processing section (CPU) 22 according to the connection parameter entered in Step S1111, and the system proceeds to Step S1113.

In Step S1113, the connection parameter entered in the data processing section (CPU) 22 is subjected to syntax check.

If the result of the above check is YES, namely, if the entered connection parameter has no syntax error, then the system proceeds to Step S1114. If the result of the check is NO, namely, if the connection parameter has a syntax error, then the system proceeds to Step S1125.

In Step S1114, evaluation is made to determine whether or not the transceiver section 21 can be connected to the transmit mail storage 31, using the parameter for the connection between the transceiver section 21 and transmit mail storage 31.

To put it more specifically, the IP address of the transmit mail server entered in the IP address input window 312 of the transmit mail server shown in FIG. 3 is used to check whether or not the transceiver section 21 can be connected to the transmit mail storage 31.

If the result of the above check is YES, namely, if the transceiver section 21 can be connected with the transmit mail storage 31, then system proceeds to Step S1115. If the result of the above check is NO, namely, if the transceiver section 21 cannot be connected with the transmit mail storage 31, then system proceeds to Step S1125.

In Step S1115, the transceiver section 21 sends confirmation mail to the transmit mail storage 31 and the system proceeds to the Step S1116.

In Step S1116, evaluation is made to determine whether or not the transmit mail storage 31 can send the confirmation mail. Namely evaluation is made to determine whether or not confirmation mail has been returned to the transceiver section 21 without being sent to the transmit mail storage 31 when sent from the transceiver section 21 to the transmit mail storage 31. If confirmation mail has been returned to the transceiver section 21, it is determined that confirmation mail cannot be sent, namely the parameter for this connection is invalid.

In Step S1116, if the result of the above check is YES, namely if confirmation mail has been sent, the system proceeds to the Step S1117. If the result of the check is NO, namely, if the confirmation mail has been returned to the transceiver section 21, the system proceeds to the Step S1125.

In Step S1117, the transceiver section 21 is allowed to access the receive mail storage 32 by the data processing section (CPU) 22 using the connection parameter. Then the system proceeds to the Step S1118.

In Step S1118, evaluation is made to determine whether or not the transceiver section 21 can be connected to the receive mail storage 32 by the parameter for connection between the transceiver section 21 and receive mail storage 32 entered in the Step S1111.

To put it more specifically, evaluation is made to determine whether or not there is the receive mail server corresponding to the IP address entered in the IP address input window 322 of the receive mail server shown in FIG. 3, namely whether or not the transceiver section 21 can be connected to the pre-assigned receive mail storage 32 according to the IP address.

If the result of this check is YES, namely if the transceiver section 21 can be connected to a predetermined receive mail storage, the system proceeds to the Step S1119. If the result of this check is NO, namely if it cannot be connected, the system proceeds to the Step S1125.

In Step S1119, evaluation is made to determine whether or not the transceiver section 21 can be connected to the receive mail storage 32, according to the parameter for connection between the transceiver section 21 and receive mail storage 32 entered in Step S1111.

To put it more specifically, evaluation is made to determine whether or not the transceiver section 21 is authenticated by the receive mail storage 32 according to the mailbox name and password entered into the mailbox name input window 324 and password input window 326 shown in FIG. 3.

When the result of evaluation is YES, namely when the transceiver section 21 has been authenticated by the receive mail storage 32, the system goes to Step S1120. If the result of evaluation is NO, namely if it is not authenticated, the system goes to Step S1125.

In Step S1120, evaluation is made to determine whether or not the confirmation mail sent from the image forming apparatus 20 to its own equipment has been received by the receive mail storage 32.

If the result of this check is YES, namely if the aforementioned confirmation mail has been received by the receive mail storage 32, the system proceeds to the Step S1121. If the result of this check is NO, namely if it has not been received, the system proceeds to the Step S1122.

In Step S1121, the confirmation screen 430 given in FIG. 4(c) is displayed on the display section 27. It is also possible to make arrangements so that the image forming apparatus 20 can receive confirmation mail from the receive mail storage 32 at the discretion of the setting person or automatically.

In Step S1122, the transceiver section 21 is allowed to access the receive mail storage 32 again, and evaluation is made to determine whether or not confirmation mail can be received again.

If the result of this check is YES, namely if confirmation mail can be received again, the system proceeds to the Step S1123. If it is NO, namely if confirmation mail cannot be received again, the system proceeds to the Step S1125.

In Step S1123, evaluation is made to determine whether or not the number of times confirmation mail has been received is below the predetermined number of times. The aforementioned predetermined number of times is not subjected to any restriction. It refers to any preset number of times.

In Step S1123, it is also preferred that evaluation be made to determine whether or not a predetermined time has elapsed during the time from reception of confirmation mail (Step S1120) to re-reception. The aforementioned time is not subjected to any restriction. It refers to any preset number of times. In Step S1123, it is also preferred that re-reception of confirmation mail be evaluated by combination of “a predetermined number of times” with “a predetermined time”.

If the result of this check in Step S1123 is YES, namely if the number of times confirmation mail is received is below the predetermined number of times, the system proceeds to the Step S1124. confirmation mail is received again and the system returns to the Step S1120.

If the result of this check is NO, namely if the number of times confirmation mail has been received is above the predetermined number of times, the system proceeds to the Step S1125.

In Step S1125, the confirmation screens 610 and 630 indicating “NG” as given in FIGS. 6(a) and (c) are displayed on the display section 27.

On the confirmation screen 610 displayed when the result of the check in Step S1113 is NO, causes for the evaluated invalid connection parameter are indicated. These causes include “Input parameter error: Incorrect parameter. Check the parameter”, and “Input parameter error: No parameter entry. Enter the parameter”.

On the confirmation screen 610 displayed when the result of the check in Step S1114 is NO, causes for the evaluated invalid connection parameter are indicated. These causes include “Connection error: Check the IP address of the transmit mail server”.

On the confirmation screen 610 to be displayed when the result of evaluation in Step S1116 is “NO”, causes for evaluated invalid connection parameter are indicated. These causes include “Transmit error: Transmission has been rejected by the transmit mail server”.

On the confirmation screen 630 to be displayed when the result of evaluation in Step S1118 is “NO”, causes for evaluated invalid connection parameter are indicated. These causes include “Connection error: Check the IP address of the receive mail server”.

On the confirmation screen 630 displayed when the result of evaluation in Step S1119 is “NO”, causes for the evaluated invalid connection parameter are indicated. These causes include “Receive mailbox authentication error: Check the mailbox name.”, “Receive mailbox authentication error: Check the password” and “Receive mailbox authentication error: Check the mailbox name and password”.

On the confirmation screen 630 to be displayed when the result of evaluation in Step S1122 is “NO”, causes for evaluated invalid connection parameter are indicated. These causes include “Receive error: Reception has been rejected by the receive mail server”.

On the confirmation screen 630 to be displayed when the result of evaluation in Step S1123 is “NO”, causes for evaluated invalid connection parameter are indicated. These causes include “Receive error: Reception has been rejected by the receive mail server”.

When the Reentry button 614 has been clicked on the aforementioned confirmation screens 610 and 630, the system proceeds to the Step S1126 for prompting reentry of the connection parameter.

In Step S1126, a confirmation screen 710 for prompting the setting person to reenter the connection parameter given in FIG. 7 is displayed on the display section 27.

When it has been determined that reentry is necessary, the OK button 712 on the confirmation screen 710 is clicked by the setting person, and the system proceeds to the Step S1127.

In Step S1127, the data input screen 300 given in FIG. 3 is displayed on the display section 27 again and the setting person is allowed to reenter the connection parameter requiring updating, according to the cause for a connection parameter error shown in Step S1011.

Upon termination of the reentry of the connection parameter by the setting person, the setting person is allowed to click the OK button (not illustrated) of the data input screen 300. When the OK button has been clicked, the system proceeds to the Step S1128.

In Step S1128, evaluation is made to determine whether or not the image forming apparatus 20 should be rebooted in order to ensure that the reentered connection parameter permits the image forming apparatus 20 to be recognized by the electronic mail server 30.

If the result of this check is NO, namely if it has been determined that rebooting is not necessary, the system goes to Step S1112 again, and confirmation mail is created by the data processing section (CPU) 22 using the reentered connection parameter.

If the result of this check is YES, namely if it has been determined that rebooting of the image forming apparatus 20 is essential, then the system proceeds to the Step S1129.

In the Step S1129, evaluation is made to determine whether or not the image forming apparatus 20 should be automatically rebooted.

If the result of this check is YES, namely if it has been determined that automatic rebooting of the image forming apparatus 20 is essential, then the system proceeds to the Step S1134.

In the Step S1134, the image forming apparatus 20 is automatically rebooted and the reentered connection parameter is determined to be valid. After rebooting of the image forming apparatus 20, the system returns to the Step S1112, and confirmation mail is created by the data processing section (CPU) 22 using the reentered connection parameter.

If the result of this check in Step S1129 is NO, namely if it has been determined that automatic rebooting of the image forming apparatus 20 is not necessary, the system goes to Step S1130, and a confirmation screen 810 for prompting the setting person to reboot the image forming apparatus 20 as given in FIG. 13 is displayed on the display section 27. At the same time, the setting person determines whether or not the image forming apparatus 20 is to be rebooted.

It is also possible to arrange such a configuration that, when the setting person has determined that the image forming apparatus 20 is not rebooted, the setting person is allowed to click the return button 814 on the confirmation screen 810, and the confirmation screens 610 and 630 given in FIGS. 6(a) and (c) are displayed again.

When the setting person has clicked the END button 512 on these confirmation screens 610 and 630, the work of registering the image forming apparatus 20 for use in the network terminates without the image forming apparatus 20 being registered. When the OK button 812 is clicked, the system proceeds to the Step S1131.

In Step S1131, evaluation is made to determine whether or not the image forming apparatus 20 is being used or not. To put it more specifically, evaluation is made to see if the main units of the aforementioned copy machine, fax machine, scanner and a combination thereof are currently operating or not. It is also preferred to check if use of these main units is reserved or not, in addition to checking for the current status of operation.

If the result of this check is YES, namely if the image forming apparatus 20 is currently working, the system proceeds to the Step S1132. If the result of this check is NO, namely if the image forming apparatus 20 is not working, the system proceeds to the Step S1133.

The Step S1132 is a step of waiting where the image forming apparatus 20 is not rebooted for a predetermined period of time. This waiting time can be set as desired.

After the lapse of the predetermined period of time, the system again returns to the Step S1028.

In Step S1133, the image forming apparatus 20 is rebooted and the reentered connection parameter is determined as valid. The system again returns to Step S1112 after the image forming apparatus 20 has been rebooted, and confirmation mail is created by the data processing section (CPU) 22 using the reentered connection parameter.

Twelfth Embodiment

Referring to drawings, the following describes the twelfth embodiment of a network image forming apparatus according to the present invention.

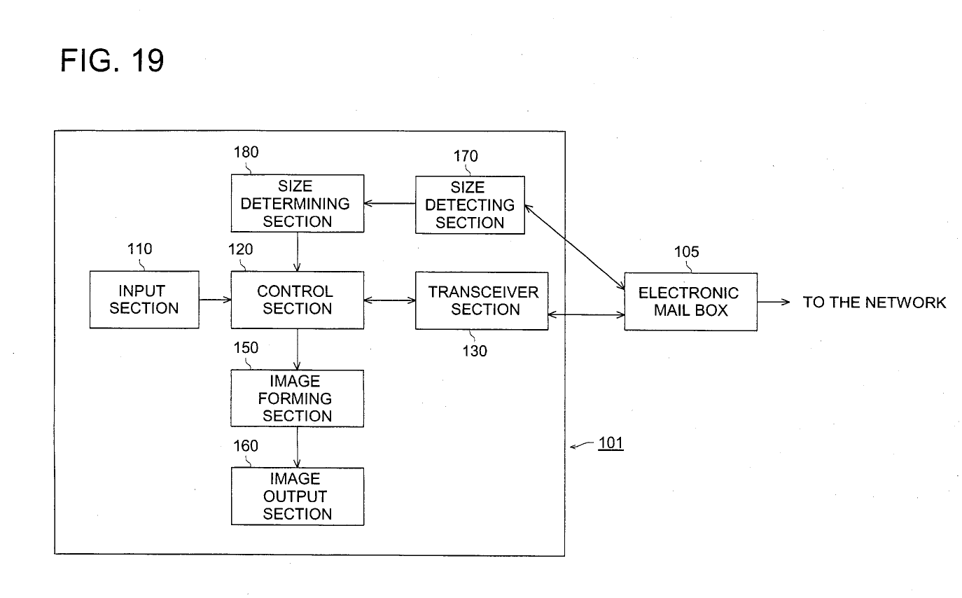

As shown in FIG. 19, this embodiment comprises; a transceiver section 130 as transceiver means for transmitting and receiving electronic mail through a mail box 105 as a mail server arranged in a predetermined network; an image forming section 150 as image forming means for forming an image; and an image output section 160 as image output means for producing an image formed by the aforementioned image forming means.

In the network image forming apparatus 101 shown in FIG. 19, this embodiment also includes: a size detecting section 170 as size detecting means for detecting the data size of the electronic mail received by the electronic mail box 105 as a receive mail box provided on the aforementioned mail server; a size determining section 180 as size determining means for determining whether or not the aforementioned detected data size is greater than a predetermined size; a control section 120 as control means for provide control in such a way that the text of electronic mail is received by the transceiver means, when it has been determined that the data size is smaller than a predetermined size.

In FIG. 19, an input section 110 includes an operation panel for operating the network image forming apparatus 101, and an imager reading apparatus (e.g. a scanner) for entering an image to produce an image by the network image forming apparatus 10 as required. Operation entries gained from the input section 110 and image data obtained from the image reading apparatus as required are sent to the control section 120.

The control section 120 controls the transceiver section 130, image forming section 150 and image output section 160 according to the operation entries sent from the input section 110 and electronic mail sent from the transceiver section 130 to be described later.

As will be described later, the image forming apparatus 120 controls the operation, depending on whether or not the transceiver section 130 transmits or receives electronic mail temporarily stored in the electronic mail box 105, based on the result of checking in the size determining section 180.

Further, when the image data has been entered from the input section 110, the control section 120 creates job data based on the image data and the data on the form of the output data entered from the input section 110, e.g. form data related to the format, size and output medium, and sends it the form data to the image forming section 150.

When having recognized to have received illegal mail as will be described later, the control section 120 creates the electronic mail for notifying an external manager, and sends it to the transceiver section 130.

According to the instruction from the control section 120, the transceiver section 130 transmits and receives the external electronic mail received by the electronic mail box 105. Further, when having received the electronic mail created upon reception of the aforementioned illegal mail, transceiver section 130 sends it to the aforementioned manager through the network according to the instruction of the control section 120.

According to the aforementioned job data, the image forming section 150 creates the image output data and sends it to the image output section 160.

The image output section 160 consists of display means and a component performing the functions of a printer, and produces the image output data sent from the image forming section 150. In other words, the data is displayed on the display means and/or is printed out on such a medium as paper with the aid of printer function.

Here when it has been determined by the size determining means that the data size of the electronic mail is smaller than a predetermined value, the control section 120 is preferred to work as command extracting means for extracting the relevant command from the electronic mail.

Further, when it has been determined by the size determining means that the data size is larger than a predetermined value, the control section 120 is preferred to work as electronic mail creating means for creating electronic mail for reporting this information.

The following describes the network image forming apparatus 101.

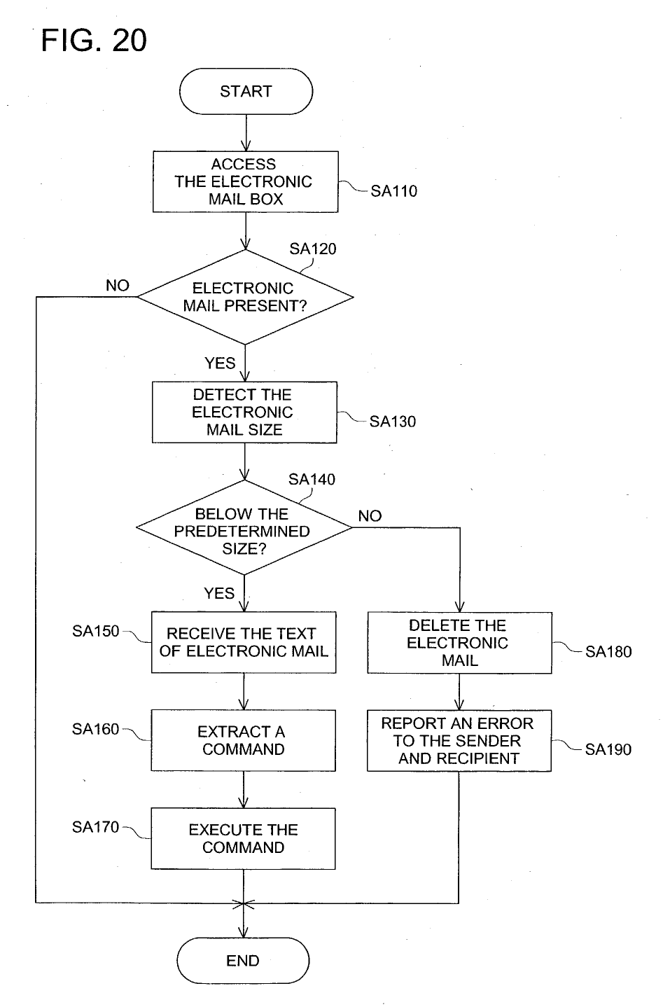

In Step SA 110 as shown in FIG. 20, the transceiver section 130 accesses the electronic mail box 105 according to the instruction from the control section 120 and the system proceeds to the Step SA 120. In this access, authentication may be performed as required.

In Step SA 120, evaluation is made to determine whether or not electronic mail is present in the electronic mail box 105 accessed. To put it more specifically, the transceiver section 130 accesses the electronic mail box 105 and the presence or absence of electronic mail is checked by the control section 120. Alternatively, it is also possible to arrange such a configuration that the electronic mail box 105 accesses the size detecting section 170 and the size determining section 180 determines that there is no relevant size information.

If the result of this check is NO, namely if there is no electronic mail in the electronic mail box 10, the control section 120 provides control in such a way that electronic mail is not received, for example, by allowing the transceiver section 130 to suspend connection for transmission and reception of the electronic mail box 105. If the result of this check is YES, namely if there is electronic mail in the electronic mail box 105 then the system proceeds to the Step SA 130.

In Step SA 130, the size detecting section 170 accesses the electronic mail box 105 and data size is detected from the header information of electronic mail. The result of detection is sent to the size determining section 180 and the system proceeds to the Step SA 140.

In Step SA 140, evaluation is made by the size determining section 180 to determine whether or not the data size detected in Step SA 130 is smaller than a predetermined value, and the result of this check is sent to the control section 120. Here the predetermined size serving as a threshold value is 50 Kbytes, for example.

The size of electronic mail containing an adequate command does not reach the level in excess of a certain value. So when a predetermined data size is used as a threshold value for evaluation, it is possible to determine whether or not the electronic mail in the electronic mail box 105 is the one containing an adequate command. If the result of this check is NO, namely if the size of the electronic mail in the electronic mail box 105 is greater than a predetermined value, i.e. when this electronic mail may be illegal, then the system proceeds to the Step SA 180.

If the result of this check is YES, namely if the size of the electronic mail is smaller than a predetermined value, i.e. when this electronic mail contains an adequate command, then the system proceeds to the Step SA 150.

In Step SA 150, when the check result of YES is sent from the size determining section 180, the control section 120 prompts the transceiver section 130 to receive the text of the electronic mail that was subjected to determination in Step SA 140, and the system proceeds to the Step SA 160. In Step SA 160, electronic mail received in the transceiver section 130 is sent to the control section 120 and the control section 120 extracts a command from the text of this electronic mail. Then the system proceeds to the Step SA 170. In Step SA 170, the control section 120 executes this extracted command and the transceiver section 130 cuts off the connection with the electronic mail box 105, whereby processing of electronic mail terminates. In Step SA 150, it is also possible to arrange such a configuration that the electronic mail picked up from the electronic mail box 105 is deleted from the electronic mail box 105.

The command executed in Step SA 170 includes the command for requesting transmission of the information on the number of copies and that for requesting acquisition of history data such as failure data (e.g. jamming) when the network image forming apparatus is used as a copying machine.

In Step SA 180, the electronic mail determined as illegal in Step SA 140 is deleted and the system proceeds to the Step SA 190.

In Step SA 190, electronic mail for notifying that the electronic mail box 105 has received illegal mail is created by the control section 120, and this electronic mail is sent to the terminal of the external manager. Then the transceiver section 130 cuts off connection with the electronic mail box 105, whereby processing of electronic mail terminates.

In the embodiment shown in FIG. 20, illegal mail is deleted in Step SA 180. Without being restricted thereto, it is essential only that illegal mail be captured in the network image forming apparatus 101 and means be provided to ensure that illegal mail will not be processed. For example, it is possible to arrange such a configuration that illegal mail is kept as it is, and is deleted on a periodic basis. Alternatively, it is possible to send only the electronic mail created in the Step SA 190 to the manager.

In the above embodiment, electronic mail for reporting the reception of illegal mail is created in Step SA 190, and is sent to the manager. However, it goes without saying that mere deletion of illegal mail is sufficient without such electronic mail being sent to the manager.

FIG. 20 shows an example of merely processing the electronic mail without attached file. The following describes an embodiment of processing electronic mail with attached file.

In this case, the size detecting section 170 as size detecting means detects the size of the attached file as the aforementioned data size, and the size determining section 180 as size determining means determines whether or not the size of the attached file is greater than a predetermined size.

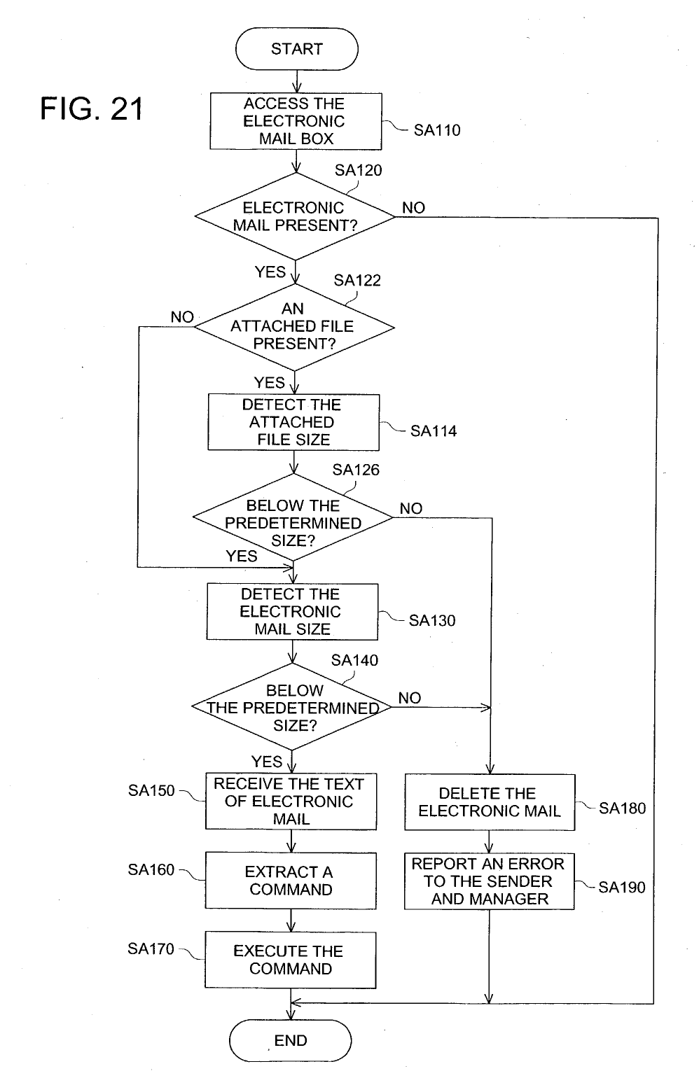

In FIG. 21 as described above, the transceiver section 130 accesses the electronic mail box 105 (Step SA 110), and evaluation is made to determine whether or not if there is electronic mail (Step SA 120). If it has been determined that there is no electronic mail, the operation terminates.

If the result of this check in Step SA 120 is YES, namely if electronic mail is present, the system proceeds to the Step SA 122.

In Step SA 122, the size detecting section 170 accesses the electronic mail box 105 and presence or absence of the attached file is detected from the header information of electronic mail or the like. If the result of this check is NO, namely if electronic mail is not present, the system proceeds to the Step SA 130. If the result of this check is YES, namely if electronic mail is present, the system proceeds to the Step SA 124. Further, the data size of the attached file is detected and the system proceeds to the Step SA 126.

In Step SA 126, evaluation is made by the size determining section 180 to determine whether or not the data size detected in Step SA 124 is below a predetermined value. The result of this check is sent to the control section 120. Here the predetermined size serving as a threshold value is 200 Kbytes, for example.

The size of electronic mail containing an adequate command does not reach the level in excess of a certain value. So when a predetermined data size is used as a threshold value for evaluation, it is possible to determine whether or not the electronic mail in the electronic mail box 105 is the one containing an adequate command.

If the result of this check is NO, namely if the electronic mail in the electronic mail box 105 contains the attached file whose data size is greater than a predetermined value, i.e. when this electronic mail is illegal, then the system proceeds to the Step SA 180.

Further, if the result of this check is YES, namely if the electronic mail contains an adequate attached file, then the system proceeds to the Step SA 130.

In Step SA 130, the data size of electronic mail itself is detected in the size detecting section 170 and this detected data size is evaluated with a predetermined serving as a threshold value (Step SA 140). The data size as a threshold value is 50 Kbytes, for example, as described above.

When it has been determined that the electronic mail to be evaluated in Step SA 140 is adequate electronic mail, this electronic mail is received by the electronic mail server 30 (Step SA 150), and a command is extracted from this electronic mail and/or attached file by the control section 120 (Step SA 160). This command is executed (Step SA 170) and the transceiver section 130 cuts off connection with the electronic mail box 105, whereby processing of electronic mail terminates. The command executed in Step SA 170 is the same as that described above.

When it has been determined that electronic mail to be evaluated is illegal, the system proceeds to the Step SA 180. The electronic mail evaluated to contain an illegal attached file in Step SA 126 and electronic mail evaluated to contain an illegal mail (hereinafter collectively called “illegal mail, etc.”) are detected in Step SA 180. Further, the electronic mail for reporting the reception of illegal mail is created by the control section 120 (Step SA 190), and this electronic mail is sent to the terminal of the manager. The transceiver section 130 cuts off connection with the electronic mail box 105, whereby processing of electronic mail terminates.

In the embodiment shown in FIG. 21, illegal mail is deleted in Step SA 180, similarly to that shown in FIG. 20. Without being restricted thereto, it is essential only that illegal mail be captured in the network image forming apparatus 101 and means be provided to ensure that illegal mail will not be processed. For example, it is possible to arrange such a configuration that illegal mail is kept as it is, and is deleted on a periodic basis. Alternatively, it is possible to send only the electronic mail created in the Step SA 190 to the manager.

In the above embodiment, electronic mail for reporting the reception of illegal mail is created in Step SA 190, and is sent to the manager. However, it goes without saying that mere deletion of illegal mail is sufficient without such electronic mail being sent to the manager.

As described above, evaluation is automatically made to determine if the mail is illegal or not before being received by the network image forming apparatus to ensure that illegal mail will not be received. This method is helpful in avoiding loads on unnecessary communication traffic over the network, loads on the network image forming apparatus in processing illegal mail and unwanted consumption of memory space.

Thirteen Embodiment

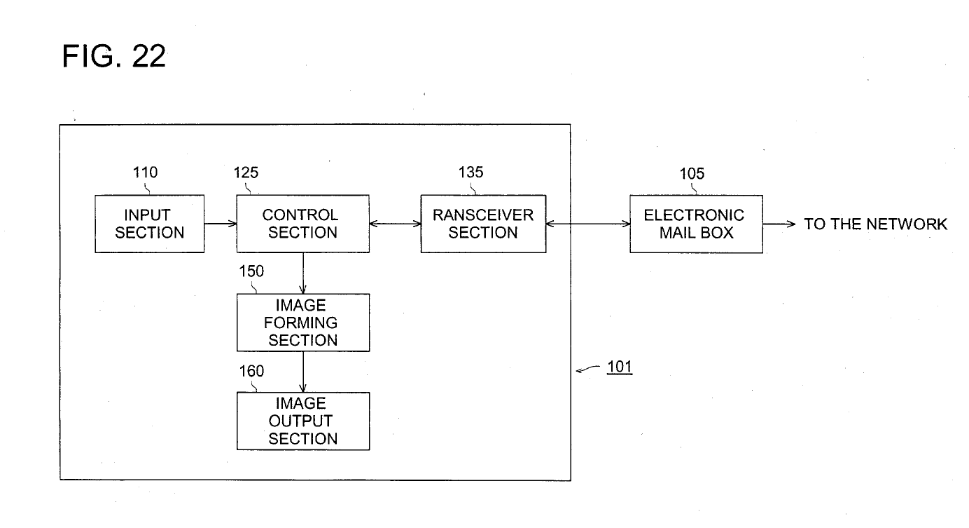

As shown in FIG. 22, the thirteenth embodiment of the aforementioned network image forming apparatus comprises: a transceiver section 135 as transceiver means for transmitting and receiving electronic mail through a mail server arranged on the prescribed network; an image forming apparatus 150 as image forming means for forming an image; an image output section 160 as image output means for producing an image formed by the aforementioned image forming means; and a control section 125 as control means for controlling the operation of the aforementioned transceiver means.

In the embodiment shown in FIG. 19, it is also possible to arrange such a configuration that the control section 120 determines if the number of electronic mail items received by the transceiver section 135 and the reception of electronic mail terminates when the number has reached a predetermined, value.

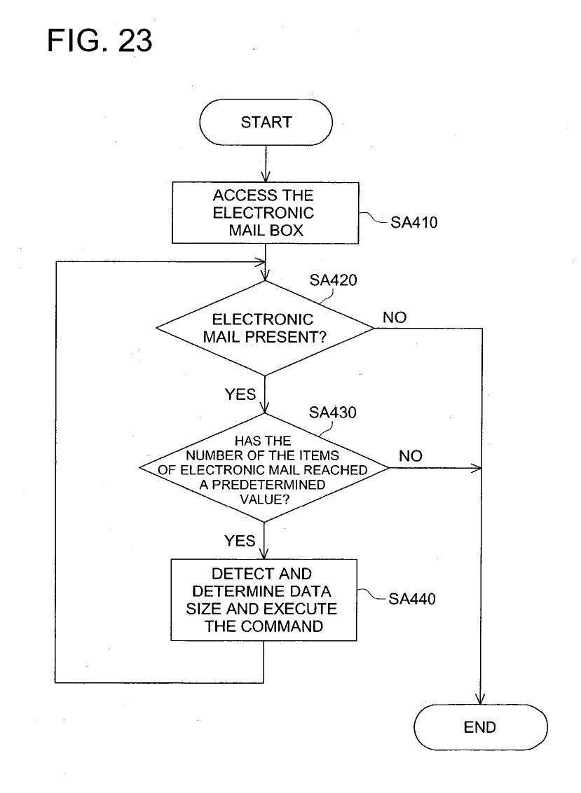

To put it more specifically, as shown in FIG. 23, the transceiver section 135 accesses the electronic mail box 105 in Step SA 410. In the process of access, it is also possible to authenticate the mail if required.

In Step SA 420, evaluation is made by the control section 125 to determine whether or not electronic mail is present in the electronic mail box 105, similarly to the case of Step SA 120 shown in FIGS. 20 and 21.

If the result of this check is NO, namely if there is no electronic mail in the electronic mail box 105, the operation terminates. If the result of this check is YES, namely if there is electronic mail in the electronic mail box 105, the system proceeds to the Step SA 430.

In Step SA 430, evaluation is made to determine whether or not the number of the items of electronic mail (hereinafter referred to as “processed mail”) processed in the control section 125 has reached a predetermined value, for example, “ten”. If the result of this check is NO, namely if the number of processed mail items has reached the predetermined value, the transceiver section 135 cuts off the connection with the electronic mail box 105, whereby processing of electronic mail terminates. If the result of this check is YES, namely if the number of processed mail items has not reached the predetermined value, the system proceeds to the Step SA 440.

In Step SA 440, electronic mail received by the electronic mail box 105 is taken out by the transceiver section 135 and is subject to predetermined processing as shown in FIGS. 20 and 21. Then the system proceeds to the Step SA 420.

The number of electronic mail items is set in one connection as described above, and means are provided to ensure that the greater number of electronic mail items is not be received by the network image forming apparatus. This method reduces the local loads in processing the electronic mail—processing involving evaluation to determine if the mail is illegal or not, extraction and execution of a command and the like.

In the embodiment shown in FIGS. 20, 21 and 23, It is preferred that the line once cut off between the transceiver section 135 and electronic mail box 105 be connected again after a certain time interval and processing of electronic mail be started. The time required before the re-connection may be set in advance. Alternatively, connection may be made by operating the input section 110 on the network image forming apparatus 101 given in FIGS. 19 and 22.

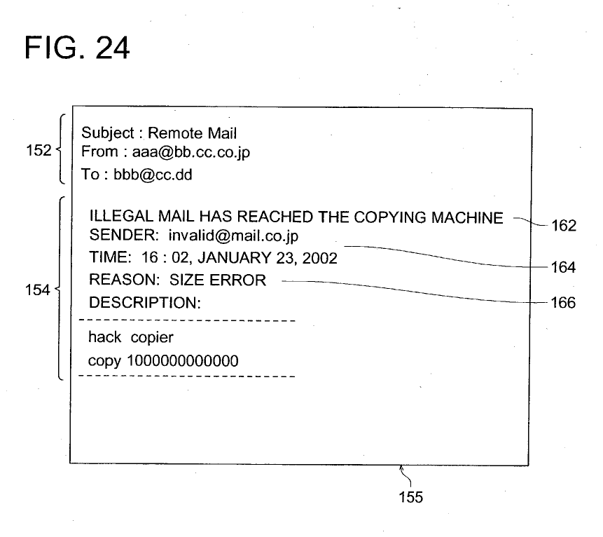

In the embodiment shown in FIGS. 20, 21 and 23, the electronic mail to be created for notifying a manager of the reception of illegal mail includes that shown in FIG. 24.

In FIG. 24, electronic mail data 155 includes a header part 152 and a text part 154.

The header part 152 includes a subject column, send-from column and send-to column.

The text part 154 contains at least a message part 162 for showing reception of illegal mail, a sender's address part 164 for showing the sender's address of illegal mail and a reason part 166 for indicating the reason for determining illegal mail.

In FIG. 6(a) to FIG. 6(c), the electronic mail address of the copying machine as a network image forming apparatus having detected illegal mail is “aaa@bb.cc.dd” and the electronic mail address for the manager notified of the detection of illegal mail is “bbb@cc.dd”.

It is indicated that the sender of the illegal mail is “invalid@mail.co.jp” and the time of reception is 16:2, Jan. 23, 2002. It is also shown that a size error is the cause for determining that illegal mail has been received.

Communication by electronic mail as described above is automatically sent to the manager allows the manager to confirm from a remote place that illegal mail has been received, without having to operate the network image forming apparatus directly.

Fourteenth Embodiment

Referring to drawings, the following describes the fourteenth embodiment of a network image forming apparatus according to the present invention.

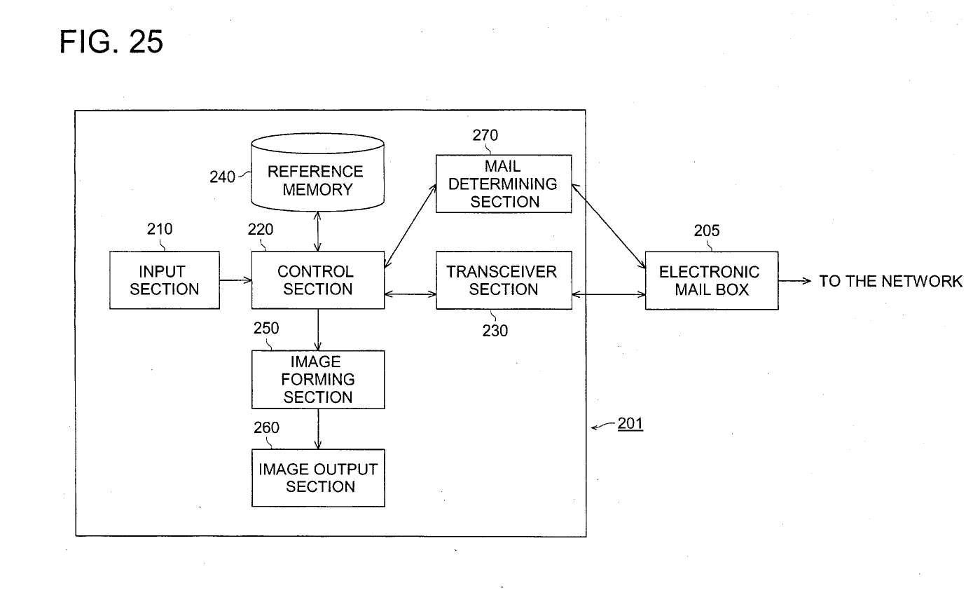

As shown in FIG. 25, this embodiment comprises; a transceiver section 230 for transmitting and receiving electronic mail via predetermined network; an image forming section 250 as image forming means for forming an image; and an image output section 260 as image output means for producing an image formed by the aforementioned image forming means.

This network image forming apparatus processes the operations remote-controlled from outside by performing operations according to the command described in the electronic mail including a predetermined command received by the aforementioned transceiver means.

The network image forming apparatus 201 shown in FIG. 25 consists of: a controller 220 as identification information extracting means for picking up identification information from the electronic mail received by the aforementioned transceiver means; a controller 220 as authentication means for authenticating the identification information picked up by the aforementioned means; a reference memory 240 for storing the information used for reference at the time of authentication by the aforementioned authentication means; a controller 220 as command extracting means for extracting a predetermined command described in the electronic mail containing authenticated identification information that has been captured by the aforementioned authentication means; and a controller 220 as control means for controlling each component according to the aforementioned extracted command.

In FIG. 25, the input section 210 includes an operation panel for operating the network image forming apparatus 201, and an imager reading apparatus (e.g. a scanner) for entering an image to produce an image by the network image forming apparatus 201 as required. Operation entries gained from the input section 210 and image data obtained from the image reading apparatus as required are sent to the control section 220.

The control section 220 controls the image forming sections 230, 250 and 260 according to the operation entries sent from the input section 210 and electronic mail sent from the transceiver section 230 to be described later.

Further, when the image data has been entered from the input section 210, the control section 220 creates job data based on the image data and the data on the form of the output data entered from the input section 210, e.g. form data related to the format, size and output medium, and sends it the form data to the image forming section 250.

Further, the control section 220 picks up the identification information from the specified area of electronic mail received by the transceiver section 230 as will be described later, and authenticates this identification information. Instruction is given by the transceiver section 230 to ensure that the entire electronic mail should be captured when the identification information has been authenticated as correct information.

Further, the predetermined command described in this electronic mail is extracted from the entire electronic mail received by the transceiver section 230, and each component is controlled according to the aforementioned extracted command.

This section is preferred to serve as an electronic mail creating means for creating electronic mail that is used to notify detection of illegal mail wherein the aforementioned identification information is not authenticated, whenever such illegal mail has been detected.

The transceiver section 230 receives the external electronic mail received by the electronic mail box 205 according to the instruction from the control section 230. The electronic mail created upon reception of the aforementioned illegal mail is sent to the aforementioned manager via the network according to the instruction from the control section 220.

The reference memory 240 stores the master data for authenticating the aforementioned identification information by the control section 220. In addition to the master data, authority defined for each piece of identification information is preferred to be associated therewith and stored therein.

When authority is associated with the data, the control section 220 as the aforementioned authentication means authenticates the aforementioned identification information as will be described later, and information on the authority corresponding to the authenticated identification information is extracted from the reference memory and evaluation is made to determine whether or not the command included in this electronic mail lies within the extracted authority. The control section 220 as the aforementioned control means is preferred to control each component according to the command if it has been determined that this command lies within the scope of the aforementioned authority.

The image forming section 250 creates the image output data according to the aforementioned job data, and sends it to the image output section 260.

The image output section 260 consists of display means and a component performing the functions of a printer, and produces the image output data sent from the image forming section 250. In other words, the data is displayed on the display means and/or is printed out on such a medium as paper with the aid of printer function.

The mail determining section 270 accesses the electronic mail box 105 according to the instruction from the control section 220, and checks whether or not electronic mail has been received by the electronic mail box 205. The result of this check is sent to the control section 220.

The following describes the operation of the network image forming apparatus 201.

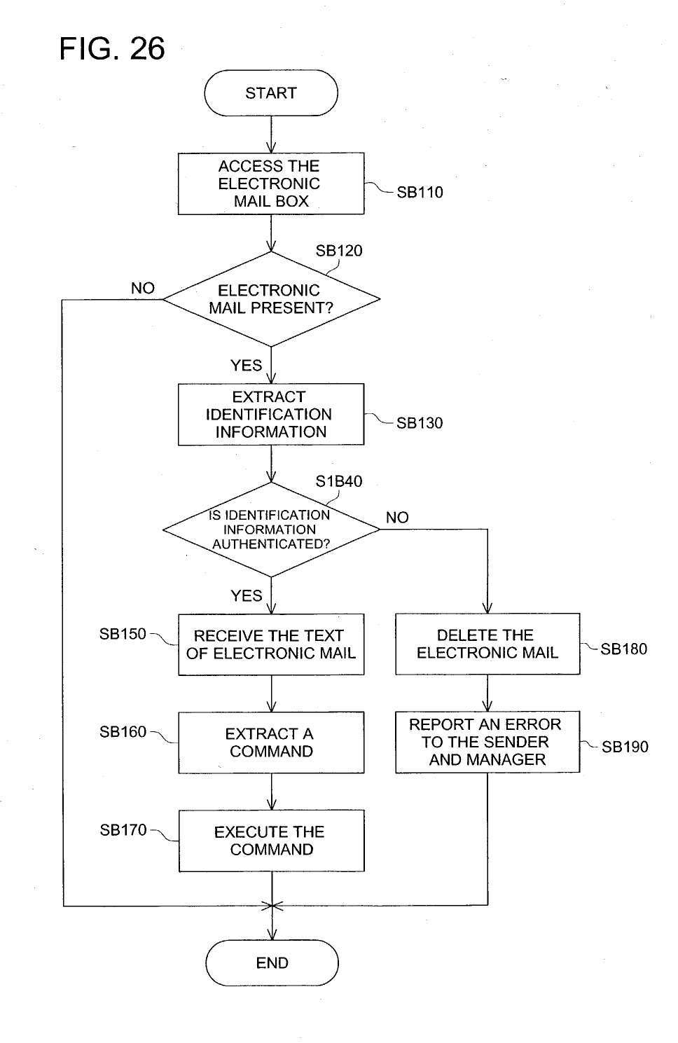

In Step SB 119 as shown in FIG. 26, the mail determining section 270 access the electronic mail box according to the instruction from the control section 270 and the system proceeds to the Step SB 120. In this access, authentication may be performed if required.

In Step SB 120, evaluation is made to determine whether or not electronic mail is present in the electronic mail box 205. To put it more specifically, mail determining section 270 accesses the electronic mail box 205 to check presence or absence of electronic mail.

If the result of this check is NO, namely if there is no electronic mail in the electronic mail box 205, the mail determining section 270 sends information to the control section 220 to notify that there is no electronic mail. The control section 220 terminates the operation by providing control in such a way that the transceiver section 230 suspends connection with the electronic mail box 205 for reception of information, thereby ensuring that electronic mail is not received. If the result of this check is YES, namely if there is electronic mail in the electronic mail box 205, then the system proceeds to the Step SB 130.

In Step SB 130, the transceiver section 230 access the electronic mail box 205 according to the instruction from the control section 220. Management information part including the identification information, e.g. header information is taken from electronic mail in the electronic mail box 205, and is sent to the control section 220. The control section 220 extracts identification information from this management information part and the system proceeds to the Step SB 140.

In Step SB 140, identification information extracted in Step SB 130 is checked against the master data registered in the reference memory, and evaluation is made by the control section 220 to determine whether or not this identification information is correct.

If the result of this check is NO, namely if this identification information is incorrect, the system proceeds to the Step SB 180. If the result of this check is YES, namely if this identification information is correct, the system proceeds to the Step SB 150.

In Step SB 150, if the result of this check in Step SB 140 is YES, the control section 220 prompts the transceiver section 230 to receive the text of electronic mail evaluated in Step SB 140. Then the system proceeds to the Step SB 160. In Step SB 160, the electronic mail received by the transceiver section 230 is sent to the control section 220, where a command is extracted from this electronic mail. Then the system proceeds to the Step SB 170. In Step SB 170, the control section 220 continues to execute this extracted command, and the transceiver section 230 cuts off connection with the electronic mail box 205, whereby processing of electronic mail terminates. In Step SB 150, it is also possible to arrange such a configuration that the electronic mail taken out of the electronic mail box 205 by the transceiver section 230 is deleted from the electronic mail box 205.

The command executed in Step SB 170 includes the command for requesting transmission of the information on the number of copies and that for requesting acquisition of history data such as failure data (e.g. jamming) when the network image forming apparatus is used as a copying machine.

In Step SB 180, the electronic mail determined as illegal in Step SB 140 is deleted and the system proceeds to the Step SB 190. In Step SB 190, electronic mail for notifying that the electronic mail box 205 has received illegal mail is created by the control section 220, and this electronic mail is sent to the terminal of the external manager. Then the transceiver section 230 cuts off connection with the electronic mail box 205, whereby processing of electronic mail terminates.

In the embodiment shown in FIG. 26, illegal mail is deleted in Step SB 180. Without being restricted thereto, it is essential only that illegal mail be captured in the network image forming apparatus 201 and means be provided to ensure that illegal mail will not be processed. For example, it is possible to arrange such a configuration that illegal mail is kept as it is, and is deleted on a periodic basis. Alternatively, it is possible to send only the electronic mail created in the Step SB 190 to the manager.

In the above embodiment, electronic mail for reporting the reception of illegal mail is created in Step SB 190, and is sent to the manager. However, it goes without saying that mere deletion of illegal mail is sufficient without such electronic mail being sent to the manager.

The aforementioned identification information can be any information if the sender of this electronic mail is identified. However, this information is preferred to be a password described in a predetermined area of the electronic mail, e.g. header part or an electronic mail address as identification information that necessarily belongs to the sender, for example.

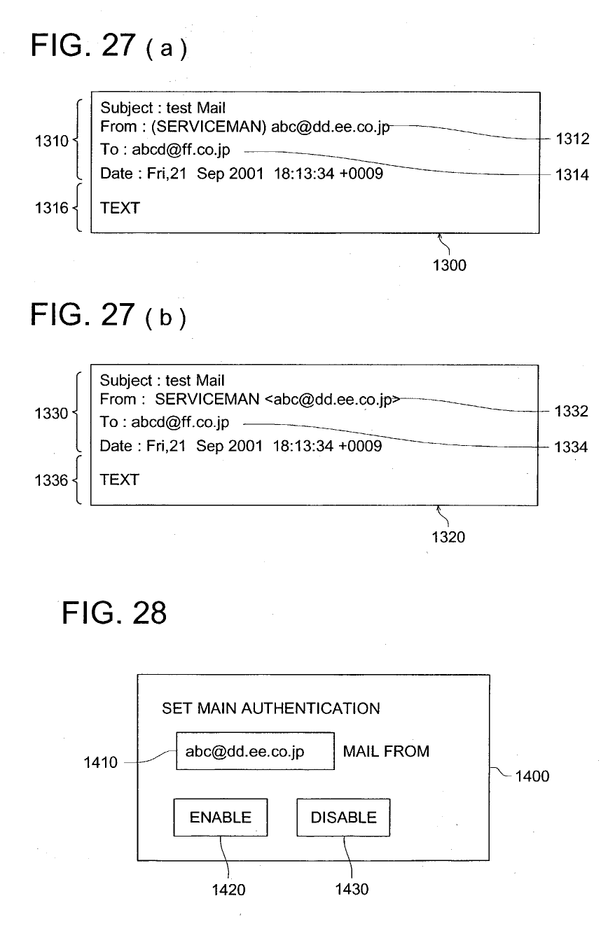

For example, when the identification information is an electronic mail address, this identification information corresponds to the sender's electronic mail address that is described in the sender's address column 1312 of the electronic mail 1300 having both header part 1310 and text part 1316, as shown in FIG. 27(a). It corresponds to “abcd@dd.ee.co.jp” in FIG. 27(a). Electronic mail address “abcd@ff.co.jp” of this network image forming apparatus is described in the recipient's address column 1314 in FIG. 27(a).

In FIG. 27(b), identification information is the sender's electronic mail address described in the sender's address column 1332 of the electronic mail 1320 having a header part 1330 and text part 1336. Further, similarly to the case of FIG. 27(a), the electronic mail address of the network image forming apparatus is described in the recipient's address column 1334.

As described above, when the sender's electronic mail address is directly described in the sender's address column (FIG. 27(a)), the sender's name is shown in the sender's address column. For example, when the electronic mail address associated with the name is included in the header part (Fig. (b)), the sender's electronic mail address as identification information is extracted in the aforementioned Step SB 130.

In Step SB 140, to authenticate the aforementioned identification information, it is necessary to create the master data that has its identification information registered in the reference memory 240 is registered. As shown in FIG. 28, the electronic mail address to be authenticated is entered in address input window 1410 on the display section 1400 of the operation panel of the aforementioned input section 210. When permission is given to reception of electronic mail from the entered electronic mail address by the transceiver section 230, the Enable button 1420 is clicked. If no permission is given, the Disable button 1430 is clicked. This procedure is used to create master data. In FIG. 28, reception of electronic mail from “abc@dd.ee.co.jp” is enabled.

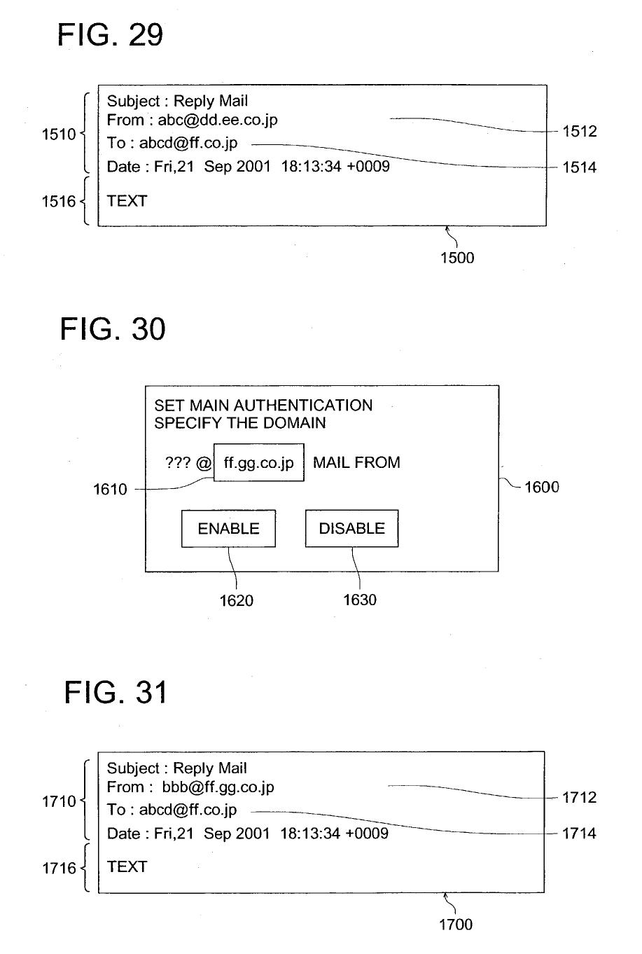

When electronic mail 1500 from the “abc@dd.ee.co.jp” shown in FIG. 29 is sent to the electronic mail address “abcd@ff.co.jp” of the network image forming apparatus described in the recipient's address column 1514 after this setting procedure, then an electronic mail address is extracted as identification information from the sender's address column 1512 in Step SB 130. This sender's electronic mail-address is authenticated in Step SB 140, and a predetermined command described in the text part 1516 in Step SB 160 is extracted.

The electronic mail address as identification information can be authenticated by the domain name. As shown in FIG. 30, the domain name to be authenticated is entered in a domain name input window 1410 on the display section 1600 of the operation panel of the aforementioned input section 210. When permission is given to reception of electronic mail from the entered electronic mail address by the transceiver section 230, the Enable button 1620 is clicked. If no permission is given, the Disable button 1630 is clicked. This procedure is used to create master data within the reference memory 240. In FIG. 30, reception of electronic mail from the domain of “ff.gg.co.jp” is enabled.

When electronic mail 1700 from the “bbb@ff.gg.co.jp” shown in FIG. 31 is sent to the electronic mail address “abcd@ff.co.jp” of the network image forming apparatus described in the recipient's address column 1714 after this setting procedure, then an electronic mail address is extracted from the sender's address column 1712 in Step SB 130 and the domain name thereof is identified as identification information. The domain name of this sender's electronic mail is authenticated in Step SB 140, and a predetermined command described in the text part 1716 in Step SB 160 is extracted.

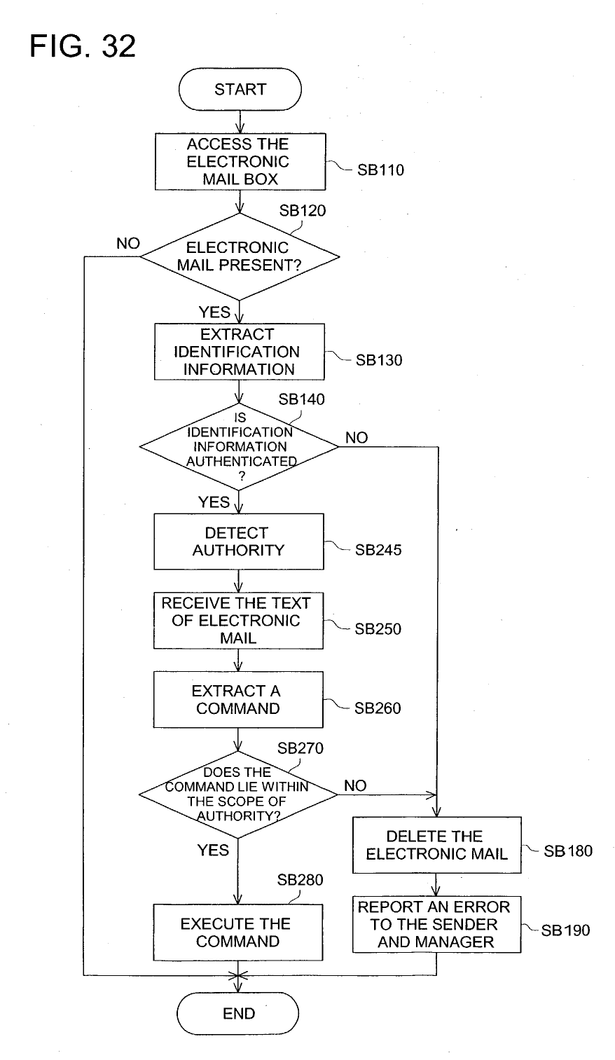

It is also possible to arrange such a configuration that the scope of the command issued to the network image forming apparatus is set for each of the aforementioned pieces of information. In this case, the control section 220 as the aforementioned authentication means authenticates the aforementioned identification information (Step SB 140), as shown in FIG. 32. At the same time, the information on the authority corresponding to authenticated identification information is extracted from the reference memory (Step SB 245). Evaluation is made to determine whether or not the command included in the electronic mail lies within the scope of the extracted authority (Step SB 270). When the command has been determined to lie within the aforementioned scope of authority by authentication means, the control section 220 as control means controls each component according to the command (Step SB 280).

In FIG. 32, the mail determining section 270 accesses the electronic mail box 205 (Step SB 110) similarly to the embodiment shown in FIG. 26, and checks if there is any electronic mail or not (Step SB 120). If there is no electronic mail, the operation terminates. When electronic mail has been found out, identification information is extracted from the electronic mail by the transceiver section 230 (Step SB 130), and this identification information is authenticated (Step SB 140). After authentication of the identification information, the system proceeds to the Step SB 245. If identification information is not authenticated, the system proceeds to the Step SB 180.

In Step SB 245, the master data on command authority corresponding to the identification information extracted by Step SB 130 is picked up from the reference memory 240 by the controller 220, and the system proceeds to the Step SB 250.

Here the command authority is classified, for example, into three stages according to the level or the like. Users on the highest level are assumed as “super-users” (manager centers), the users on the next level as managers (servicemen) for setting multiple network image forming apparatuses while moving, and the users of the lowest level as general users. They are each associated with corresponding levels of authority.

Here the authority assigned to general users involves acquisition of the internal information on a network image forming apparatus, e.g. log information, count information, failure (jamming) information, information of the serviceman call (SC) information on adjustment to be made by a serviceman; output instruction including image output and text output instructions; confirmation of job and reservation statuses; and startup instruction for starting from the sleep mode or off state.

The authority assigned to general users involves, for example, a data rewrite instruction inside the reference memory 240, a lock instruction for prompting the network image forming apparatus to be disabled, a network image forming apparatus shutdown instruction and forceful job terminating instruction, in addition to that assigned to general users.

The authority assigned to the super-uses involves, for example, a system change instruction such as an instruction for rewriting the network image forming apparatus control software, in addition to that assigned to a serviceman.

In Step SB 250, the control section 220 prompts the transceiver section 230 to receive the text of electronic mail containing the identification information authenticated in Step SB 140. Then the system proceeds to the Step SB 260. In Step SB 260, commands are extracted from received electronic mail, and the electronic mail received by the transceiver section 230 is sent to the control section 220. Commands are extracted from received electronic mail by the control section 220, and the system proceeds to the Step SB 270.

In Step SB 270, evaluation is made to determine whether or not commands extracted in Step SB 260 lie within the scope of authority, namely whether or not extracted commands are included in the group of commands extracted in Step SB 245.

If the result of this check is NO, namely if commands described on the received electronic mail do not lie within the scope of the sender's authority, this electronic mail is handled as illegal mail. Then the system proceeds to the Step SB 180.

If the result of this check is YES, namely if commands described on the received electronic mail lie within the scope of the sender's authority, the system proceeds to the Step SB 280.

In Step SB 280, the control section 220 continues to execute these extracted commands, and the transceiver section 230 cuts off connection with the electronic mail box 205, whereby processing of electronic mail terminates. In Step SB 205, electronic mail picked up from the transceiver section 230 by the electronic mail box 205 can be deleted from the electronic mail box 205.

When mail has been determined as illegal mail in Steps SB 140 and 270, the system proceeds to the Step SB 180, where electronic mail evaluated as illegal mail is deleted, and the system proceeds to the Step SB 190. In Step SB 190, electronic mail for reporting reception of illegal mail by the electronic mail box 205 is created by the control section 220. This electronic mail is then sent to the terminal of an external manager. Then the transceiver section 230 cuts off connection with the electronic mail box 205, and processing of electronic mail terminates.

In the embodiment shown in FIG. 32, illegal mail is deleted in Step SB 180, similarly to the case shown in FIG. 26. Without being restricted thereto, it is essential only that illegal mail be captured in the network image forming apparatus 201 and means be provided to ensure that illegal mail will not be processed. For example, it is possible to arrange such a configuration that illegal mail is kept as it is, and is deleted on a periodic basis. Alternatively, it is possible to send only the electronic mail created in the Step SB 190 to the manager.

In the embodiment shown above, electronic mail for reporting reception of illegal mail is created in Step SB 190 and is sent to the manager. It is also possible to arrange such a configuration that illegal mail is simply deleted without the electronic mail being sent to the manager.

Regarding the step (Step SB 245) for extracting command authority, FIG. 32 shows the case where the command authority is extracted immediately after authentication of identification information (Step SB 140). Without being restricted thereto, it can be extracted at any time if extraction is completed before the evaluation in Step SB 270.

When control is performed as shown in FIG. 32, it is necessary to ensure that the aforementioned identification information and authority determined for each identification information are associated with each other and are stored in the reference memory 240.

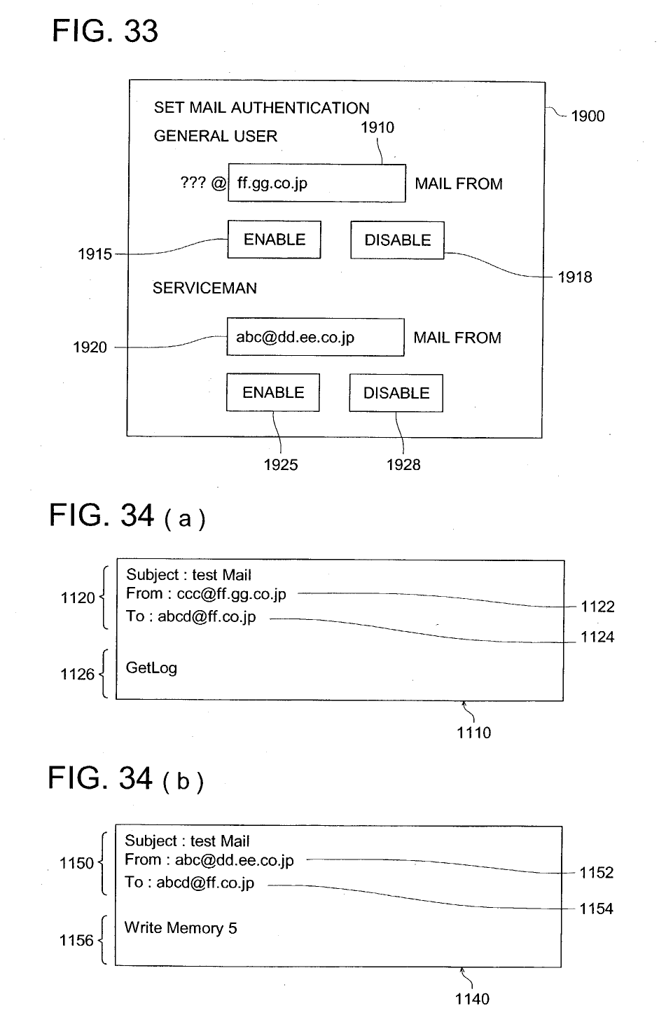

To put it more specifically, as shown in FIG. 33, the general users use the domain name to create master data, and the serviceman uses an electronic mail address to create it. The domain name to be authenticated as a general user is entered in a general user domain name input window 1910 on the display section 1900 of the operation panel of the aforementioned input section 210. When permission is given to reception of electronic mail from the entered domain by the transceiver section 230, the Enable button 1915 is clicked. If no permission is given, the Disable button 1918 is clicked. This procedure is used to create general user master data within the reference memory 240. In FIG. 33, reception of electronic mail from the domain of “ff.gg.co.jp” is enabled as reception of electronic mail from a general user.

In FIG. 33, the electronic mail address to be authenticated is entered in the serviceman address input window 1920 of the input window 1910. When permission is given to reception of electronic mail from the entered electronic mail address by the transceiver section 230, the Enable button 1925 is clicked. If no permission is given, the Disable button 1928 is clicked. This procedure is used to create serviceman master data within the reference memory 240. In FIG. 33, reception of electronic mail from the domain of “abc@dd.ee.co.jp” is enabled as reception of electronic mail from a serviceman.

If, after the above-mentioned setting, electronic mail 1110 from “ccc@ff.gg.co.jp” as shown in FIG. 34(a) has been sent to the electronic mail address “abcd@ff.co.jp” of the network image forming apparatus described in the recipient's address column 1124, then an electronic mail address is extracted from the sender's address column 1122 in Step SB 130, and the domain name is specified as identification information. The domain of the electronic mail address of this sender is authenticated as that for the general user in Step SB 140, and a predetermined command described in the text part 1126 is extracted in Step SB 260. In Step SB 270, evaluation is made to determine whether or not this command lies within the scope of the general user's authority. In FIG. 34(a), this command corresponds to a log information get command (GetLog) available to the general user, as described above. This command is executed in Step SB 280.

When electronic mail 1140 from “abc@dd.ee.co.jp” shown in FIG. 34(b) is sent to the electronic mail “abcd@ff.co.jp” of the network image forming apparatus described in the recipient's address column, an electronic mail address is extracted from the sender's address column in Step SB 130. This is identified as identification information, and this sender's electronic mail address is authenticated as a serviceman in Step SB 140, and a predetermined command described in the text part 1156 is extracted in Step SB 260. In Step SB 270, evaluation is made to determine whether or not this command lies within the scope of serviceman authority. In FIG. 34(b), this command is a “Write Memory 5” command that gives an instruction to rewrite the fifth data in the reference memory 240. As described above, this is a command available to the serviceman, so this command is executed in Step SB 280.

When a password is used as identification information, a change of this password lies within the authority of a higher-order command. A change of a general user's password lies within the authority of a serviceman and super-user, while a change of serviceman password lies within the authority of a super-user.

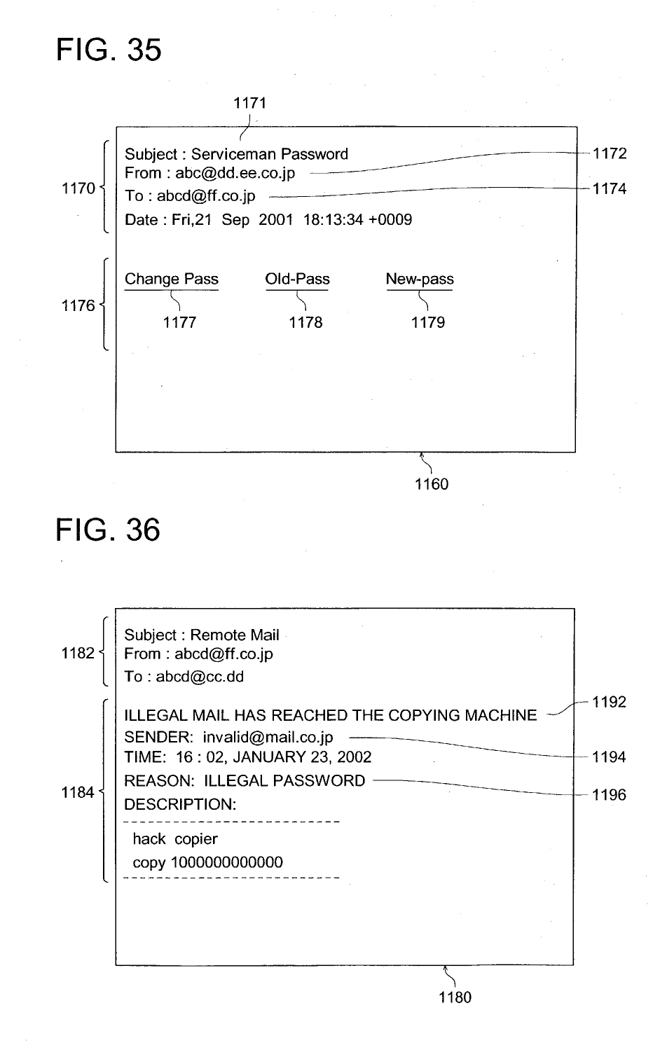

FIG. 35 shows an example of electronic mail for issuing to the network image forming apparatus the instruction for a serviceman to change the general user's password.

Electronic mail 1160 contains a header part 1170 and text part 1176. The header 1170 contains a subject column 1171, sender's address column 1172 and recipient's address column 1174. The text part 1176 includes a command display 1177. Further, a pre-change password display 1178 and a post-change password display 1179 are also provided.

In FIG. 35, the subject column 1171 contains the description of a password as identification information indicating that the electronic mail is sent from the person authorized as a serviceman. It also shows that this electronic mail is sent from abc@dd.ee.co.jp to abcd@ff.co.jp.

The command display 1177 shows that the command instructed by the electronic mail involves change of a password. A pre-change password and post-change password are described therein.

In FIG. 35, the password as identification information is extracted according to the data in the subject column 1171. When this password is authenticated (Step SB 140), the command display 1177 is extracted from the text part 1176 in Step SB 260, and a general user's password is changed from the password given on the display 1178 to the password given on the display 1179 in Step SB 280.

Since greater authority is awarded to a super-user than a serviceman, it is also possible to change the command involving a change of both passwords. For example, when a serviceman's password is shown in the subject column 1171, then the pre-change password is requested. However, when a super-user's password is shown in the subject column 1171, then the pre-change password is not requested.

Further, in the embodiment given in FIGS. 26 and 32, it is preferred that the line once cut off between the transceiver section 203 and electronic mail box 205 should be connected again after the lapse of a predetermined time interval, and processing of electronic mail should be resumed. The time interval before re-connection of the line can be preset or can be made by the operation of the input section 210 of the network image forming apparatus in FIG. 25.

In the embodiment shown in FIGS. 26 and 32, the electronic mail addressed to a manager and created for reporting reception of illegal mail is exemplified by that shown in FIG. 36, for example.

In FIG. 36, electronic mail data includes a header part 1182 and text part 1184.

The header part 1182 contains a subject column, send-from column and send-to column.

The text part 1184 includes at least a message part 1192 showing reception of illegal mail, a sender's address part 1194 showing the sender's address of illegal mail and a reason part 1196 describing the reasons for having received illegal mail.

In FIG. 36, the electronic mail address of the network image forming apparatus having detected illegal mail is “abcd@ff.co.jp” and the electronic mail of a manager to whom this information is reported is “bbb@cc.dd”.

It is indicated that the sender of the illegal mail is “invalid@mail.co.jp”, and illegal mail was received at 16:2, Jan. 23, 2002. It is also shown that the reason for determining reception of illegal mail is detection of an illegal password. If the report through the above-mentioned electronic mail is transmitted, the manager can confirm reception of illegal mail at a distant place without directly operating the network image forming apparatus.

Some of the embodiments according to the present invention have been introduced. Configurations based on some modification of them without departing from the spirit of the present invention are considered as pertaining to the present invention.

The present invention allows a parameter setting person to check if an image forming apparatus can transmit and/or receive electronic mail correctly or not. In the event of a connection parameter setting error, it permits the setting person to identify an incorrect setting item and to check the troubleshooting procedure. Further, an image forming apparatus is capable of self-transmission and reception of electronic mail without being affected by delay in distribution of electronic mail to a mail server. When the connection parameter requiring rebooting of the image forming apparatus has been modified, a message indicating the need for rebooting can be displayed to the setting person.

The present invention reduces loads of communication traffic on the network due to reception of illegal mail or loads on the image forming apparatus resulting from processing of illegal mail when multiple image forming apparatuses are subjected to remote control using a technique based on electronic mail.

The present invention provides automatic detection of illegal mail when an image forming apparatus is subjected to remote control using a technique based on electronic mail.

Disclosed embodiments can be varied by a skilled person without departing from the spirit and scope of the invention.

What is claimed is:

1. A system for forming an image and communicating electronic mails, including a transmit mail and a receive mail, through a network, comprising:
a server, that includes a transmit-mail storage for temporarily storing said transmit mail to be transmitted via said network, and a receive-mail storage for temporarily storing said receive mail received via said network; and
an image-forming apparatus, that includes a transceiver section for transmitting a transmit data set to be transmitted on said transmit mail and for receiving a receive data set received on said receive mail, and a data-processing section for processing said receive data set received by said transceiver section;
wherein said server is coupled to both said network and said image-forming apparatus, so as to communicate said transmit data set and said receive data set on said electronic mails through said network; and
wherein said image-forming apparatus further includes:
an operating section to input connecting data;
a connecting data storage to store said connecting data therein; and
a displaying section to display said connecting data inputted by said operating section; and
wherein, when said connecting data are inputted from said operating section and a confirmation-starting command, to start an operation for confirming connections between said server and said transceiver section, is activated, said data-processing section generates a connecting parameter according to said connecting data inputted by said operating section, and then, said transceiver section is electrically connected to both said transmit-mail storage and said receive-mail storage, both included in said server, by employing said connecting parameter; and
wherein said data-processing section determines whether or not said connecting data are effective by monitoring a connecting status between said transceiver section and said server, and sends first displaying data for displaying a result determined by said data-processing section to said displaying section, which displays said result on a displaying screen.

2. The system of claim 1,
wherein, when said data-processing section determines that said connecting data are ineffective, said data-processing section also sends a second displaying data for displaying a second message urging a reentry of said connecting data to said displaying section, so that said displaying section displays said second message on said displaying screen, as needed.

3. The system of claim 2,
wherein, when said server rejects a confirmation mail sent from said transceiver section in said operation for confirming connections between said server and said transceiver section with employing said connecting parameter, said data-processing section determines that said connecting data, inputted by said operating section, are ineffective.

4. The system of claim 2,
wherein, when said transceiver section fails to achieve an accessing operation for accessing said receive-mail storage from said transceiver section in said operation for confirming connections between said server and said transceiver section with employing said connecting parameter, said data-processing section determines that said connecting data, inputted by said operating section, are ineffective.

5. The system of claim 2,
wherein, in said operation for confirming connections between said server and said transceiver section with employing said connecting parameter,
when said server rejects a confirmation mail sent from said transceiver section, or
when said transceiver section fails to achieve an accessing operation for accessing said receive-mail storage from said transceiver section,
said data-processing section determines that said connecting data, inputted by said operating section, are ineffective, and
said data-processing section also sends a third displaying data, for displaying a third message indicating an inability of normal communicating operation for said electronic mails, to said displaying section, so that said displaying section displays said third message on said displaying screen, as needed.

6. The system of claim 5,
wherein, when said data-processing section confirms that said receive-mail storage has not received a confirmation mail, said data-processing section controls said transceiver section so as to repeat accessing operations for accessing said receive-mail storage a predetermined number of times at a predetermined time interval; and
wherein, if said data-processing section still confirms that said receive-mail storage has not received a confirmation mail after said predetermined number of said accessing operations have completed, said data-processing section sends said third displaying data to said displaying section.

7. The system of claim 2,
wherein said data-processing section determines whether or not said server can recognize a new connecting parameter, regenerated from new connecting data reentered from said operating section, without rebooting said image-forming apparatus; and
wherein, when said data-processing section determines that said server cannot recognize said new connecting parameter without rebooting said image-forming apparatus, said data-processing section sends a fourth displaying data, for displaying a fourth message indicating a necessity of rebooting said image-forming apparatus, to said displaying section, so that said displaying section displays said fourth message on said displaying screen.

8. The system of claim 2,
wherein said data-processing section determines whether or not said server can recognize a new connecting parameter, regenerated from new connecting data reentered from said operating section, without rebooting said image-forming apparatus; and
wherein, when said data-processing section determines that said server cannot recognize said new connecting parameter without rebooting said image-forming apparatus, said data-processing section automatically reboots said image-forming apparatus.

9. A method for registering an image-forming apparatus into a network of a system for forming an image and communicating electronic mails, including a transmit mail and a receive mail, through said network, and said system comprising a server that includes a transmit-mail storage for temporarily storing said transmit mail to be transmitted via said network and a receive-mail storage for temporarily storing said receive mail received via said network, and said image-forming apparatus that includes a transceiver section for transmitting a transmit data set to be transmitted on said transmit mail and for receiving a receive data set received on said receive mail and a data-processing section for processing said receive data set received by said transceiver section, said method comprising the steps of:
inputting connecting data for generating a connecting parameter to connect said transceiver section with both said transmit-mail storage and said receive-mail storage of said server;
determining whether or not said connecting data are effective by monitoring a connecting status between said transceiver section and said server; and
displaying a first message indicating a result determined in said determining step on a displaying screen.

10. The method of claim 9, further comprising the steps of:
displaying a second message urging a reentry of said connecting data as needed, when it is determined that said connecting data are ineffective in said determining step.

11. The method of claim 10,
wherein said determining step further comprises the steps of:
controlling said transceiver section so as to conduct a sending operation of a confirmation mail by employing said connecting parameter; and
judging whether or not said confirmation mail is rejected in said transceiver section; and
wherein, when judging that said confirmation mail is rejected in said judging step, said connecting data are determined as ineffective data.

12. The method of claim 10,
wherein said determining step further comprises the steps of:
controlling said transceiver section so as to conduct an accessing operation for accessing said receive-mail storage of said server by employing said connecting parameter; and
judging whether or not said accessing operation is failed; and
wherein, when judging that said accessing operation is failed in said judging step, said connecting data are determined as ineffective data.

13. The method of claim 10,
wherein said determining step further comprises the steps of:
controlling said transceiver section so as to conduct a sending operation of a confirmation mail by employing said connecting parameter;
judging whether or not said confirmation mail is rejected in said transceiver section;
controlling said transceiver section so as to conduct an accessing operation for accessing said receive-mail storage of said server by employing said connecting parameter;
judging whether or not said accessing operation is failed; and
judging whether or not said confirmation mail is received at said receive-mail storage; and
wherein, when judging that said confirmation mail is rejected in said judging step, said connecting data are determined as ineffective data; and
wherein, when judging that said accessing operation is failed in said judging step, said connecting data are determined as ineffective data; and
wherein, when judging that said confirmation mail is not received by said receive-mail storage, it is determined that receiving/transmitting operations cannot be normally conducted.

14. The method of claim 13,
wherein, when it is confirmed that said confirmation mail is not received by said receive-mail storage, said judging step of confirmation mail reception further comprises the steps of:
judging whether or not said transceiver section should perform again an accessing operation for accessing said receive-mail storage; and
judging whether or not a number of repetitions of accessing operations for accessing said receive-mail storage already exceeds a predetermined number of times, when judging that said transceiver section should perform again said accessing operation; and
wherein, judging that said number of repetitions of accessing operations for accessing said receive-mail storage already exceeds said predetermined number of times, it is determined that receiving operations of said electronic mail could not be normally conducted.

15. The method of claim 10, when said connecting data, which were once inputted, are changed to new connecting data, further comprising the steps of:
inputting said new connecting data for regenerating a new connecting parameter;
determining whether or not said server can recognize said new connecting parameter, regenerated from new connecting data inputted in said inputting step, without rebooting said image-forming apparatus; and
displaying a fourth message indicating a necessity of rebooting said image-forming apparatus on said displaying screen, when determining that said server cannot recognize said new connecting parameter without rebooting said image-forming apparatus.

16. The method of claim 10, when said connecting data, which were once inputted, are changed to new connecting data, further comprising the steps of:
inputting said new connecting data for regenerating a new connecting parameter;
determining whether or not said server can recognize said new connecting parameter, regenerated from new connecting data inputted in said inputting step, without rebooting said image-forming apparatus; and
rebooting said image-forming apparatus in an automatic mode, when determining that said server cannot recognize said new connecting parameter without rebooting said image-forming apparatus.

17. An apparatus for forming an image and having a function of communicating electronic mails, including a transmit mail and a receive mail, through a mail server equipped in a network system, comprising:
a transceiver section to transmit a transmit data set to be transmitted on said transmit mail and to receive a receive data set received on said receive mail;
a data size detecting section to detect a data size of said receive data set, which is received and stored in a receive-mail storage provided in said mail server;
a data size determining section to determine whether or not said data size, detected by said data size detecting section, is larger than a predetermined data size; and
a controlling section to control said transceiver section so as to receive said receive data set of said receive mail when said data size determining section determines that said data size, detected by said data size detecting section, is not larger than a predetermined data size.

18. The apparatus of claim 17,
wherein said receive data set received on said receive mail includes predetermined command data for commanding an operation of said controlling section; and further comprising:
a command data extracting section to extract said command data from said receive data set when said data size determining section determines that said data size, detected by said data size detecting section, is not larger than said predetermined data size.

19. The apparatus of claim 17, further comprising:
an electronic-mail creating section to create said transmit mail, which includes a message indicating that said data size is larger than said predetermined data size, when said data size determining section determines that said data size, detected by said data size detecting section, is larger than said predetermined data size;
wherein said transceiver section transmits said transmit mail including said message to an external terminal device of a manager of said network system.

20. The apparatus of claim 17,
wherein, when an attached file is attached to said receive mail, said data size detecting section also detects an attached data size of said attached file, and a data size determining section also determines whether or not said attached data size, detected by said data size detecting section, is larger than a predetermined attached-data size.

21. The apparatus of claim 20, further comprising:
an electronic-mail creating section to create said transmit mail, which includes a message indicating that said attached data size is larger than said predetermined attached data size, when said data size determining section determines that said attached data size, detected by said data size detecting section, is larger than said predetermined attached data size;
wherein said transceiver section transmits said transmit mail including said message to an external terminal device of a manager of said network system.

22. An apparatus for forming an image and having a function of communicating electronic mails, including a transmit mail and a receive mail, through a mail server equipped in a network system, comprising:
a transceiver section to conduct a transmitting operation of said transmit mail and a receiving operation of said receive mail; and
a controlling section that determines whether or not a number of receive mails, received by said transceiver section, reaches to a predetermined number;
wherein said controlling section controls said transceiver section so as to deactivate said receiving operation of said receive mail when determining that said number of receive mails reaches to said predetermined number.

23. An apparatus for forming an image and having a function of communicating electronic mails including predetermined command data through a network, operations of said apparatus being remote-controlled according to said predetermined command data sent from an external device, said apparatus comprising:
a transceiver section to conduct transmitting/receiving operations of said electronic mails;
an identifying-information extracting section to extract identifying information from an electronic mail received by said transceiver section;
an authenticating section to authenticate said identifying information extracted by said identifying information extracting section;
a reference information storage to store reference information to be referred when said authenticating section authenticates said identifying information;
a command data extracting section to acquire said electronic mail including said identifying information authenticated by said authenticating section, in order to extract said predetermined command data from said electronic mail; and
a controlling section to control each of sections as needed, according to said predetermined command data extracted by said command data extracting section.

24. The apparatus of claim 23,
wherein said identifying information is a password written in a predetermined area of said electronic mail.

25. The apparatus of claim 23,
wherein said identifying information is a mail address of a sender of said electronic mail.

26. The apparatus of claim 23,
wherein said reference information storage stores each of identifying information sets correlating to each of authorities, each of which is established for every identifying information set; and
wherein said authenticating section authenticates said identifying information set and extracts information with respect to an authority corresponding to said identifying information set from said reference information storage, to determine whether or not said predetermined command data, included in said electronic mail, resides within a scope of said authority extracted; and
wherein, when said authenticating section determines that said predetermined command data resides within a scope of said authority extracted, said controlling section controls each of sections as needed, according to said predetermined command data.

27. The apparatus of claim 23, further comprising:
a electronic-mail creating section to create said electronic mail, which includes a message indicating that said identifying information is not authenticated, when an authenticating section did not authenticate said identifying information extracted by said identifying-information extraction section;
wherein said transceiver section transmits said transmit mail including said message to an external terminal device of a manager of said network system.
